(19) United States
(12) Patent Application Publication
(10) Pub. No.: US 2006/0098223 A1
(43) Pub. Date: May 11, 2006

(54) Image former and computer system

(76) Inventors: Ken Yoshizuka, Nagano-ken (JP); Toshiya Takahata, Nagano-ken (JP); Yoichiro Irie, Nagano-ken (JP)

Correspondence Address: SUGHRUE MION, PLLC, 2100 PENNSYLVANIA AVENUE, N.W., SUITE 800, WASHINGTON, DC, 20037, US

(21) Appl. No.: 10/514,991

(22) PCT Filed: May 16, 2003
(86) PCT No.: PCT/JP03/06153

§ 371 Date: Sep. 29, 2005

(30) Foreign Application Priority Data
May 21, 2002 (JP) 2002-146888
May 21, 2002 (JP) 2002-146896
May 21, 2002 (JP) 2002-146895
May 21, 2002 (JP) 2002-146892
May 21, 2002 (JP) 2002-146893
May 21, 2002 (JP) 2002-146894

(51) Int. Cl. G06F 3/12

(52) U.S. Cl. 358/1.15

(57) ABSTRACT

An image forming apparatus etc. with which information can be accurately and efficiently written to an element is achieved. An antenna is provided at a position where, when a predetermined developing unit, of among a plurality of developing units attached to a plurality of attach/detach sections, is performing development of a latent image on a photoconductor, it is in opposition to at least one of the elements of the other developing units that are not performing the development. When the developing unit is positioned at the opposition position and is performing development, the writing member writes information to the element of at least one developing unit of among the developing units attached respectively to the plurality of attach/detach sections.

### TECHNICAL FIELD

The present invention relates to image forming apparatuses and computer systems.

### BACKGROUND ART

Among image forming apparatuses such as laser beam printers, there are those to and from which a developing unit having a memory can be attached and detached, and in which a latent image formed on a photoconductor is printed in full color by rotating the attached developing unit using a rotating device such as a rotary.

Further, communication is carried out between the memory and the main image forming apparatus, in order to read and write various types of information to and from the memory of the developing unit.

Here, it is necessary that communication between the memory and the main image forming apparatus is carried out accurately. For example, if a communication error occurs and incorrect information is written when information on the remaining toner amount is being written to the memory of the developing unit, then it is no longer possible to properly manage the remaining toner amount in the developing unit.

Accordingly, the present invention was arrived at in light of the foregoing issue, and it is an object thereof to provide an image forming apparatus and a computer system with which communication can be carried out accurately with respect to an element of a developing unit.

Meanwhile, in a configuration in which the main image forming apparatus writes information to a memory in a wired manner, there is a degree of freedom regarding the timing for performing writing.

In contrast, in a configuration in which the main image forming apparatus writes information to a memory wirelessly, there are limitations regarding the timing for performing writing. For example, interrupting the image formation process and stopping the moving member just to write information to the memory will result in a drop in the processing speed of the image forming apparatus.

Accordingly, the present invention was arrived at in light of the foregoing issue, and it is an object thereof to achieve an image forming apparatus and a computer system with which information can be wirelessly written in an efficient manner with respect to a developing unit having an element.

### DISCLOSURE OF INVENTION

A main aspect of the present invention is an image forming apparatus comprising: a photoconductor on which a latent image can be formed; a moving member provided with a plurality of attach/detach sections, to and from each of which a developing unit having an element to which information can be written and a developer containing section for containing developer with which the latent image on the photoconductor can be developed can be attached and detached; and an antenna for wirelessly writing information to the element of the developing unit attached to one of the attach/detach sections; wherein the antenna is provided at a position where, when a predetermined developing unit, of among a plurality of developing units attached to the plurality of attach/detach sections, is performing development of the latent image on the photoconductor, the antenna is in opposition to at least one of the elements of the other developing units that are not performing the development.

Another main aspect of the present invention is an image forming apparatus comprising: a moving member provided with a plurality of attach/detach sections, to and from each of which a developing unit having an element to which information can be wirelessly written and a developer containing section can be attached and detached; a photoconductor on which a latent image can be formed; and a writing member for writing information to the element; wherein the developing unit attached to one of the attach/detach sections is moved by the moving member to an opposition position in opposition to the photoconductor and develops the latent image formed on the photoconductor, and wherein, when the developing unit is positioned at the opposition position and is performing development, the writing member writes information to the element of at least one developing unit of among the developing units attached respectively to the plurality of attach/detach sections.

Features and objects of the present invention other than the above will become clear through the present specification and the description in the accompanying drawings.

### BRIEF DESCRIPTION OF DRAWINGS

FIG. 1 is a diagram for describing how the developing unit 54 (51, 52, 53) and the photoconductor unit 75 are attached to and detached from the main printer unit 10a.

FIG. 2 is a diagram showing the main structural components constituting the printer 10.

FIG. 3 is a block diagram showing the control unit 100 provided in the printer 10.

FIG. 4 is a perspective view of the yellow developing unit 54 seen from the perspective of the developing roller 510.

FIG. 5 is a cross-sectional view showing the main structural components of the yellow developing unit 54.

FIG. 6A is a plan transparent view showing the structure of the elements.

FIG. 6B is a block diagram for describing the internal configuration of the elements and the send/receive section.

FIG. 7 is a diagram for describing the information stored in the memory cell 54h of the element 54a.

FIG. 8 is a diagram for describing the information stored in the memory cell of the element 75a of the photoconductor unit 75.

FIG. 9A is a diagram showing a state where the yellow developing unit 54 is stopped at a developing position (opposition position) for developing the latent image on the photoconductor 20.

FIG. 9B is a diagram showing another example of the arrangement of the main-unit-side antenna 124b.

FIG. 9C, like FIG. 9B, is a diagram showing another example of the arrangement of the main-unit-side antenna 124b.

FIG. 10 is a diagram for illustrating how the main-unit-side antenna 124b is contiguously in opposition to elements of three developing units that are not performing the development.

FIG. 11 is a diagram for illustrating how the main-unit-side antenna 124b is contiguously in opposition to elements of two developing units that are not performing the development.

FIG. 12 is a diagram for illustrating how the main-unit-side antenna 124b is contiguously in opposition to elements of two other developing units that are not performing the development.

FIG. 13 is a diagram for describing how the main-unit-side antenna 124b is provided outside in the axial direction of rotation of the rotary 55.

FIG. 14 is a diagram for illustrating the rotary 55 at the home position.

FIG. 15 is a flowchart for describing how information is written to the elements of the developing units.

FIG. 16 is an explanatory diagram showing the external configuration of a computer system.

FIG. 17 is a block diagram showing the configuration of the computer system shown in FIG. 16.

FIG. 18A is a diagram showing a state where the yellow developing unit 2054 is positioned at the developing position (opposition position).

FIG. 18B is a diagram showing a state where the yellow developing unit 2054 is positioned at the attach/detach position (detach position).

FIG. 18C is a diagram showing a state where the rotary 2055 is positioned at the home position after the printer 2010 has been turned ON and an initialization process has been performed.

FIG. 19 is a flowchart for describing how information is written to the elements of the developing units.

FIG. 20 is a diagram showing another example of the arrangement of the main-unit-side antenna 2124b.

FIG. 21 is a flowchart for describing another example of how information is written to the elements of the developing units.

FIG. 22 is a diagram showing a state where the protective cover is attached to the developing unit.

FIG. 23 is a diagram showing another example of how the elements are provided.

FIG. 24 is an example showing how the yellow developing unit 3054 is mounted to the rotary 3300 provided in the main image forming apparatus unit.

FIG. 25 is a diagram showing the state of the yellow developing unit 3054 before it is mounted to the rotary 3300.

FIG. 26 is a diagram showing the yellow developing unit 3054 mounted to the rotary 3300.

FIG. 27 is a perspective view of the yellow developing unit 4054 seen from the perspective of the developing roller 4510.

FIG. 28 is an exploded view showing the positional relationship between the recessed section 4549, the element 4054a, and the lid section 4547 as regards the yellow developing unit 4054.

FIG. 29 is a cross-sectional view showing the main structural components of the yellow developing unit 4054.

FIG. 30 is a perspective view of the photoconductor unit 4075.

FIG. 31 is an exploded view showing the positional relationship between the recessed section 4758, the element 4075a, and the lid section 4756 as regards the photoconductor unit 4075.

FIG. 32 is a diagram showing the state before the yellow developing unit 5054 is mounted to the main printer unit 5010a.

FIG. 33 is a diagram showing the state as the yellow developing unit 5054 is being mounted to the main printer unit 5010a.

FIG. 34 is a diagram showing the yellow developing unit 5054 mounted to the main printer unit 5010a.

FIG. 35 is a perspective view showing the photoconductor unit 5075 seen from the perspective of the outer wall surface 5077.

FIG. 36 is a diagram showing the state before the photoconductor unit 5075 is mounted to the main printer unit 5010a.

FIG. 37 is a diagram showing the state as the photoconductor unit 5075 is being mounted to the main printer unit 5010a.

FIG. 38 is a diagram showing the photoconductor unit 5075 mounted to the main printer unit 5010a.

FIG. 39 is a perspective view of the yellow developing unit 6054 seen from the perspective of the developing roller 6510.

FIG. 40 is a cross-sectional view showing the main structural components of the yellow developing unit 6054.

A legend of the main reference numerals used in the drawings is shown below.
10 printer
10a main printer unit 10a
10b first opening cover
10c second opening cover
10d photoconductor unit attach/detach opening
10e developing unit attach/detach opening
20 photoconductor
30 charging unit
40 exposing unit
50 YMCK developing device
51 cyan developing unit
52 magenta developing unit
53 black developing unit
54 yellow developing unit
51a, 52a, 53a, 54a elements
54b noncontact IC chip
54c capacitor for resonation
54d antenna
54e rectifier
54f signal analysis section RF
54g controller
54h memory cell
55 rotary
55a central shaft
55b, 55c, 55d, 55e attach/detach sections
60 first transferring unit
70 intermediate transferring member
75 photoconductor unit
75a element
76 cleaning blade
76a waste toner containing section
77 outer wall surface
80 second transferring unit
90 fusing unit
92 paper supply tray
94 paper supply roller
95 display unit
96 resisting roller
100 control unit
101 main controller
102 unit controller
112 interface
113 image memory
120 CPU
121 serial interface
122 main-unit-side memory (storage element)
123 send/receive circuit
124a main-unit-side antenna (for communication with photoconductor-unit element)
124b main-unit-side antenna (for communication with developing-unit elements)
125 YMCK developing device drive control circuit
126a AC voltage supply section
126b DC voltage supply section
127 exposing unit drive control circuit
127a pixel counter
510 developing roller (developer bearing roller)
520 seal member
524 seal urging member
522 seal-supporting metal plate
530 first toner containing section
535 second toner containing section
540 housing
541 opening
545 restriction wall
550 toner supply roller (toner supply member)
560 restriction blade
560a rubber section
560b rubber-supporting section
562 blade-supporting metal plate
570 blade-backing member
1000 computer system
1002 main computer unit
1104 display device
1106 printer
1108 input device
1108A keyboard
1108B mouse
1110 reading device
1110A flexible disk drive device
1110B CR-ROM drive device
1202 internal memory
1204 hard disk drive unit
2010e developing unit attach/detach opening
2020 photoconductor
2030 charging unit
2040 exposing unit
2050 YMCK device
2051 cyan developing unit
2052 magenta developing unit
2053 black developing unit
2054 yellow developing unit
2051a, 2052a, 2053a, 2054a elements
2075 photoconductor unit
2076 cleaning blade
2124b main-unit-side antenna (for communicating with developing-unit elements)
3054 yellow developing unit
3054a element
3054m protective cover (cover)
3054n grasping section
3300 rotary
3302 engaging groove
3350 cover
3352 tension spring
3354 rotation shaft
3356 engaging protrusion
3510 developing roller (developer bearing roller)
3520 seal member
3522 seal-supporting metal plate
3540 housing
3540a recessed section
3560 restriction blade
3562 blade-supporting metal plate
4020 photoconductor
4054 yellow developing unit
4054a element
4075 photoconductor unit
4075a element
4510 developing roller (developer bearing roller)
4520 seal member
4522 seal-supporting metal plate
4524 seal urging member
4530 first toner containing section
4535 second toner containing section
4540 housing
4540a main housing unit
4541 opening
4543 outer wall section
4545 restriction wall
4547 lid section
4549 recessed section
4550 toner supply roller (toner supply member)
4560 restriction blade
4560a rubber section
4560b rubber-supporting section
4562 blade-supporting metal plate
4570 blade-backing member
4752 housing
4752a main housing unit
4754 outer wall section
4756 lid section
4758 recessed section
5010 printer
5010a main printer unit 10a
5010b first opening cover
5010c second opening cover
5010d photoconductor unit attach/detach opening
5010e developing unit attach/detach opening
5020 photoconductor
5054 yellow developing unit
5054a element
5075 photoconductor unit
5075a element
5077 outer wall surface
5540a outer wall surface
6010e developing unit attach/detach opening
6020 photoconductor
6051 cyan developing unit
6052 magenta developing unit
6053 black developing unit
6054 yellow developing unit
6051a, 6052a, 6053a, 6054a elements
6055 rotary
6124b main-unit-side antenna (for communicating with developing-unit elements)
6510 developing roller (developer bearing roller)
6520 seal member
6524 seal urging member
6522 seal-supporting metal plate
6530 first toner containing section
6535 second toner containing section
6540 housing
6541 opening
6545 restriction wall
6550 toner supply roller (toner supply member)
6560 restriction blade
6560a rubber section
6560b rubber-supporting section
6562 blade-supporting metal plate
6570 blade-backing member
T toner
RS read sensor for synchronization

### BEST MODE FOR CARRYING OUT THE INVENTION

At least the following matters will be made clear through the present specification and the description of the accompanying drawings.

An image forming apparatus comprises: a photoconductor on which a latent image can be formed; a moving member provided with a plurality of attach/detach sections, to and from each of which a developing unit having an element to which information can be written and a developer containing section for containing developer with which the latent image on the photoconductor can be developed can be attached and detached; and an antenna for wirelessly writing information to the element of the developing unit attached to one of the attach/detach sections; wherein the antenna is provided at a position where, when a predetermined developing unit, of among a plurality of developing units attached to the plurality of attach/detach sections, is performing development of the latent image on the photoconductor, the antenna is in opposition to at least one of the elements of the other developing units that are not performing the development.

With the foregoing image forming apparatus, the time during which a predetermined developing unit is developing a latent image on the photoconductor can be used to write information to at least one element of the other developing units that are not performing the development, and thus information can be written efficiently while preventing the adverse effects due to the developing operation.

In this image forming apparatus, the moving member may move rotatively to selectively position each of the plurality of developing units attached to the plurality of attach/detach sections in opposition to the photoconductor.

With the foregoing image forming apparatus, correct information can be written to at least one of the elements of the developing units that are not performing the development when a predetermined developing unit mounted to the moving member that moves rotatively is developing the latent image on the photoconductor.

In this image forming apparatus, the element may be provided on an outer wall surface in a longitudinal direction of the developing unit, and the antenna may be provided at a position that is more outside, in a radial direction of rotation of the moving member, than the elements of the developing units that are not performing the development.

With the foregoing image forming apparatus, correct information can be written to at least one of the elements of the developing units that are not performing the development using the antenna, which is provided at a position that is more outside, in a radial direction of rotation of the moving member, than elements of developing units that are not performing the development.

In this image forming apparatus, the antenna may be provided at a position that is more outside, in the radial direction of rotation of the moving member, than the element of the developing unit that is on a side opposite, with respect to a rotational axis of the moving member, from the developing unit that is performing development of the latent image on the photoconductor.

With the foregoing image forming apparatus, the antenna that is provided at a position that is more outside, in the radial direction of rotation of the moving member, than the element of a developing unit that is on a side opposite, with respect to a rotational axis of the moving member, from a developing unit that is developing a latent image on the photoconductor, that is, at a position that is farthest away from the photoconductor, can be used to effectively write correct information,to the element of the above-mentioned developing unit on the opposite side.

In this image forming apparatus, a longitudinal direction of the antenna may be in the direction of rotation of the moving member.

With the foregoing image forming apparatus, the longitudinal direction of the antenna is provided in the direction of rotation of the moving member, and thus correct information can be written to the element of developing units that are not performing the development, even if there is error in the amount of rotative movement of the moving member when selectively bringing a plurality of developing units mounted to the attach/detach sections in opposition to the photoconductor.

In this image forming apparatus, the element may be provided on a lateral surface of the developing unit on a leading side when the developing unit is being attached to the attach/detach section, and the antenna may be provided at a position that is more outside, in an axial direction of rotation of the moving member, than the elements of the developing units that are not performing the development.

With the foregoing image forming apparatus, correct information can be written to at least one element of the developing units that are not performing the development using the antenna provided at a position that is more outside, in an axial direction of rotation of the moving member, than elements of developing units that are not performing the development.

In this image forming apparatus, the antenna may be capable of writing information to the element in a non-contacting state.

With the foregoing image forming apparatus, correct information can be written, in a non-contacting state, to elements of developing units that are not performing the development.

In this image forming apparatus, the antenna may be used to write, to the element, information indicating a remaining amount of developer that is contained in the developing unit provided with that element.

Since the amount of developer that is contained in the developer containing section of a developing unit decreases as developing is performed, it is preferable that information allowing the amount of developer that is remaining to be ascertained is suitably written to the element. Accordingly, with the foregoing image forming apparatus, correct information that indicates an amount of developer that is remaining can be written to the element of a developing unit that is not performing the development.

In this image forming apparatus, the antenna may be used to write, to the element, information indicating a usage amount of developer that is contained in the developing unit provided with that element.

Since the amount of developer that is contained in the developer containing section of a developing unit decreases as developing is performed, it is preferable that information allowing the amount of developer that is remaining to be ascertained is suitably written to the element. Accordingly, with the foregoing image forming apparatus, correct information that indicates an amount of developer that is used can be written to the element of a developing unit that is not performing the development.

The image forming apparatus may further comprise an AC voltage supply section for supplying an AC voltage, and when the predetermined developing unit, of among the plurality of developing units attached to the plurality of attach/detach sections, is supplied with the AC voltage from the AC voltage supply section and is performing development of the latent image on the photoconductor, the antenna may be used to write information to the element of the developing unit that is not performing the development.

When a developing unit is supplied with an AC voltage from an AC voltage supply section so as to develop the latent image on the photoconductor, there is a possibility that electromagnetic noise from the AC voltage supply section may occur at the periphery of the developing unit and adversely affect it. Accordingly, with the foregoing image forming apparatus, the antenna is provided at a position that is in opposition to the element of a developing unit other than the developing unit that is performing development, which is most likely to be affected by the electromagnetic noise, and thus the antenna can be used to write correct information to the element of a developing unit that is not performing the development.

In this image forming apparatus, the developing unit may have a developer bearing member for bearing the developer, and the AC voltage supply section may supply the AC voltage to the developer bearing member.

With the foregoing image forming apparatus, correct information can be written to the element of a developing unit that is not performing the development even if the developing unit has a developer bearing member to which an AC voltage is supplied from the AC voltage supply section.

In this image forming apparatus, a difference between a maximum voltage value and a minimum voltage value of the AC voltage may be at least 1000 volts.

When the difference between the maximum voltage value and the minimum voltage value of the AC voltage is 1000 volts or more, the electromagnetic noise also increases. Accordingly, with the foregoing image forming apparatus, the antenna is provided at a position that is in opposition to the element of a developing unit other than the developing unit that is performing development, which is most likely to be adversely affected by the electromagnetic noise, and thus correct information can be written to the element of a developing unit that is not performing the development using the antenna.

It is also possible to achieve an image forming apparatus comprising: a photoconductor on which a latent image can be formed; a moving member provided with a plurality of attach/detach sections, to and from each of which a developing unit having an element to which information can be written and a developer containing section for containing developer with which the latent image on the photoconductor can be developed can be attached and detached; and an antenna for wirelessly writing information to the element of the developing unit attached to one of the attach/detach sections; wherein the antenna is provided at a position where, when a predetermined developing unit, of among a plurality of developing units attached to the plurality of attach/detach sections, is performing development of the latent image on the photoconductor, the antenna is in opposition to at least one of the elements of the other developing units that are not performing the development such that information can be written wirelessly to that element, wherein the moving member moves rotatively in opposition to the photoconductor, wherein the antenna is provided at a position that is more outside, in the radial direction of rotation of the moving member, than the element provided on an outer wall surface in a longitudinal direction of the developing unit that is on a side opposite, with respect to a rotational axis of the moving member, from the developing unit that is performing development of the latent image on the photoconductor, wherein a longitudinal direction of the antenna is in the direction of rotation of the moving member, wherein the antenna is capable of writing information to the element in a non-contacting state, and wherein the antenna is used to write, to the element, information about consumption of developer that is contained in the developing unit provided with that element. Further, it is also possible to achieve a computer system comprising: an image forming apparatus including: a photoconductor on which a latent image can be formed; a moving member provided with a plurality of attach/detach sections, to and from each of which a developing unit having an element to which information can be written and a developer containing section for containing developer with which the latent image on the photoconductor can be developed can be attached and detached; and an antenna for wirelessly writing information to the element of the developing unit attached to one of the attach/detach sections; and a main computer unit that is connected to the image forming apparatus; wherein the antenna is provided at a position where, when a predetermined developing unit, of among a plurality of developing units attached to the plurality of attach/detach sections, is performing development of the latent image on the photoconductor, the antenna is in opposition to at least one of the elements of the other developing units that are not performing the development.

An image forming apparatus comprises: a moving member provided with a plurality of attach/detach sections, to and from each of which a developing unit having an element to which information can be wirelessly written and a developer containing section can be attached and detached; a photoconductor on which a latent image can be formed; and a writing member for writing information to the element; wherein the developing unit attached to one of the attach/detach sections is moved by the moving member to an opposition position in opposition to the photoconductor and develops the latent image formed on the photoconductor, and wherein, when the developing unit is positioned at the opposition position and is performing development, the writing member writes information to the element of at least one developing unit of among the developing units attached respectively to the plurality of attach/detach sections.

In the case of a configuration in which developing units having an element, to which information can be written wirelessly, and a developer containing section can be attached to and detached from attach/detach sections, there is a possibility that the developing units mounted to the attach/detach sections will become detached. Therefore, it is preferable that information such as the amount of remaining developer contained in the developer containing section is suitably written to the element of that developing unit. However, in a configuration including a moving member provided with a plurality of attach/detach sections, there will be a drop in the processing speed of the image forming apparatus if the image forming process is interrupted and the moving member is stopped just to write information to the element, for example.

On the other hand, with the foregoing image forming apparatus, the writing member writes information to the element of at least one developing unit, of among the developing units mounted to the plurality of attach/detach sections, when a developing unit is positioned at the opposition position and is performing development, and thus the time during which that developing unit is positioned at the opposition position and is performing development can be utilized so that the writing member can effectively write information.

In this image forming apparatus, the developing unit may have a developer bearing member for bearing developer, and the latent image may be developed by the developer borne on the developer bearing member of the developing unit that is positioned at the opposition position.

With the foregoing image forming apparatus, the time during which the latent image is developed by the developer that is borne on the developer bearing member of the developing unit that is positioned at the opposition position can be utilized so that the writing member can effectively write information.

In this image forming apparatus, the writing member may write information to the element in a non-contacting state.

If the writing member writes information to the element of at least one developing unit, of among the developing units mounted to the plurality of attach/detach sections, when the developing unit is positioned at the opposition position and is performing development, it is necessary to inhibit vibration or the like to the developing unit as much as possible. Here, with the foregoing image forming apparatus, the writing member writes information to the element in a non-contacting state, and thus impact, for example, caused by the writing member coming into contact with the element can be eliminated.

In this image forming apparatus, the writing member may write information to the element when the moving member is not moving.

With the foregoing image forming apparatus, the writing member writes information to the element when the moving member is not moving, and thus there is increased writing accuracy.

In this image forming apparatus, the writing member may write information to the element of the developing unit that is positioned at the opposition position.

With the foregoing image forming apparatus, the time during which the developing unit is positioned at the opposition position and is performing development can be utilized so that the writing member can effectively write information to the element of the developing unit that is positioned at the opposition position.

In this image forming apparatus, the writing member may write information to the element of a developing unit, of among the developing units attached respectively to the plurality of attach/detach sections, other than the developing unit that is positioned at the opposition position.

With the foregoing image forming apparatus, the time during which the developing unit is positioned at the opposition position and developing the latent image can be utilized so that the writing member can effectively write information to the element of a developing unit, of among the developing units mounted to the plurality of attach/detach sections, other than the developing unit that is positioned at the opposition position.

In this image forming apparatus, the developing unit may have a developer bearing member for bearing developer, and an AC voltage may be applied between the developer bearing member and the photoconductor to develop the latent image with the developer that is borne on the developer bearing member.

There is a possibility that noise or the like will be generated when an AC voltage is applied between the developer bearing member and the photoconductor to develop the latent image with the developer that is borne on the developer bearing member. With the foregoing image forming apparatus, the writing member writes information to the element of a developing unit, of among the developing units mounted to the plurality of attach/detach sections, other than the developing unit that is positioned at the opposition position and is developing the latent image, that is, to the element of a developing unit that is away from the source causing the noise etc., and thus the reliability with which information is written is increased.

In this image forming apparatus, the writing member may write information to the element of a developing unit, of among the developing units attached respectively to the plurality of attach/detach sections, that is adjacent to the developing unit that is positioned at the opposition position.

With the foregoing image forming apparatus, the writing member writes information to the element of a developing unit, of among the developing units mounted to the plurality of attach/detach sections, that is adjacent to the developing unit positioned at the opposition position, that is, to the element of a developing unit that is farther away from the source causing the noise etc. than the developing unit that is positioned at the opposition position, and thus the reliability with which information is written is increased.

In this image forming apparatus, the writing member may write information to the element of a developing unit, of among the developing units attached respectively to the plurality of attach/detach sections, that is not adjacent to the developing unit that is positioned at the opposition position.

With the foregoing image forming apparatus, the writing member writes information to the element of a developing unit, of among the developing units mounted to the plurality of attach/detach sections, that is not adjacent to the developing unit that is positioned at the opposition position, that is, to the element of a developing unit that is farther away from the source causing the noise etc. than a developing unit that is adjacent to the developing unit positioned at the opposition position, and thus the reliability with which information is written is increased even more.

In this image forming apparatus, the writing member may write, to the element, information indicating a remaining amount of developer that is contained in the developing unit provided with that element.

The amount of developer that is contained in a developing unit decreases when developing is carried out. Here, with this image forming apparatus, information on the remaining amount can be effectively written to the element in accordance with the amount of developer that is consumed by developing.

In this image forming apparatus, the writing member may write, to the element, information indicating a usage amount of developer that is contained in the developing unit provided with that element.

The amount of developer that is contained in a developing unit decreases when developing is performed. Here, with this image forming apparatus, information on the usage amount can be effectively written to the element in accordance with the amount of developer that is consumed by developing.

It is also possible to achieve an image forming apparatus comprising: a moving member provided with a plurality of attach/detach sections, to and from each of which a developing unit having an element to which information can be wirelessly written and a developer containing section can be attached and detached; a photoconductor on which a latent image can be formed; and a writing member for writing information to the element; wherein the developing unit attached to one of the attach/detach sections is moved by the moving member to an opposition position in opposition to the photoconductor and develops the latent image formed on the photoconductor, wherein, when the developing unit is positioned at the opposition position and is performing development, the writing member writes information to the element of at least one developing unit of among the developing units attached respectively to the plurality of attach/detach sections, wherein the developing unit has a developer bearing member for bearing developer, wherein the latent image is developed by the developer borne on the developer bearing member of the developing unit that is positioned at the opposition position, and wherein the writing member writes information to the element in a non-contacting state when the moving member is not moving.

It is also possible to achieve a computer system comprising: a main computer unit; and an image forming apparatus that is connected to the main computer unit and that includes: a moving member provided with a plurality of attach/detach sections, to and from each of which a developing unit having an element to which information can be wirelessly written and a developer containing section can be attached and detached; a photoconductor on which a latent image can be formed; and a writing member for writing information to the element; wherein the developing unit attached to one of the attach/detach sections is moved by the moving member to an opposition position in opposition to the photoconductor and develops the latent image formed on the photoconductor, and wherein, when the developing unit is positioned at the opposition position and is performing development, the writing member writes information to the element of at least one developing unit of among the developing units attached respectively to the plurality of attach/detach sections.

In the foregoing image forming apparatus, the developing unit may have a developer bearing member for bearing developer that is contained in the developer containing section, and a cover that is removable or retractable and that is for covering the developer bearing member, and the element may be provided inside the cover.

In the foregoing image forming apparatus, the developing unit may have a developer bearing member for bearing developer that is contained in the developer containing section, and a cover that is removable or retractable and that is for covering the developer bearing member, and the element may be provided inside the cover.

In the foregoing image forming apparatus, the element may be provided at a position where it is not exposed to the outside.

In the foregoing image forming apparatus, the element may be provided at a position where it is not exposed to the outside.

The image forming apparatus may further comprise an attach/detach opening through which the developing unit is attached and detached; and the element may be provided at a position where it is not exposed from the attach/detach opening when the developing unit, is attached to the image forming apparatus.

The image forming apparatus may further comprise an attach/detach opening through which the developing unit is attached and detached; and the element may be provided at a position where it is not exposed from the attach/detach opening when the developing unit is attached to the image forming apparatus.

In the foregoing image forming apparatus, a longitudinal direction of the element may be in a longitudinal direction of the developing unit.

In the foregoing image forming apparatus, a longitudinal direction of the element may be in a longitudinal direction of the developing unit.

### =First Embodiment=

===Overview of Image Forming Apparatus (Laser Beam Printer)===

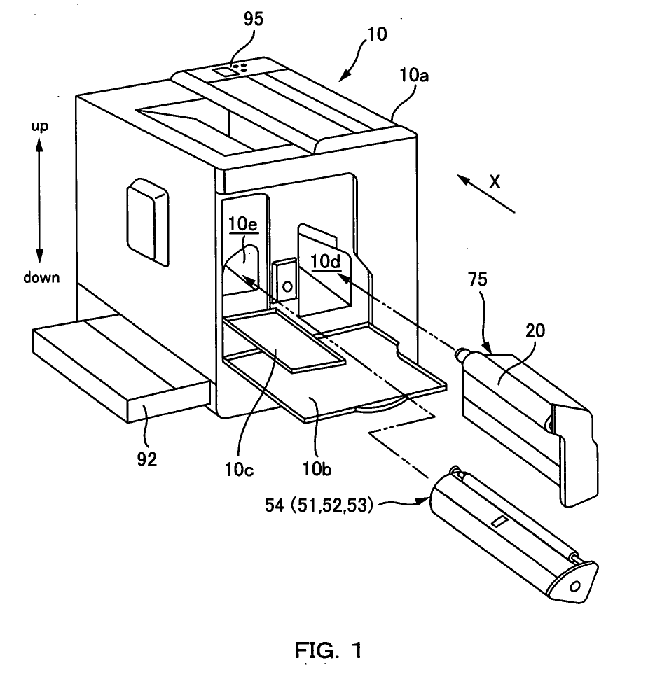

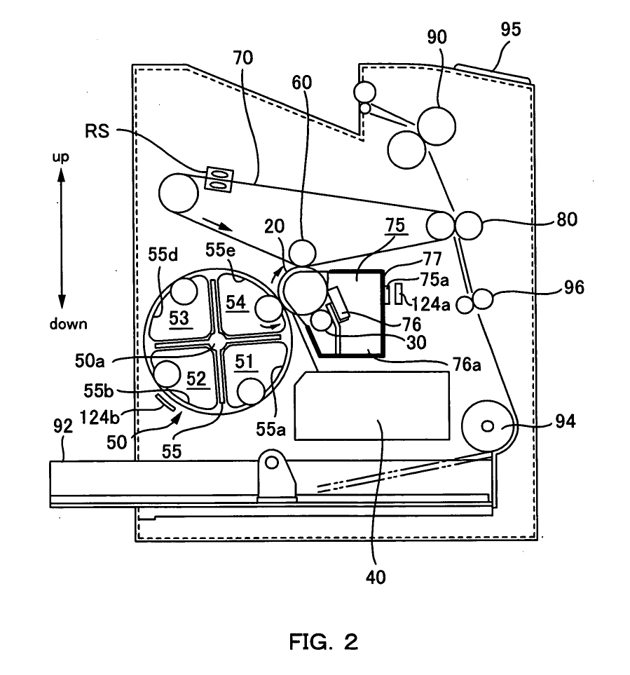

Next, using FIG. 1 and FIG. 2, an overview of a laser beam printer (hereinafter, also referred to as “printer”) 10 serving as an example of an image forming apparatus is described. FIG. 1 is a diagram for describing how a developing unit 54 (51, 52, 53) and a photoconductor unit 75 are attached to and detached from a main printer unit 10a. FIG. 2 is a diagram showing the main structural components making up the printer 10. It should be noted that FIG. 2 is a diagram of a cross section taken perpendicular to the X direction in FIG. 1. Also, the vertical direction is shown by an arrow in FIG. 1 and FIG. 2, and for example, a paper supply tray 92 is arranged at a lower section of the printer 10 and a fusing unit 90 is arranged at an upper section of the printer 10.

<Attach/Detach Configuration>

The developing unit 54 (51, 52, 53) and the photoconductor unit 75 can be attached to and detached from the main printer unit 10a. The printer 10 is constituted by mounting the developing unit 54 (51, 52, 53) and the photoconductor unit 75 to the main printer unit 10a.

The main printer unit 10a has a first opening cover 10b that can be opened and closed, a second opening cover 10c that can be opened and closed and that is provided more inward than the first opening cover 10b, a photoconductor unit attach/detach opening 10d through which the photoconductor unit 75 is attached and detached, and a developing unit attach/detach opening 10e through which the developing unit 54 (51, 52, 53) is attached and detached.

Here, by the user opening the first opening cover 10b, the photoconductor unit 75 can be attached to and detached from the main printer unit 10a via the photoconductor unit attach/detach opening 10d. Further, by the user opening the second opening cover 10c, the developing unit 54 (51, 52, 53) can be attached to and detached from the main printer unit 10a via the developing unit attach/detach opening 10e.

<Overview of the Printer 10>

An overview of the printer 10 in which the developing unit 54 (51, 52, 53) and the photoconductor unit 75 have been mounted to the main printer unit 10a is described.

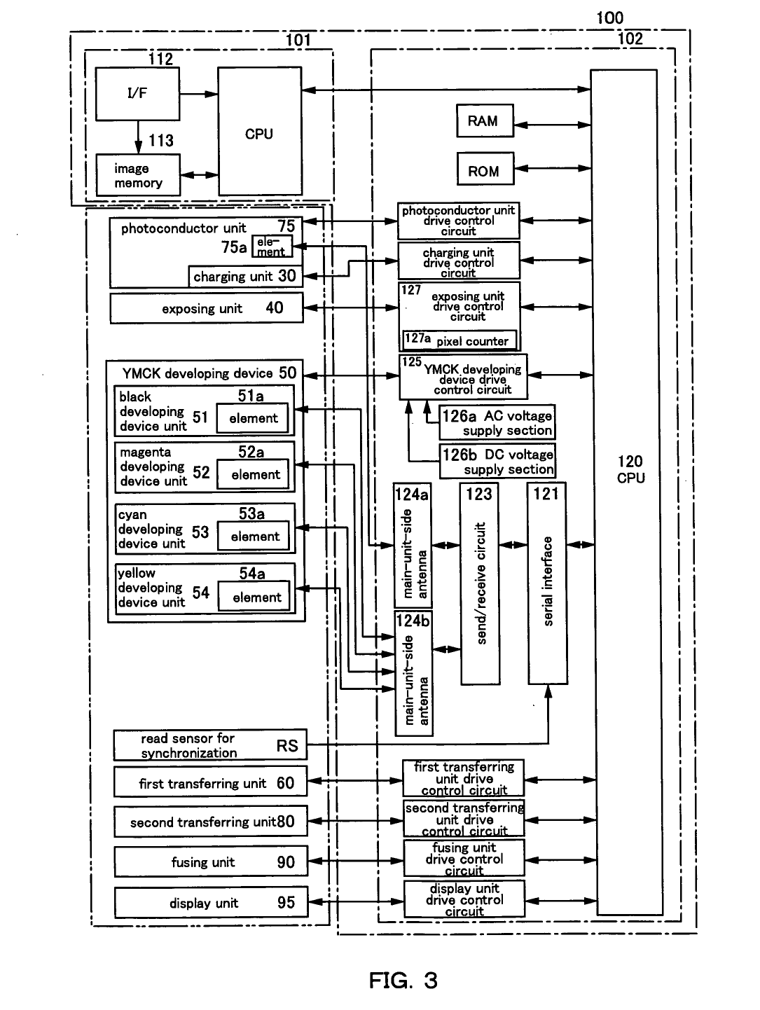

As shown in FIG. 2, the printer 10 of this embodiment has, in the direction of rotation of a photoconductor 20, which is a latent image bearing member for bearing a latent image, a charging unit 30, an exposing unit 40, a YMCK developing device 50, a first transferring unit 60, an intermediate transferring member 70, and a cleaning blade 76. It further includes a second transferring unit 80, the fusing unit 90, a display unit 95 such as a liquid crystal panel for constituting means for notifying the user, for example, and a control unit 100 (FIG. 3) for controlling these units, for example, so as to control the operation of the printer 10.

The photoconductor 20 has a cylindrical conductive base and a photoconductive layer formed on the outer peripheral surface of the base, and can rotate about its central axis, and in this embodiment, it rotates in the clockwise direction as shown by the arrow in FIG. 2.

The charging unit 30 is a device for charging the photoconductor 20, and the exposing unit 40 is a device for forming a latent image on the charged photoconductor 20 by irradiating a laser. The exposing unit 40 has a semiconductor laser, a polygon mirror, and a F-θ lens, for example, and irradiates a modulated laser onto the charged photoconductor 20 based on an image signal input from a host computer that is not shown, such as a personal computer or a word processor.

The YMCK developing device 50 has a rotary 55 that serves as a moving member, and four developing units mounted to the rotary 55. The rotary 55 is capable of rotating, and is provided with four attach/detach sections 55a, 55b, 55d, and 55e to and from which the four developing units 51, 52, 53, and 54, respectively, can be attached and detached via the developing unit attach/detach opening 10d. The cyan developing unit 51, which contains cyan (C) toner, can be attached to and detached from the attach/detach section 55a, the magenta developing unit 52, which contains magenta (M) toner, can be attached to and detached from the attach/detach section 55b, the black developing unit 53, which contains black (K) toner, can be attached to and detached from the attach/detach section 55d, and the yellow developing unit 54, which contains yellow (Y) toner, can be attached to and detached from the attach/detach section 55e.

The rotary 55, by rotating, moves the four developing units 51, 52, 53, and 54 mentioned above that are mounted to the attach/detach sections 55a, 55b, 55d, and 55e, respectively. That is, the rotary 55 rotates the four mounted developing units 51, 52, 53, and 54 about a central shaft 50a while maintaining their positions relative to one another. Then, the developing units 51, 52, 53, and 54 are selectively brought into opposition with the latent image formed on the photoconductor 20 and the latent image on the photoconductor 20 is developed using the toner contained in the developing units 51, 52, 53, and 54. It should be noted that the developing units are described in detail later.

A main-unit-side antenna 124b is provided at a position where, of among the developing units 51, 52, 53, and 54 mounted to the attach/detach sections 55a, 55b, 55d, and 55e, the antenna is in opposition to at least one of the elements of the other developing units that are not performing the development when one predetermined developing unit is developing a latent image on the photoconductor 20. For example, the main-unit-side antenna 124b is provided at a position that is outside, in the radial direction of rotation of the rotary 55, of the element of the developing unit (in FIG. 2, the magenta developing unit 52) on the side opposite, with respect to the central shaft 50a of the rotary 55, from the developing unit that is in opposition to the photoconductor 20 (in FIG. 2, the yellow developing unit 54). It should be noted that the position where the main-unit-side antenna 124b is provided is not limited to a position outside and in opposition to the element of the magenta developing unit 52 when the rotary 55 is stopped at the state shown in FIG. 2, and it may also be positioned outside and in opposition to the element of either the cyan developing unit 51 or the black developing unit 53. In the case of providing the main-unit-side antenna 124b at a position that is outside an element of one developing unit that is not performing the development, that is, when the antenna is provided at the position shown in FIG. 2, then the distance between it and the photoconductor 20 is longest. The first transferring unit 60 is a device for transferring a single color toner image formed on the photoconductor 20 to the intermediate transferring member 70. When the four colors of toner are successively transferred superimposed over one another, a full color toner image is formed on the intermediate transferring member 70.

The intermediate transferring member 70 is an endless belt that is rotatively driven at substantially the same circumferential velocity as the photoconductor 20. A read sensor for synchronization RS is provided near the intermediate transferring member 70. The read sensor for synchronization RS is a sensor for detecting the reference position of the intermediate transferring member 70, and obtains a synchronization signal Vsync in the sub-scanning direction, which is perpendicular to the main-scanning direction. The read sensor for synchronization RS has a light-emitting section for emitting light and a light-receiving section for receiving light. Light that is emitted from the light-emitting section passes through a hole formed at a predetermined position in the intermediate transferring member 70, and when light is received by the light-receiving section, the read sensor for synchronization RS generates a pulse signal. One pulse signal is generated per each revolution of the intermediate transferring member 70.

The second transferring unit 80 is a device for transferring a single color toner image or a full color toner image formed on the intermediate transferring member 70 to a recording medium such as paper, film, or cloth.

The fusing unit 90 is a device for fusing the single color toner image or the full color toner image, which has been transferred to the recording medium, onto the recording medium such as paper, making it a permanent image.

The cleaning blade 76 is made of rubber and abuts against the surface of the photoconductor 20. The cleaning blade 76 scrapes off and removes toner remaining on the photoconductor 20 after the toner image has been transferred to the intermediate transferring member 70 by the first transferring unit 60.

The photoconductor unit 75 is provided between the first transferring unit 60 and the exposing unit 40, and includes the photoconductor 20, an element 75a to which information can be written, the charging unit 30, the cleaning blade 76, and a waste toner containing section 76a for containing toner that has been scraped off by the cleaning blade 76. The element 75a has a configuration that allows various types of written information to be recorded, and is provided on an outer wall surface 77 in the longitudinal direction of the photoconductor unit 75. For example, as shown in FIG. 2, the element 75a is provided on the right side surface of the outer wall surface 77 so that it is in opposition to a main-unit-side antenna 124a of the control unit 100 at a distance that allows wireless communication between it and the main-unit-side antenna 124a.

It should be noted that the position where the element 75a is provided on the outer wall surface 77 is not limited to the right side surface of the outer wall surface 77 viewed from the direction perpendicular to the paper plane of FIG. 2, and as long as the position allows the element 75a to wirelessly communicate with the main-unit-side antenna 124a when the photoconductor unit 75 is mounted to the main printer unit 10a, then the element 75a can be provided at other positions on the outer wall surface 77.

The control unit 100 is made of a main controller 101 and a unit controller 102, as shown in FIG. 3. An image signal is input to the main controller 101, and in accordance with a command based on this image signal, the unit controller 102 controls the various units, for example, to form an image.

===Operation of the Printer 10===

The operation of the printer 10 configured as above is described below, referring to other structural components thereof as well.

First, an image signal from a host computer that is not shown is input to the main controller 101 of the printer 10 via an interface (I/F) 112, and then the photoconductor 20 and the intermediate transferring member 70 are rotated due to control by the unit controller 102 based on a command from the main controller 101. Then, the reference position of the intermediate transferring member 70 is detected by the read sensor for synchronization RS, and a pulse signal is output. This pulse signal is sent to the unit controller 102 via a serial interface 121. The unit controller 102 controls the following operation, using the received pulse signal as a reference.

The photoconductor 20 is successively charged by the charging unit 30 at a charging position while rotating. The region of the photoconductor 20 that is charged is brought to an exposure position through rotation of the photoconductor 20, and a latent image corresponding to image information of the first color, for example, yellow Y, is formed in that region by the exposing unit 40.

The latent image formed on the photoconductor 20 is brought to a developing position due to rotation of the photoconductor 20, and is developed with yellow toner by the yellow developing unit 54. A yellow toner image is thus formed on the photoconductor 20.

The yellow toner image that is formed on the photoconductor 20 is brought to the first transferring position due to rotation of the photoconductor 20 and is transferred to the intermediate transferring member 70 by the first transferring unit 60. At this time, a first transferring voltage of a polarity that is opposite to the toner charge polarity is applied to the first transferring unit 60. It should be noted that throughout this operation the second transferring unit 80 is kept separated from the intermediate transferring member 70.

The above process is repeated for the second color, the third color, and the fourth color, thereby transferring different color toner images, which correspond to respective image signals, superimposed over one another onto the intermediate transferring member 70. Thus, a full color toner image is formed on the intermediate transferring member 70.

The full color toner image that is formed on the intermediate transferring member 70 is brought to the second transferring position due to rotation of the intermediate transferring member 70 and is transferred to a recording medium by the second transferring unit 80. It should be noted that the recording medium is carried from the paper supply tray 92 to the second transferring unit 80 via a paper supply roller 94 and a resisting roller 96. Also, when performing the transferring operation, the second transferring unit 80 is pressed against the intermediate transferring member 70 and at the same time a second transferring voltage is applied thereto.

The fusing unit 90 heats and applies pressure to the full color toner image that is transferred to the recording medium, fusing it to the recording medium.

On the other hand, after the photoconductor 20 passes the first transferring position, the toner adhering to its surface is scraped off by the cleaning blade 76 and photoconductor 20 is prepared for charging for forming the next latent image. The toner that is scraped off is collected into the waste toner containing section 76a.

===Overview of the Control Unit===

The configuration of the control unit 100 is described next with reference to FIG. 3. FIG. 3 is a block diagram showing the control unit 100 provided in the printer 10.

The main controller 101 of the control unit 100 is connected to a host computer via the interface 112, and is provided with an image memory 113 for storing image signals that are received from the host computer.

The unit controller 102 of the control unit 100 is electrically connected to the various units (the charging unit 30, the exposing unit 40, the first transferring unit 60, the photoconductor unit 75, the second transferring unit 80, the fusing unit 90, and the display unit 95) and the YMCK developing device 50, and by receiving signals from the sensors provided in these components, it controls these units and the YMCK developing device 50 based on signals input from the main controller 101 while detecting the state of these units and the YMCK developing device 50. As the structural components for driving these units and the YMCK developing device 50, FIG. 3 shows a photoconductor unit drive control circuit, a charging unit drive control circuit, an exposing unit drive control circuit 127, a YMCK developing device drive control circuit 125, a first transferring unit drive control circuit, a second transferring unit-drive control circuit, a fusing unit drive control circuit, and a display unit drive control circuit.

The exposing unit drive control circuit 127 connected to the exposing unit 40 has a pixel counter 127a that serves as consumption amount detection means for detecting the amount of developer that is consumed. The pixel counter 127a counts the number of pixels that are input to the exposing unit 40 based on a signal indicating the number of images input to the exposing unit drive control circuit 127. It should be noted that it is also possible to provide the pixel counter 127a in the exposing unit 40 or in the main controller 101. It should be noted that the number of pixels is the number of pixels in terms of the basic resolution unit of the printer 10, that is, the number of pixels of the image that is actually printed. The amount of toner T that is consumed (the amount that is used) is proportional to the number of pixels, and thus by counting the number of pixels it is possible to detect the amount of toner T that is consumed.

To the YMCK developing device drive control circuit 125, an AC voltage is supplied from an AC voltage supply section 126a and a DC voltage is supplied from a DC voltage supply section 126b. The YMCK developing device drive control circuit 125 superimposes the AC voltage and the DC voltage, and applies the superimposed voltage to the developing roller at a suitable timing, forming an alternating electric field between the developing roller and the photoconductor 20.

Also, the CPU 120 provided in the unit controller 102 is connected to a nonvolatile storage element such as a serial EEPROM via the serial interface (I/F) 121.

Also, the CPU 120 is capable of wirelessly communicating with elements 51a, 52a, 53a, and 54a of the developing units 51, 52, 53, and 54, respectively, via the serial interface 121, a send/receive circuit 123, and the main-unit-side antenna (antenna for communicating with developing-unit elements) 124b. The CPU 120 also is capable of wirelessly communicating with the element 75a of the photoconductor unit 75 via the serial interface 121, the send/receive circuit 123, and the main-unit-side antenna (antenna for communicating with photoconductor-unit element) 124a.

At the time of wireless communication, the antenna 124b for communicating with developing-unit elements, which serves as a writing member, writes information to the elements 51a, 52a, 53a, and 54a of the developing units 51, 52, 53, and 54, respectively. The antenna 124b for communicating with developing-unit elements is also capable of reading information from the elements 51a, 52a, 53a, and 54a of the developing units 51, 52, 53, and 54, respectively. At the time of wireless communication, the antenna 124a for communicating with photoconductor-unit element, which serves as a writing member, writes information to the element 75a of the photoconductor unit 75. The antenna 124a for communicating with photoconductor-unit element, which serves as a writing member, can also read information from the element 75a of the photoconductor unit 75.

===Overview of the Developing Units===

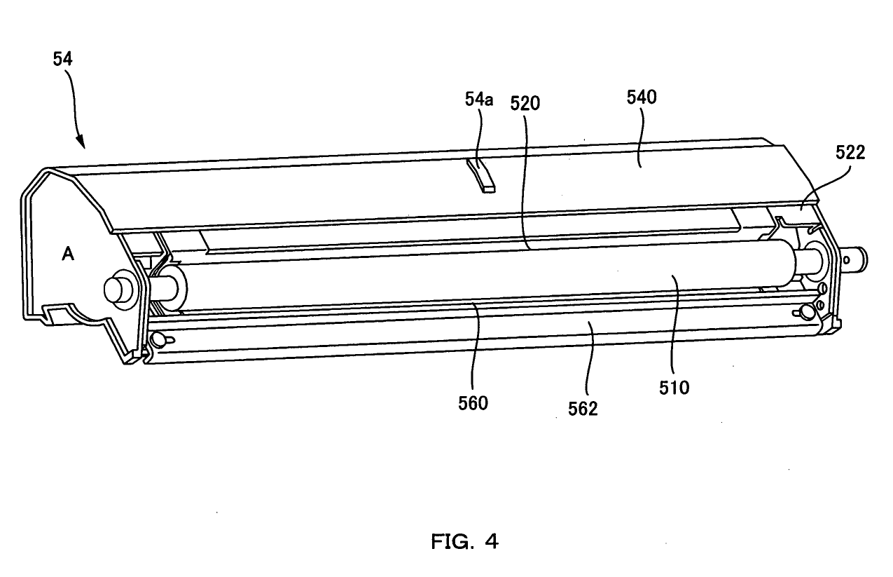

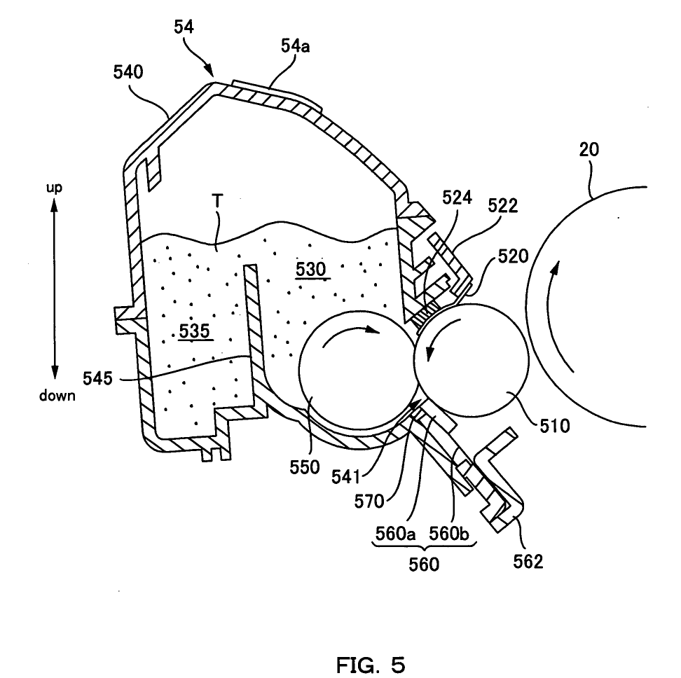

An overview of the developing units is provided next using FIG. 4 and FIG. 5. FIG. 4 is a perspective view of the yellow developing unit 54 seen from the perspective of a developing roller 510. FIG. 5 is a cross-sectional view showing the primary structural components of the yellow developing unit 54. It should be noted that in FIG. 5 as well, the vertical direction is shown by an arrow, and for example, the central axis of the developing roller 510 is lower than the central axis of the photoconductor 20. Also, in FIG. 5, the yellow developing unit 54 is shown positioned at a developing position that is in opposition to the photoconductor 20.

The YMCK developing device 50 is provided with the cyan developing unit 51, which contains cyan (C) toner, the magenta developing unit 52, which contains magenta (M) toner, the black developing unit 53, which contains black (K) toner, and the yellow developing unit 54, which contains yellow (Y) toner, and since the configuration of these developing units is the same, the yellow developing unit 54 is described below.

The yellow developing unit 54 is provided with, for example, a developer containing section, that is, a first containing section 530 and a second containing section 535, for containing yellow toner T as a developer, the element 54a, a housing 540, the developing roller 510, which serves as the developer bearing member, a toner supply roller 550 for supplying toner T to the developing roller 510, and a restriction blade 560 for regulating the thickness of the layer of toner T that is borne on the developing roller 510.

The housing 540 is manufactured by joining an upper housing and a lower housing to form a single unit, and the inside of the housing is divided into the first containing section 530 and the second containing section 535 by a restriction wall 545 that extends upward from the lower section (the vertical direction of FIG. 5). The first containing section 530 and the second containing section 535 form developer containing sections (530, 535) for containing toner T as a developer. The upper sections of the first containing section 530 and the second containing section 535 are in communication, and the movement of the toner T is regulated by the restriction wall 545. It should be noted that it is also possible to provide a stirring member for stirring the toner T contained in the first containing section 530 and the second containing section 535, but in the present embodiment, the developing units (the cyan developing unit 51, the magenta developing unit 52, the black developing unit 53, and the yellow developing unit 54) rotate in conjunction with rotation of the rotary 55, thereby stirring the toner T in the developing units, and thus a stirring member is not provided in the first containing section 530 or the second containing section 535.

The element 54a, to which information can be written, is provided on an outer surface in the longitudinal direction of the housing 540. More specifically, the longitudinal direction of the element 54a intersects the longitudinal direction of the yellow developing unit 54 so that information is effectively written to the element 54a. More preferably, it is also possible to adopt a configuration in which the longitudinal direction of the element 54a is perpendicular to the longitudinal direction of the yellow developing unit 54. Moreover, the element 54a is provided on the outer surface of the housing 540 so that when the yellow developing unit 54 is mounted to the rotary 55 and rotated about the central shaft 50a, the element 54a, at a specific position, is in opposition to the main-unit-side antenna 124b and separated from it by such a distance that the antenna can wirelessly communicate with the main-unit-side antenna 124b. The element 54a has a configuration that allows it to store written information, and this will be described in greater detail later.

An opening 541 that communicates with the outside of the housing 540 is provided in the lower section of the first containing section 530. The toner supply roller 550 is provided in the first containing section 530 with its circumferential surface facing the opening 541, and is rotatably supported on the housing 540. Also, the developing roller 510 is provided with its circumferential surface facing the opening 541 from outside the housing 540, and the developing roller 510 abuts against the toner supply roller 550.

The developing roller 510 bears toner T and carries the toner to a developing position in opposition to the photoconductor 20. The developing roller 510 is made, for example, of aluminum, stainless steel or iron, and if necessary, it can be subjected to nickel plating or chrome plating, and the toner bearing region can be subjected to sandblasting or the like. Also, the developing roller 510 can rotate about its central axis, and as shown in FIG. 5, it rotates in the direction (in FIG. 5, the counterclockwise direction) opposite from the direction in which the photoconductor 20 rotates (in FIG. 5, the clockwise direction). Its central axis is lower than the central axis of the photoconductor 20. Also, as shown in FIG. 5, in a state where the yellow developing unit 54 is in opposition to the photoconductor 20, a gap exists between the developing roller 510 and the photoconductor 20. That is, the yellow developing unit 54 develops the latent image formed on the photoconductor 20 without being in contact with the photoconductor 20. It should be noted that when developing the latent image formed on the photoconductor 20, an alternating electric field is formed between the developing roller 510 and the photoconductor 20.

The toner supply roller 550 supplies the toner T contained in the first containing section 530 and the second containing section 535 to the developing roller 510. The toner supply roller 550 is made of polyurethane foam, for example, and abuts against the developing roller 510 in a state of elastic deformation. The toner supply roller 550 is arranged at a lower section of the first containing section 530, and the toner T contained in the first containing section 530 and the second containing section is supplied to the developing roller 510 by the toner supply roller 550 at a lower section of the first containing section 530. The toner supply roller 550 can rotate about its central axis, and its central axis is lower than the central axis of rotation of the developing roller 510. Also, the toner supply roller 550 rotates in a direction (in FIG. 5, the clockwise direction) that is opposite from the direction of rotation of the developing roller 510 (in FIG. 5, the counterclockwise direction). It should be noted that the toner supply roller 550 has the function of supplying the toner T that is contained in the first containing section 530 and the second containing section 535 to the developing roller 510 as well as the function of stripping off, from the developing roller 510, toner T remaining on the developing roller 510 after developing.

The restriction blade 560 regulates the thickness of the toner T layer borne on the developing roller 510, and applies charge to the toner T borne on the developing roller 510. The restriction blade 560 has a rubber section 560a and a rubber-supporting section 560b. The rubber section 560a is made of silicone rubber or urethane rubber, for example, and the rubber-supporting section 560b is a thin plate of phosphor bronze or stainless steel, for example, and has spring properties. The rubber section 560a is supported by the rubber-supporting section 560b, and one end of the rubber-supporting section 560b is fixed to a blade-supporting metal plate 562. The blade-supporting metal plate 562 is fastened to a seal frame 526, which is described later, and is attached to the housing 540 together with the restriction blade 560, forming a portion of a seal unit 520, which is described later. In this state, the rubber section 560a is pressed against the developing roller 510 by the elastic force created by the bending of the rubber-supporting section 560b.

Also, a blade-backing member 570 made of Moltoprene or the like is provided on the side of the restriction blade 560 that is opposite from the developing roller 510 side. The blade-backing member 570 prevents the toner T from entering in between the rubber-supporting section 560b and the housing 540, stabilizing the elasticity obtained by the bending of the rubber-supporting section 560b, and, by applying force to the rubber section 560a toward the developing roller 510 from directly behind the rubber section 560a, it presses the rubber section 560a against the developing roller 510. Consequently, the blade-backing member 570 increases the contact uniformity and the sealing properties of the rubber section 560a with respect to the developing roller 510.

The end of the restriction blade 560 on the side opposite from the side supported by the blade-supporting metal plate 562, that is, its tip, is not in contact with the developing roller 510, and a portion thereof away from its tip by a predetermined distance is in contact with the developing roller 510 with some breadth. That is, the restriction blade 560 does not abut against the developing roller 510 at its edge but rather at its mid section. Also, the restriction blade 560 is arranged such that its tip is facing upstream in the direction in which the developing roller 510 rotates, making so-called counter-abutment with respect to the developing roller 510. It should be noted that the abutting position where the restriction blade 560 abuts against the developing roller 510 is lower than the central axis of the developing roller 510 and is lower than the central axis of the toner supply roller 550.

The seal member 520 prevents the toner T in the yellow developing unit 54 from leaking outside the unit, and also collects toner T on the developing roller 510, after the developing roller 510 has passed the developing position, into the developing unit without scraping it off. The seal member 520 is a seal made of polyethylene film or the like. The seal member 520 is supported by a seal-supporting metal plate 522, and is attached to the frame 540 via the seal-supporting metal plate 522. A seal urging member 524 made of Moltoprene or the like is provided at the side of the seal member 520 that is opposite from the developing roller 510 side, and due to the elasticity of the seal urging member 524, the seal member 520 is pressed against the developing roller 510. It should be noted that the abutting position where the seal member 520 abuts against the developing roller 510 is above the central axis of the developing roller 510.

In the yellow developing unit 54 configured in this manner, the toner supply roller 550 supplies the toner T that is contained in the first containing section 530 and the second containing section 535, which function as developer containing sections, to the developing roller 510. The toner T that is supplied to the developing roller 510 is carried to the abutting position of the restriction blade 560 in conjunction with rotation of the developing roller 510, and when it passes the abutting position, the thickness of the toner T layer is regulated and charge is applied. The toner T on the developing roller 510, whose layer thickness has been regulated, is brought to the developing position in opposition to the photoconductor 20 due to further rotation of the developing roller 510, and is supplied for developing the latent image formed on the photoconductor 20 in an alternating electric field at the developing position. The toner T on the developing roller 510 that has passed the developing position due to further rotation of the developing roller 510 then passes the seal member 520 and is collected into the developing unit without being scraped off by the seal member 520.

===Configuration of the Elements===

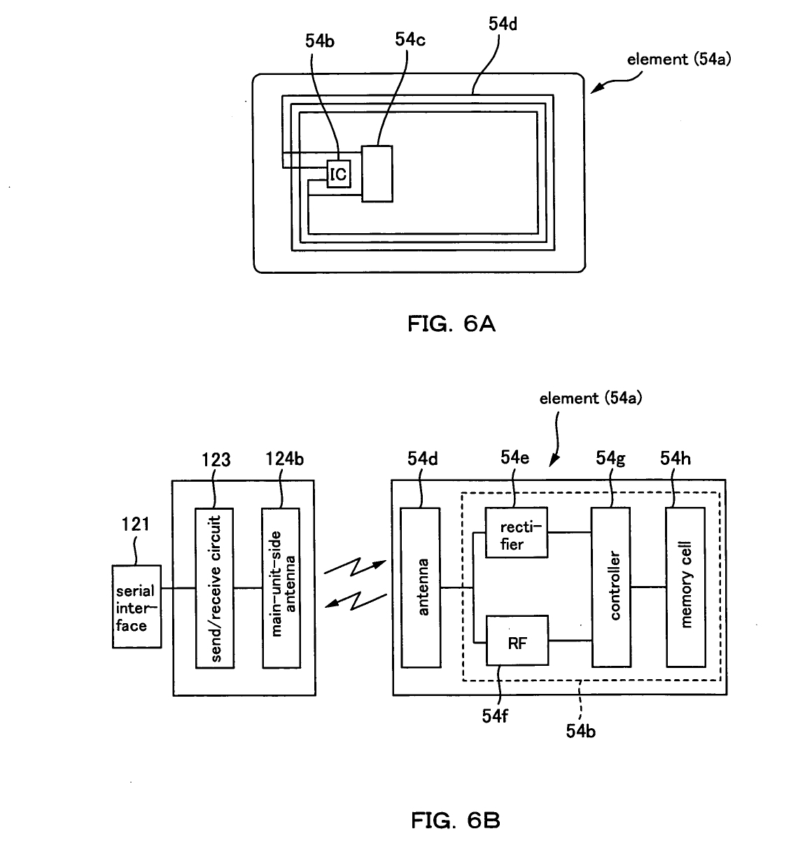

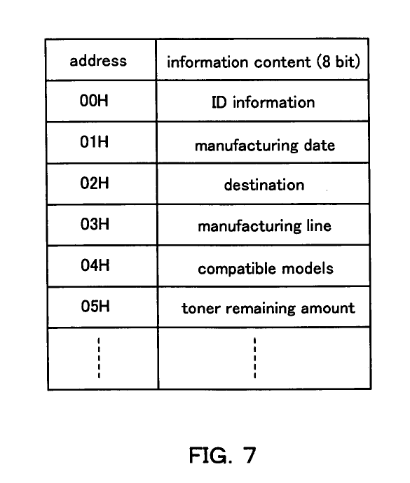

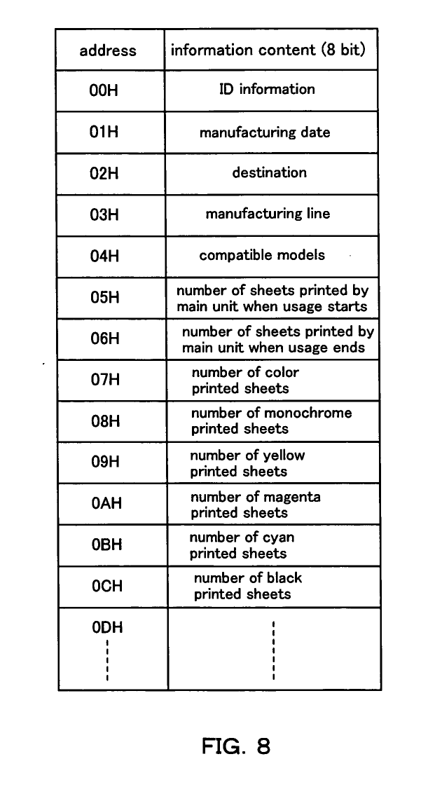

The configuration of the elements of the developing units and the element of the photoconductor unit, including the configuration for sending and receiving data, is described next with reference to FIG. 6A, FIG. 6B, FIG. 7, and FIG. 8. FIG. 6A is a transparent plan view showing the configuration of the elements. FIG. 6B is a block diagram for describing the internal configuration of the elements and the send/receive section. FIG. 7 is a diagram for describing the information stored in a memory cell 54h of the element 54a. FIG. 8 is a diagram for describing the information stored in the memory cell of the element 75a of the photoconductor unit 75.

Since the elements 51a, 52a, and 53a of the developing. units 51, 52, and 53 other than the yellow developing unit 54 are also of the same configuration, the element 54a of the yellow developing unit 54 is taken as an example and described below.

If the element 54a and the main-unit-side antenna 124b are in a predetermined positional relationship, for example, if they are within a distance of 10 mm of one another, information can be sent and received between the two in a non-contacting state. The element 54a is overall very compact and thin, and one of its surfaces can be made adhesive and attached to an object as a label. It is called a memory tag, for example, and is sold commercially in various forms.

The element 54a has anon-contact IC chip 54b, a capacitor for resonation 54c that is formed by etching a metal film, and a flat coil serving as the antenna 54d. These are mounted onto a plastic film and covered by a transparent cover sheet.

The main printer unit 10a has a coil serving as the main-unit-side antenna 124, the send/receive circuit 123, and the serial interface 121, which is connected to the controller (CPU) 120 of the main printer unit 10a.

The non-contact IC chip 54b has a rectifier 54e, a signal analysis section RF (Radio Frequency) 54f, a controller 54g, and the memory cell 54h. The memory cell 54h is a nonvolatile memory that can be electrically read and written, such as an NAND flash ROM, and is capable of storing information that has been written and reading stored information from the outside.

The antenna 54d of the element 54a and the main-unit-side antenna 124b wirelessly communicate with one another to read information stored on the memory cell 54h and write information to the memory cell 54h. Also, the high frequency signals that are generated by the send/receive circuit 123 of the main printer unit 10a are induced as a high frequency magnetic field via the main-unit-side antenna 124b. This high frequency magnetic field is absorbed via the antenna 54d of the element 54a and rectified by the rectifier 54e, thereby providing a direct current power source for driving the circuits in the IC chip 54b.

The memory cell 54h of the element 54a stores various types of information, as shown in FIG. 7. The address 00H (H indicates hexadecimal) stores unique ID information for each element, such as the serial number of the element, the address 01H stores the date that the developing unit was manufactured, the address 02H stores information for specifying the destination of the developing unit, the address 03H stores information for specifying the manufacturing line on which the developing unit was manufactured, the address 04H stores information for specifying models with which the developing unit is compatible, the address 05H stores toner remaining amount information as information indicating the amount of toner that is contained in the developing unit, and the address 06H and subsequent regions store appropriate information.

The ID information that is stored on the above memory cell 54h of the element 54a can be written at the time that the storage element is manufactured in the factory. The main printer unit 10a can read this ID information to identify the individual elements 54a, 51a, 52a, 53a.

It should be noted that the element 75a of the photoconductor unit 75 has the same configuration. The memory cell of the element 75a of the photoconductor unit 75 stores various types of information, as shown in FIG. 8.

The address 00H stores unique ID information for each element, such as the serial number of the element, the address 01H stores the date that the photoconductor unit was manufactured, the address 02H stores information for specifying the destination of the photoconductor unit, the address 03H stores information for specifying the manufacturing line on which the photoconductor unit was manufactured, the address 04H stores information for specifying models with which the photoconductor unit is compatible, the address 05H stores information indicating the total number of printed sheets of the main printer unit 10a when the photoconductor unit is mounted to the main printer unit 10a, the address 06H stores information indicating the total number of printed sheets of the main printer unit 10a when the photoconductor unit has reached its service life and is detached from the main printer unit 10a, the address 07H stores the number of sheets for which color printing has been performed using that photoconductor unit, the address 08H stores the number sheets for which monochrome printing has been performed using that photoconductor unit, the address 09H stores the number of sheets developed by the yellow developing unit 54, that is, the number of sheets printed using yellow toner, the address 0AH stores the number of sheets developed by the magenta developing unit 52, that is, the number of sheets printed using magenta toner, the address 0BH stores the number of sheets developed by the cyan developing unit 51, that is, the number of sheets printed using cyan toner, the address 0CH stores the number of sheets developed by the black developing unit 53, that is, the number of sheets printed using black toner, and the address ODH and subsequent regions also store appropriate information.

It should be noted that it is also possible to write, to the element 75a of the photoconductor unit 75, information on the amount of toner remaining or the amount of toner used, for example, of the developing units 51, 52, 53, and 54.

===Positional Relationship Between the Element and the Main-Unit-Side Antenna===

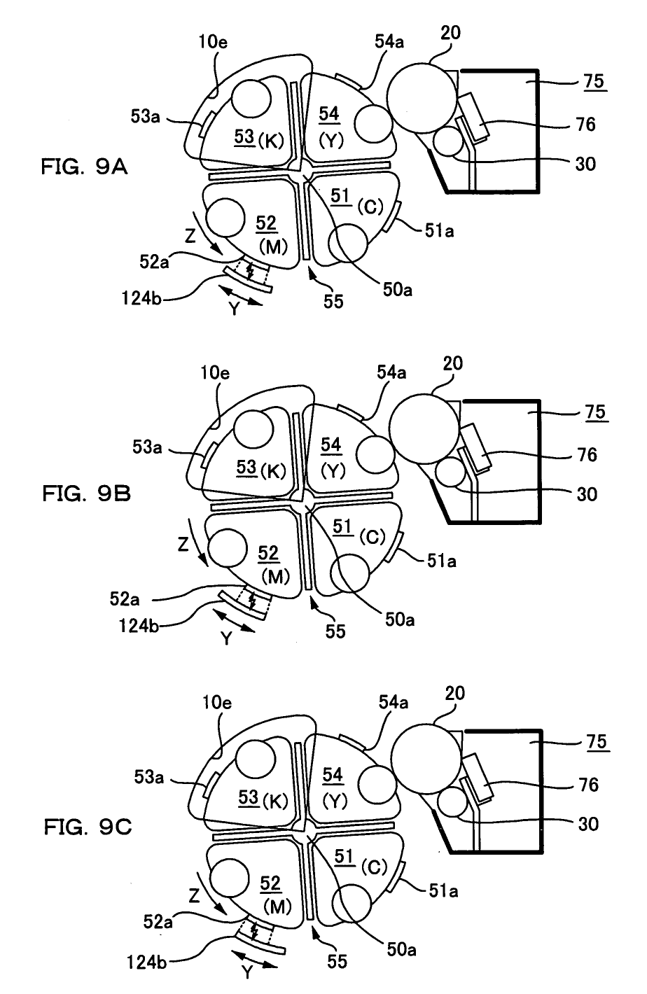

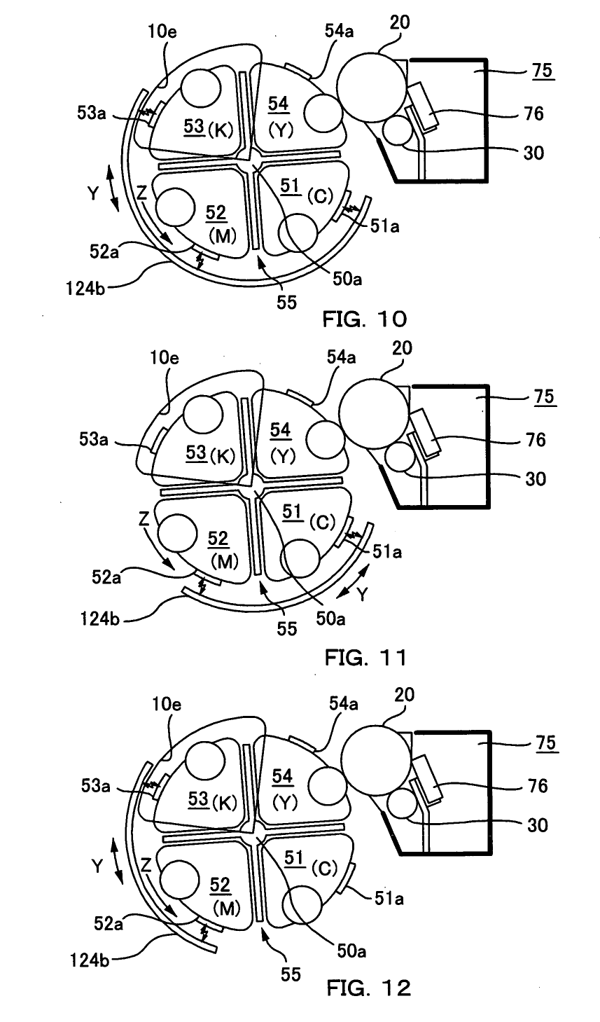

The relationship between the elements of the developing units and the main-unit-side antenna 124b is described with reference to FIG. 9A to FIG. 9C, FIG. 10, FIG. 11, and FIG. 12. FIG. 9, FIG. 10, FIG. 11, and FIG. 12 are diagrams for describing the positional relationship between the elements and the main-unit-side antenna.

In FIG. 9A, the yellow developing unit 54 is stopped at a developing position (opposition position) for developing the latent image on the photoconductor 20, and the main-unit-side antenna 124b is provided at a position on the outside in the radial direction of rotation of the rotary 55, and in opposition to the element 52a of the magenta developing unit 52, which is on the side opposite from the yellow developing unit 54 with respect to the central shaft 50a of the rotary 55. The main-unit-side antenna 124b is provided in the direction of rotation of the rotary 55, and the length of the main-unit-side antenna 124b in its longitudinal direction (the Y direction in FIG. 9A) is a length that allows the antenna to be in opposition to the entire longitudinal length of the element 52a. It should be noted that FIG. 9A shows a case where the yellow developing unit 54 is stopped at the developing position, but if the cyan developing unit 51 is stopped at the developing position, then the main-unit-side antenna 124b comes into opposition to the entire longitudinal direction of the element 53a of the black developing unit 53, if the magenta developing unit 52 is stopped at the developing position, then the main-unit-side antenna 124b comes into opposition to the entire longitudinal direction of the element 54a of the yellow developing unit 54, and if the black developing unit 53 is stopped at the developing position, then the main-unit-side antenna 124b comes into in opposition to the entire longitudinal direction of the element 51a of the cyan developing unit 51. FIG. 9B shows another example of how the main-unit-side antenna 124b is arranged, and shows a state where, with respect to FIG. 9A, the longitudinal direction of the main-unit-side antenna 124b is shifted in the clockwise direction about the central shaft 50a of the rotary 55. In this case, the longitudinal direction of the main-unit-side antenna 124b is arranged deviated within a range where it is in opposition to the entire longitudinal direction of the element 52a. Thus, like FIG. 9A, the time during which a predetermined developing unit is developing the latent image on the photoconductor 20 is utilized to efficiently write information, in a non-contacting state, to the element of the developing unit that is on the side opposite from the predetermined developing unit with respect to the central shaft 50a of the rotary 55.

FIG. 9C, like FIG. 9B, shows another example of how the main-unit-side antenna 124b is arranged, and shows a state where, with respect to FIG. 9A, the longitudinal direction of the main-unit-side antenna 124b is shifted in the counterclockwise direction about the central shaft 50a of the rotary 55. In this case, the longitudinal direction of the main-unit-side antenna 124b is arranged deviated within a range where it is in opposition to the entirety of the element 52a in the longitudinal direction. Thus, like FIG. 9A, the time during which a predetermined developing unit is developing the latent image on the photoconductor 20 is utilized to efficiently write information, in a non-contacting state, to the element of the developing unit that is on the side opposite from the predetermined developing unit with respect to the central shaft 50a of the rotary 55.

It should be noted that in FIG. 9A to FIG. 9C, when a predetermined developing unit is stopped at the developing position, the main-unit-side antenna 124b was described as being provided at a position outside of and in opposition to the element of the developing unit that is on the side opposite from the predetermined developing unit with respect to the central shaft 50a of the rotary 55, but the position where the main-unit-side antenna 124b is arranged is not limited to this position. That is, the main-unit-side antenna 124b can also be provided at a position that is outside of and in opposition to the element of any one of the other developing units that are not performing the development (in the case of the rotation position of the rotary 55 shown in FIG. 9, the element 51a or the element 53a).

In FIG. 10, the yellow developing unit 54 is stopped at the developing position (opposition position) for developing the latent image on the photoconductor 20, and the main-unit-side antenna 124b is provided at apposition where it is outside in the radial direction of rotation of the rotary 55, and in opposition to a total of three elements: the element 51a of the cyan developing unit 51, the element 52a of the magenta developing unit 52, and the element 53a of the black developing unit 53. The main-unit-side antenna 124b is provided continuous in the direction of rotation of the rotary 55, and the length of the main-unit-side antenna 124b in the longitudinal direction (in FIG. 10, they direction) is a length that allows the antenna to be in opposition to the entirety of the elements 51a, 52a, and 53a in the longitudinal direction. It should be noted that FIG. 10 shows a case where the yellow developing unit 54 is stopped at the developing position, but if the cyan developing unit 51 is stopped at the developing position, then the main-unit-side antenna 124b comes into opposition to the entirety of the element 52a, the element 53a, and the element 54a in the longitudinal direction, if the magenta developing unit 52 is stopped at the developing position, then the main-unit-side antenna 124b comes into opposition to the entirety of the element 53a, the element 54a, and the element 51a in the longitudinal direction, and if the black developing unit 53 is stopped at the developing position, then the main-unit-side antenna 124b comes into opposition to the entirety of the element 54a, the element 51a, and the element 52a in the longitudinal direction. In FIG. 11, the yellow developing unit 54 is stopped at the developing position (opposition position) for developing the latent image on the photoconductor 20, and the main-unit-side antenna 124b is provided at a position where it is outside in the radial direction of rotation of the rotary 55, and in opposition to a total of two elements: the element 51a of the cyan developing unit 51 and the element 52a of the magenta developing unit 52. The main-unit-side antenna 124b is provided continuous in the direction of rotation of the rotary 55, and-the length of the main-unit-side antenna 124b in the longitudinal direction (in FIG. 11, the Y direction) is a length that allows the antenna to be in opposition to the entirety of the elements 51a and 52a in the longitudinal direction. It should be noted that FIG. 11 shows a case where the yellow developing unit 54 is stopped at the developing position, but if the cyan developing unit 51 is stopped at the developing position, then the main-unit-side antenna 124b comes into opposition to the entirety of the element 52a and the element 53a in the longitudinal direction, if the magenta developing unit 52 is stopped at the developing position, then the main-unit-side antenna 124b comes into opposition to the entirety of the element 53a and the element 54a in the longitudinal direction, and if the black developing unit 53 is stopped at the developing position, then the main-unit-side antenna 124b comes into opposition to the entirety of the element 54a and the element 51a in the longitudinal direction. Thus, the predetermined developing unit, in FIG. 12, is stopped at the developing position (opposition position) for the yellow developing unit 54 to develop the latent image on the photoconductor 20, and the main-unit-side antenna 124b is provided at a position where it is outside in the radial direction of rotation of the rotary 55, and in opposition to the a total of two elements: the element 52a of the magenta developing unit 52 and the element 53a of the black developing unit 53. The main-unit-side antenna 124b is provided continuous in the direction of rotation of the rotary 55, and the length of the main-unit-side antenna 124b in the longitudinal direction (in FIG. 12, the Y direction) is a length that allows the antenna to be in opposition to the entirety of the elements 52a and 53a in the longitudinal direction. It should be noted that FIG. 12 shows a case where the yellow developing unit 54 is stopped at the developing position, but if the cyan developing unit 51 is stopped at the developing position, then the main-unit-side antenna 124b comes into opposition to the entirety of the element 53a and the element 54a in the longitudinal direction, if the magenta developing unit 52 is stopped at the developing position, then the main-unit-side antenna 124b comes into opposition to the entirety of the element 54a and the element 51a in the longitudinal direction, and if the black developing unit 53 is stopped at the developing position, then the main-unit-side antenna 124b comes into opposition to the entirety of the element 51a and the element 52a in the longitudinal direction. Thus, the predetermined developing unit, Meanwhile, with an image forming apparatus in which a developing unit, which has a developer containing section and an element to which information can be written, can be attached to and detached from an attach/detach section, there is a possibility that a developing unit mounted to the attach/detach section may become detached from the attach/detach section for some reason. Therefore, it is preferable that information indicating the remaining amount or the usage amount, for example, of the developer contained in the developer containing section of that developing unit is suitably written to the element of that developing unit while the developing unit is mounted to the attach/detach section. However, if information is written to the element of a developing unit that is performing development when that developing unit is developing the latent image on the photoconductor, there is a possibility that the operation of the developing unit developing the latent image on the photoconductor will affect the operation of writing information to the element, precluding the writing of correct information to the element.

Here, in the present embodiment, the time during which the yellow developing unit 54 is developing the latent image on the photoconductor 20 can be utilized to write information to at least one of the elements 51a, 52a, and 53a of the other developing units 51, 52, and 53 that are not performing the development. Thus, information can be written efficiently, with the negative impact of the developing operation being inhibited. It should be noted that the same applies when the other developing units 51, 52, and 53 are developing the latent image on the photoconductor 20.

In particular, when the yellow developing unit 54 mounted to the rotary 55, which moves rotatively, is developing the latent image on the photoconductor 20, correct information can be written to at least one of the elements 51a, 52a, and 53a of the other developing units 51, 52, and 53 that are not performing the development. It should be noted that the same applies when the other developing units 51, 52, and 53 are developing the latent image on the photoconductor 20.

It is also possible for the element 54a to be provided on the outer surface in the longitudinal direction of the yellow developing unit 54 and for the main-unit-side antenna 124b to be provided at a position that is more outside, in the radial direction of rotation of the rotary 55, than the elements of the developing units 51, 52, and 53 that are not performing the development. In this case, the main-unit-side antenna 124b that is provided at a position more outside, in the radial direction of rotation of the rotary 55, than the elements 51a, 52a, and 53a of the developing units 51, 52, and 53 that are not performing the development can be used to write correct information to at least one of the elements 51a, 52a, and 53a of the developing units 51, 52, and 53 that are not performing the development. It should be noted that the same applies when the other developing units 51, 52, and 53 are developing the latent image on the photoconductor 20.

It is also possible for the main-unit-side antenna 124b to be provided at a position that is more outside, in the radial direction of rotation of the rotary 55, than the element 52a of the magenta developing unit 52, which is on the side opposite, with respect to the central shaft 50a of the rotary 55, from the yellow developing unit 54 that is developing the latent image on the photoconductor 20. In this case, the main-unit-side element 124b, which is provided at a position that is more outside, in the radial direction of rotation of the rotary 55, than the element 52a of the magenta developing unit 52 being on the side opposite, with respect to the central shaft 50a of the rotary 55, from the yellow developing unit 54 that is developing the latent image on the photoconductor 20, that is, a position where the main-unit-side antenna 124b is farthest from the photoconductor 20, can be used to effectively write correct information to the element 52a of the magenta developing unit 52. It should be noted that the same applies when the other developing units 51, 52, and 53 are developing the latent image on the photoconductor 20.

It is also possible for the longitudinal direction of the main-unit-side antenna 124b to be in the direction of rotation of the rotary 55. In this case, the main-unit-side antenna 124b, whose longitudinal direction is provided in the direction of rotation of the rotary 55, can be used to write correct information to the elements of the developing units that are not performing the development, even if there is error in the amount of rotative movement when the rotary 55 selectively positions the developing units 51, 52, 53, and 54, which are mounted to the attach/detach sections 55a, 55b, 55d, and 55e, in opposition to the photoconductor 20.

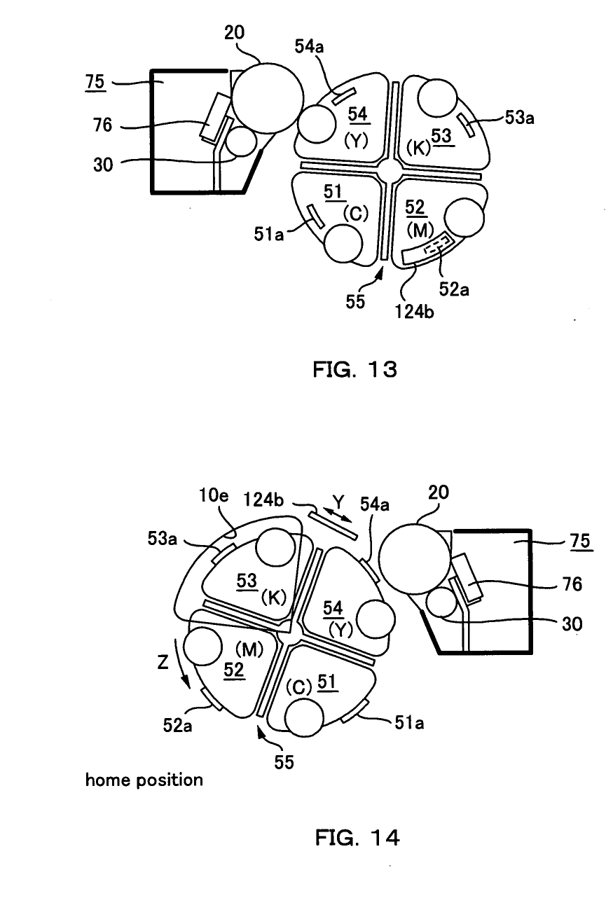

It is also possible for the element 54a to be provided on a lateral surface A (see FIG. 4) of the yellow developing unit 54 that is on the leading side when the yellow developing unit 54 is being attached to the attach/detach section 55e, and for the main-unit-side antenna 124b to be provided at a position that is more outside, in the axial direction of rotation of the rotary 55, than the elements 51a, 52a, and 53a of the developing units 51, 52, and 53 that are not performing the development. In this case, the main-unit-side antenna 124b that is provided at a position that is more outside, in the axial direction of rotation of the rotary 55, than the elements 51a, 52a, and 53a of the developing units 51, 52, and 53 that are not performing the development can be used to write correct information to at least one of the elements 51a, 52a, and 53a of the developing units 51, 52, and 53 that are not performing the development. It should be noted that the same applies when the other developing units 51, 52, and 53 are developing the latent image on the photoconductor 20. In FIG. 13, the main-unit-side antenna 124b is provided at a position that is more outside, in the axial direction of rotation of the rotary 55, than the element 52a of the developing unit 52, but this is not a limitation. That is, it is also possible for the main-unit-side antenna 124b, when development is being carried out with the rotary 55 at the position of FIG. 13, to write information to the elements 51a or 53a in a non-contacting state. It is also possible for the main-unit-side antenna 124b to write information to the element 54a in a non-contacting state. In this case, correct information can be written, in a non-contacting state, to the elements 51a, 52a, and 53a of the developing units 51, 52, and 53 that are not performing the development. It should be noted that the same applies when the other developing units 51, 52, and 53 are developing the latent image on the photoconductor 20.

It is also possible to use the main-unit-side antenna 124b to write, to the element 54a, information that indicates the remaining amount or the usage amount of the developer contained in the yellow developing unit 54 provided with the element 54a. The developer contained in the developer containing sections of the yellow developing unit 54 decreases as developing is performed, and thus it is preferable to suitably write, to the element 54a, information that allows the remaining amount of developer to be known. Accordingly, correct information indicating the remaining amount or the usage amount of the developer contained can be written to the elements 51a, 52a, and 53a of the developing unit 51, 52, and 53 that are not performing the development. It should be noted that the same applies when the other developing units 51, 52, and 53 are developing the latent image on the photoconductor 20.

It is also possible for there to be an AC voltage supply section 126a for supplying an AC voltage, and for the main-unit-side antenna 124b to be used to write information to the elements of the other developing units that are not performing the development when the AC voltage supply section 126a is supplying an AC voltage to a predetermined developing unit, of among the developing units 51, 52, 53, and 54 mounted to the attach/detach sections 55a, 55b, 55d, and 55e, so as to develop the latent image on the photoconductor 20. When the AC voltage supply section 126a is supplying an AC voltage to the yellow developing unit 54 so that it develops the latent image on the photoconductor 20, there is a possibility that electromagnetic noise from the AC voltage supply section 126a will be generated at its periphery and affect the yellow developing unit 54. Accordingly, the main-unit-side antenna 124b, which is provided at a position that is in opposition to the elements 51a, 52a, and 53a of the developing units 51, 52, and 53 other than the yellow developing unit 54 that is performing development during which time the unit 54 is most susceptible to the effects of electromagnetic noise, is used so that correct information can be written to the elements 51a, 52a, and 53a of the developing units 51, 52, and 53 that are not performing the development. It should be noted that the same applies when the other developing units 51, 52, and 53 are developing the latent image on the photoconductor 20.

It is also possible for the yellow developing unit 54 to include the developing roller 510 for bearing the developer and for the AC voltage supply section 126a to supply an AC voltage to the developing roller 510. In this case, correct information can be written to the elements 51a, 52a, and 53a of the developing units 51, 52, and 53 that are not performing the development, even if the yellow developing unit 54 has the developing roller 510 to which an AC voltage is supplied from the AC voltage supply section 126a. It should be noted that the same applies when the other developing units 51, 52, and 53 are developing the latent image on the photoconductor 20.

It is also possible for the difference between the maximum voltage value and the minimum voltage value of the AC voltage to be 1000 volts or more. When the difference between the maximum voltage value and the minimum voltage value of the AC voltage is 1000 volts or more, the electromagnetic noise is also large. Accordingly, the main-unit-side antenna 124b, which is provided at a position that is in opposition to the elements 51a, 52a, and 53a of the developing units 51, 52, and 53 other than the yellow developing unit 54 that is performing development during which time the unit 54 is most susceptible to the effects of electromagnetic noise, is used so that correct information can be written to the elements 51a, 52a, and 53a of the developing units 51, 52, and 53 that are not performing the development. It should be noted that the same applies when the other developing units 51, 52, and 53 are developing the latent image on the photoconductor 20.

It should be noted that FIG. 14 shows a state where the rotary 55 is positioned at the home position after the printer 10 has been turned ON and the initialization operation has been performed.

===Writing Information to Elements of the Developing Units===

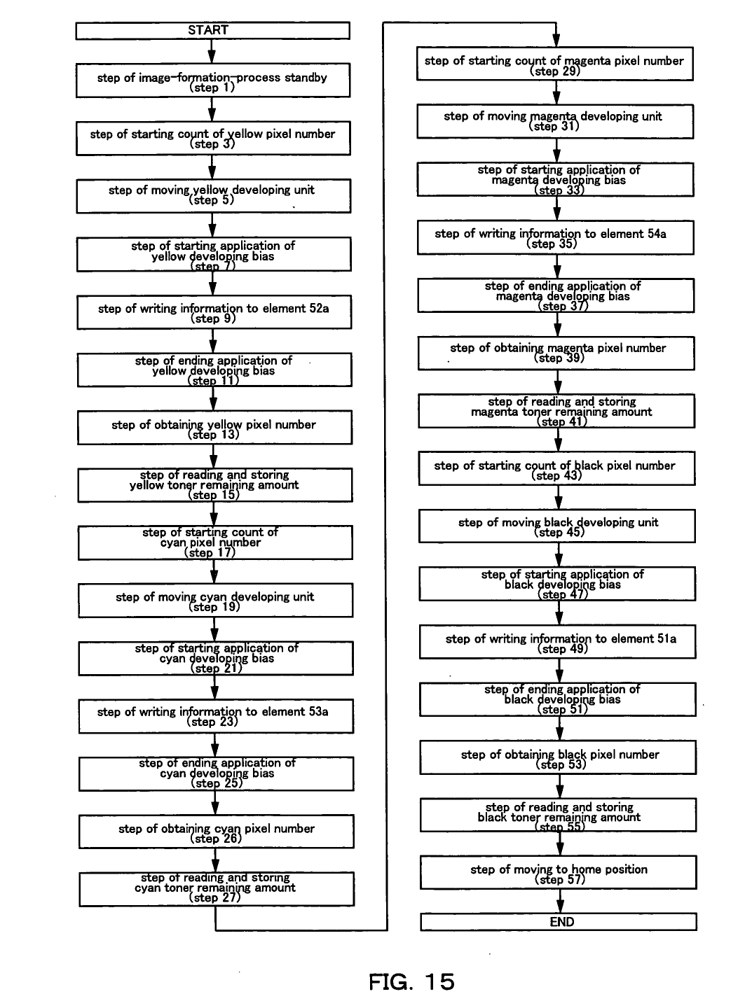

The writing of information to the elements of the developing units is described next with reference to FIG. 15. FIG. 15 is a flowchart for describing how information is written to the elements of the developing units. It should be noted that a case where the main-unit-side antenna 124b is provided at the position shown in FIG. 9A is taken as an example.

<Step of Image-Formation-Process Standby (Step 1)>

When the printer 10 is turned ON, a predetermined initialization process is performed and the printer 10 enters an image-formation-process standby state at the home position shown in FIG. 14. When an image signal serving as an image-formation-process order is input from the host computer to the main controller 101 of the printer 10 via the interface (I/F) 112, the photoconductor 20 and the intermediate transferring member 70 are rotated. Then, the read sensor for synchronization RS detects the reference position of the intermediate transferring member 70 and outputs a pulse signal. The unit controller 102 executes the following control, using the received pulse signal as a reference.

<Step of Starting Count of Yellow Pixel Number (Step 3)>

A latent image that corresponds to the yellow image information is formed on the charged photoconductor 20 by the exposing unit 40. At this time, the pixel counter 127a starts counting the number of pixels input to the exposing unit 40.

<Step of Moving Yellow Developing Unit (Step 5)>

The rotary 55 is rotated, thereby moving the yellow developing unit 54 to the developing position. At this time, the element 52a of the magenta developing unit 52 is stopped at a position in opposition to the main-unit-side antenna 124b. The element 52a and the main-unit-side antenna 124b are apart by a distance that permits wireless communication between the two.

<Step of Starting Application of Yellow Developing Bias (Step 7)>

Application of a developing bias to the developing roller of the yellow developing unit 54 is started. Thus, the latent image formed on the photoconductor 20 is developed with yellow toner. The developing bias that is applied is a voltage in which AC voltage and DC voltage are superimposed, as mentioned above. It should be noted that it is possible to apply the developing bias to the developing roller before the yellow developing unit 54 arrives at the developing position, or it is instead possible to apply the developing bias to the developing roller after the yellow developing unit 54 arrives at the developing position.

<Step of Writing Information to the Element 52a (Step 9)>

When the developing bias is being applied to the developing roller of the yellow developing unit 54, the latest remaining amount MMnew of magenta toner, which has already been written, at the time of the image formation process based on the previous image signal, to the magenta toner remaining amount storage region of the RAM in the same manner as in the later-discussed step 41, is read out, and using the main-unit-side antenna 124b, the latest remaining amount MMnew of magenta toner is written, in a non-contacting state, to the element 52a in opposition to the main-unit-side antenna 124b.

<Step of Ending Application of Yellow Developing Bias (Step 11)>

At a predetermined timing, application of the developing bias to the developing roller of the yellow developing unit 54 is ended. Thus, the operation of developing with the yellow developing unit 54 is ended.

<Step of Obtaining Yellow Pixel Number (Step 13)>

The number of pixels that have been counted is obtained from the pixel counter 127a. The number of counted pixels is proportional to the amount of toner that is consumed, and thus the amount of yellow toner that is consumed YT can be obtained.

<Step of Reading and Storing Yellow Toner Remaining Amount (Step 15)>

The yellow toner remaining amount YY that is stored in the yellow toner remaining amount storage region of the RAM is read out from the RAM and a value YYnew obtained by subtracting the consumed amount YT from the remaining amount YY is stored in the yellow toner remaining amount storage region of the RAM as the new remaining amount.

<Step of Starting Count of Cyan Pixel Number (Step 17)>

A latent image that corresponds to the cyan image information is formed on the charged photoconductor 20 by the exposing unit 40. At this time, the pixel counter 127a starts counting the number of pixels input to the exposing unit 40.

<Step of Moving Cyan Developing Unit (Step 19)>

The rotary 55 is rotated, thereby moving the cyan developing unit 51 to the developing position. At this time, the element 53a of the black developing unit 53 is stopped at a position in opposition to the main-unit-side antenna 124b. The element 53a and the main-unit-side antenna 124b are apart by a distance that permits wireless communication between the two.

<Step of Starting Application of Cyan Developing Bias (Step 21)>

Application of a developing bias to the developing roller of the cyan developing unit 51 is started. Thus, the latent image formed on the photoconductor 20 is developed with cyan toner.

<Step of Writing Information to the Element 53a (Step 23)>

When the developing bias is being applied to the developing roller of the cyan developing unit 51, the latest remaining amount BBnew of black toner, which has already been written, at the time of the image formation process based on the previous image signal, to the black toner remaining amount storage region of the RAM in the same manner as in the later-discussed step 55, is read out, and using the main-unit-side antenna 124b, the latest remaining amount BBnew of black toner is written, in a non-contacting state, to the element 53a in opposition to the main-unit-side antenna 124b.

<Step of Ending Application of Cyan Developing Bias (Step 25)>

At a predetermined timing, application of the developing bias to the developing roller of the cyan developing unit 51 is ended. Thus, the operation of developing with the cyan developing unit 51 is ended.

<Step of Obtaining Cyan Pixel Number (Step 26)>

The number of pixels that have been counted is obtained from the pixel counter 127a. The number of counted pixels is proportional to the amount of toner that is consumed, and thus the amount of cyan toner that is consumed CT can be obtained.

<Step of Reading and Storing Cyan Toner Remaining Amount (Step 27)>

The cyan toner remaining amount CC that is stored in the cyan toner remaining amount storage region of the RAM is read out from the RAM and a value CCnew obtained by subtracting the consumed amount CT from the remaining amount CC is stored in the cyan toner remaining amount storage region of the RAM as the new remaining amount.

<Step of Starting Count of Magenta Pixel Number (Step 29)>

A latent image that corresponds to the magenta image information is formed on the charged photoconductor 20 by the exposing unit 40. At this time, the pixel counter 127a starts counting the number of pixels input to the exposing unit 40.

<Step of Moving Magenta Developing Unit (Step 31)>

The rotary 55 is rotated, thereby moving the magenta developing unit 52 to the developing position. At this time, the element 54a of the yellow developing unit 54 is stopped at a position in opposition to the main-unit-side antenna 124b. The element 54a and the main-unit-side antenna 124b are apart by a distance that permits wireless communication between the two.

<Step of Starting Application of Magenta Developing Bias (Step 33)>

Application of a developing bias to the developing roller of the magenta developing unit 52 is started. Thus, the latent image formed on the photoconductor 20 is developed with magenta toner.

<Step of Writing Information to the Element 54a (Step 35)>

When the developing bias is being applied to the developing roller of the magenta developing unit 52, the latest remaining amount YYnew of yellow toner, which has been written to the yellow toner remaining amount storage region of the RAM in step 15, is read out, and using the main-unit-side antenna 124b, the latest remaining amount YYnew of yellow toner is written, in a non-contacting state, to the element 54a in opposition to the main-unit-side antenna 124b.

<Step of Ending Application of Magenta Developing Bias (Step 37)>

At a predetermined timing, application of the developing bias to the developing roller of the magenta developing unit 52 is ended. Thus, the operation of developing with the magenta developing unit 52 is ended.

<Step of Obtaining Magenta Pixel Number (Step 39)>

The number of pixels that have been counted is obtained from the pixel counter 127a. The number of counted pixels is proportional to the amount of toner that is consumed, and thus the amount of magenta toner that is consumed MT can be obtained.

<Step of Reading and Storing Magenta Toner Remaining Amount (Step 41)>

The magenta toner remaining amount MM that is stored in the magenta toner remaining amount storage region of the RAM is read out from the RAM and a value MMnew obtained by subtracting the consumed amount MT from the remaining amount MM is stored in the magenta toner remaining amount storage region of the RAM as the new remaining amount. It should be noted that the new remaining amount MMnew is written, in a non-contacting state, to the element 52a using the main-unit-side antenna 124b when performing the image formation process in accordance with the next image signal.

<Step of Starting Count of Black Pixel Number (Step 43)>

A latent image that corresponds to the black image information is formed on the charged photoconductor 20 by the exposing unit 40. At this time, the pixel counter 127a starts counting the number of pixels input to the exposing unit 40.

<Step of Moving Black Developing Unit (Step 45)>

The rotary 55 is rotated, thereby moving the black developing unit 53 to the developing position. At this time, the element 51a of the cyan developing unit 51 is stopped at a position in opposition to the main-unit-side antenna 124b. The element 51a and the main-unit-side antenna 124b are apart by a distance that permits wireless communication between the two.

<Step of Starting Application of Black Developing Bias (Step 47)>

Application of a developing bias to the developing roller of the black developing unit 53 is started. Thus, the latent image formed on the photoconductor 20 is developed with black toner.

<Step of Writing Information to the Element 51a (Step 49)>

When the developing bias is being applied to the developing roller of the black developing unit 53, the latest remaining amount CCnew of cyan toner, which has been written to the cyan toner remaining amount storage region of the RAM in step 27, is read out, and using the main-unit-side antenna 124b, the latest remaining amount CCnew of cyantoner is written, in a non-contacting state, to the element 51a in opposition to the main-unit-side antenna 124b.

<Step of Ending Application of Black Developing Bias (Step 51)>

At a predetermined timing, application of the developing bias to the developing roller of the black developing unit 53 is ended. Thus, the operation of developing with the black developing unit 53 is ended.

<Step of Obtaining Black Pixel Number (Step 53)>

The number of pixels that have been counted is obtained from the pixel counter 127a. The number of counted pixels is proportional to the amount of toner that is consumed, and thus the amount of black toner that is consumed BT can be obtained.

<Step of Reading and Storing Black Toner Remaining Amount (Step 55)>

The black toner remaining amount BB that is stored in the black toner remaining amount storage region of the RAM is read out from the RAM and a value BBnew obtained by subtracting the consumed amount BT from the remaining amount BB is stored in the black toner remaining amount storage region of the RAM as the new remaining amount. It should be noted that the new remaining amount BBnew is written, in a non-contacting state, to the element 53a using the main-unit-side antenna 124b when performing the image formation process in accordance with the next image signal.

<Step of Moving to Home Position (Step 57)>

Rotation of the rotary 55 is started to position the rotary 55 at the home position. When the rotary 55 arrives at the home position, the image formation process is ended, and the state of image-formation-process standby is entered.

The process described above is only an example, and modifications may be freely made thereto as long as the main-unit-side antenna 124b, which serves as a writing member, can write information to the elements of the developing units.

### Other Embodiments

In the foregoing, developing units, for example, according to the present invention were described in an embodiment thereof. However, the foregoing embodiment of the invention is for the purpose of elucidating the present invention and is not to be interpreted as limiting the present invention. The invention can of course be altered and improved without departing from the gist thereof, and includes equivalents.

<Another Example of AC Voltage Application>

It is also possible for the AC voltage supply section 126a to supply an AC voltage to the charging unit 30 via the charging unit drive circuit so that the charging unit 30 charges the photoconductor 20 in an alternating electric field. It is also possible to adopt a configuration in which the AC voltage supply section 126a supplies an AC voltage to the first transferring unit 60 via the first transferring unit drive circuit.

<Intensity of the AC Voltage>

The present embodiment is particularly effective for an image formation process in which there is a large difference between the maximum voltage value and the minimum voltage value applied by the AC voltage supply section 126a. For example, it is particularly effective for image forming apparatuses in which there is a 1000 volt or greater difference between the maximum voltage value and the minimum voltage value. When there is a difference of 1000 volts or more between the maximum voltage value and the minimum voltage value of the AC voltage, the electromagnetic noise that occurs is also large. In such image forming apparatuses, by writing information to the elements of other developing units that are not performing the development when the AC voltage supply section 126a is supplying an AC voltage to a predetermined developing unit such that it develops the latent image on the photoconductor 20, it is possible to accurately write information without being affected by the large noise that is caused due to the supply of AC voltage, for example.

<Developing Unit>

The developing unit is not limited to a device of the configuration described in the above embodiment, and it may be adopted for any kind of developing unit. As long as the developing unit has an element to which information can be written and a developer containing section, then it may be of any configuration. For example, it is also possible for the developing unit to be provided in the main printer unit 10a without the developing unit having a developer bearing member.

For example, as the developer bearing roller, as long as a developer bearing roller can be obtained, it is possible to use any of magnetic material, non-magnetic material, conductive material, insulating material, metal, rubber, and resin, for example. For example, as the material it is possible to use a metal such as aluminum, nickel, stainless steel, and iron, a rubber such as natural rubber, silicone rubber, urethane rubber, butadiene rubber, chloroprene rubber, neoprene rubber, and NBR, or a resin such as styrene resin, vinyl chloride resin, polyurethane resin, polyethylene resin, methacrylic resin, and nylon resin, for example. It is of course also possible to use these materials with a coating on their upper layer section. In this case, as the coating material it is possible to use polyethylene, polystyrene, polyurethane, polyester, nylon, or acrylic, for example. Also, as regards its form, it is possible to adopt any of a non-elastic body, an elastic body, a single layer, multiple layers, a film, and a roller, for example. Also, the developer is not limited to toner, and it may also be a two-component developer in which a carrier has been mixed.

The same applies for the toner supply member as well, and as the material thereof it is possible to use polystyrene foam, polyethylene foam, polyester foam, ethylene propylene foam, nylon foam, and silicone foam, for example, in addition to polyurethane foam, which was mentioned above. It should be noted that either open-cell foam or closed-cell foam can be used as the foam cell of the toner supply means. It should also be noted that there is no limitation to foam material, and it is also possible to use a rubber material having elasticity. More specifically, it is possible to use silicone rubber, urethane rubber, natural rubber, isoprene rubber, styrene butadiene rubber, butadiene rubber, chloroprene rubber, butyl rubber, ethylene propylene rubber, epichlorohydrin rubber, nitrile butadiene rubber, or acrylic rubber, molded with a conductive agent such as carbon dispersed therein.

<Photoconductor Unit>

The photoconductor unit 75 also is not limited to the device of the configuration described in the above-described embodiment, and it may be adopted for any kind of device. It is only necessary that the photoconductor unit 75 has an element to which information can be written and a photoconductor. For example, it is also possible for it to not have the charging unit 30, and instead for the charging unit to be provided in the main printer unit 10a. Also, the photoconductor is not limited to a roller-shaped photoreceptive roller, and it may also be belt-shaped.

<Elements>

The elements of the developing units and the element of the photoconductor unit are not limited to the configuration described above in the foregoing embodiment. As long as information can be written to them, it is possible for them to be elements in which the antenna is provided separately, for example.

<writing Information to the Elements>

The writing of information to the element of a developing unit that is not in opposition to the photoconductor 20 is not limited to the timing described in the above embodiment. That is, it is also possible to adopt a configuration in which information is written to the element of a developing unit that is not in opposition to the photoconductor 20 at a timing where the AC voltage supply section 126b is not supplying an AC voltage. As discussed above, the photoconductor 20 is subjected to various processes such as the charging process and the exposing process, and there is a possibility that noise, for example, will be generated when these processes are executed. Consequently, by distancing the main-unit-side antenna 124b away from the photoconductor 20, the effects of noise and the like when the various processes are executed can be reduced, regardless of the timing at which information is written.

<Main-unit-side Antenna>

The main-unit-side antenna 124b is not limited to the configuration described in the above embodiment. That is, when positioning the main-unit-side antenna 124b in opposition to the elements of a plurality of developing units, as long as the main-unit-side antenna 124b is in opposition to the longitudinal direction of the plurality of elements, it is not necessary for it to be contiguously spanning the plurality of elements, and it may be provided in opposition to each element individually. It is also possible for the main-unit-side antenna 124b to not be in opposition to the entirety of the element in the longitudinal direction. For example, it is also possible to adopt a configuration in which a portion of the main-unit-side antenna 124b is in opposition to a portion of an element in the longitudinal direction.

<Image Forming Apparatus>

In the foregoing embodiment, an intermediate-transferring-type full-color laser beam printer was described as an example of the image forming apparatus, but the present invention can also be adopted for various other types of image forming apparatuses, such as full-color laser beam printers that are not of the intermediate-transferring type, monochrome laser beam printers, copying machines, and facsimiles.

===Configuration of the Computer System, etc.===

Next, a computer system serving as an example of an embodiment of the present invention is described with reference to the drawings.

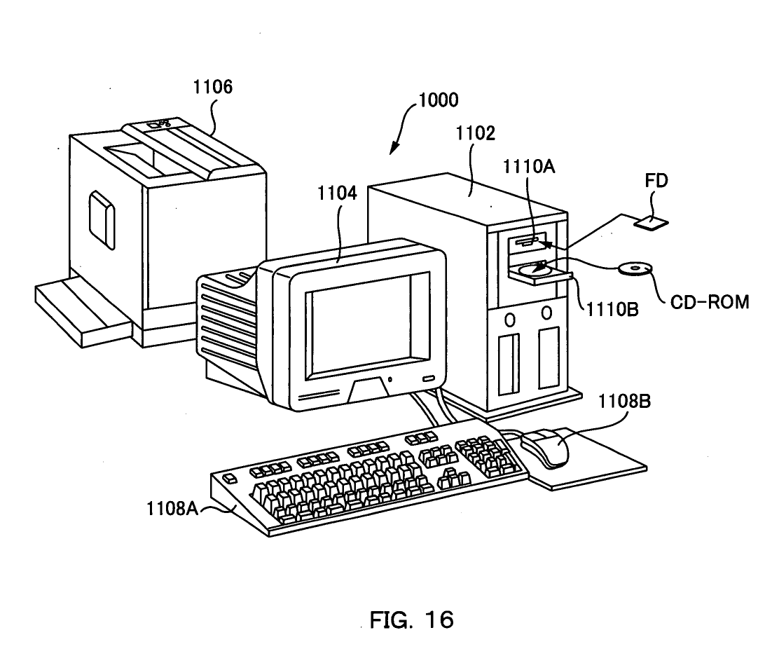

FIG. 16 is an explanatory diagram showing the external structure of the computer system. A computer system 1000 is provided with a main computer unit 1102, a display device 1104, a printer 1106, an input device 1108, and a reading device 1110. In this embodiment, the main computer unit 1102 is housed within a mini-tower type housing; however, this is not a limitation. A CRT (cathode ray tube), plasma display, or liquid crystal display device, for example, is generally used as the display device 1104, but this is not a limitation. As for the printer 1106, the printer described above is used. In this embodiment, the input device 1108 is a keyboard 1108A and a mouse 1108B, but it is not limited to these. In this embodiment, a flexible disk drive device 1110A and a CD-ROM drive device 1110B are used as the reading device 1110, but the reading device 1110 is not limited to these, and it may also be a MO (magneto optical) disk drive device or a DVD (digital versatile disk), for example.

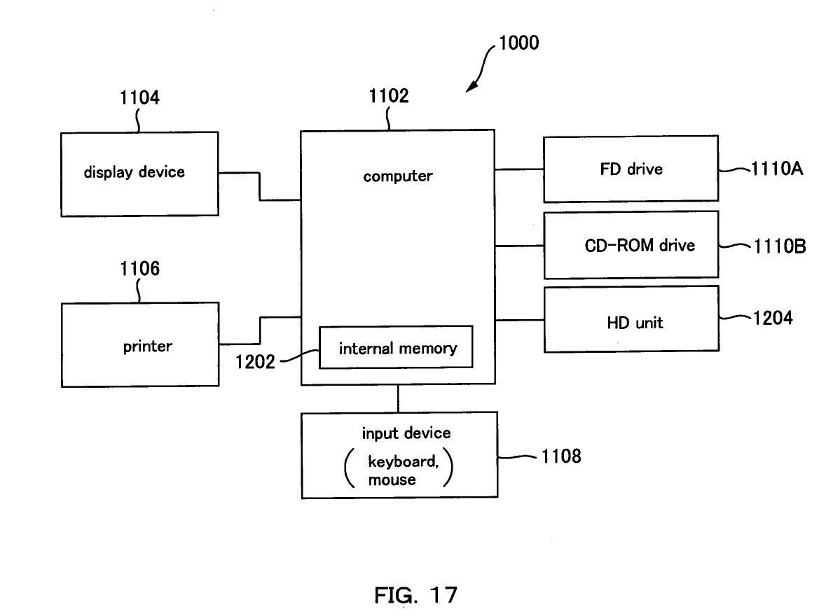

FIG. 17 is a block diagram showing the configuration of the computer system shown in FIG. 16. An internal memory 1202 such as a RAM within the housing containing the main computer unit 1102 and, also, an external memory such as a hard disk drive unit 1204 are provided.

It should be noted that in the above description, an example was described in which the computer system is constituted by connecting the printer 1106 to the main computer unit 1102, the display device 1104, the input device 1108, and the reading device 1110; however, this is not a limitation. For example, the computer system can be made of the main computer unit 1102 and the printer 1106, or the computer system does not have to be provided with any one of the display device 1104, the input device 1108, and the reading device 1110.

Further, for example, the printer 1106 can have some of the functions or mechanisms of the main computer unit 1102, the display device 1104, the input device 1108, and the reading device 1110. As an example, the printer 1106 may be configured so as to have an image processing section for carrying out image processing, a display section for carrying out various types of displays, and a recording media attach/detach section to and from which recording media storing image data captured by a digital camera or the like are inserted and taken out.

As an overall system, the computer system that is thus achieved is superior to conventional systems.

### Second Embodiment

A second embodiment is described next. The description focuses on features that are unique to the second embodiment. Features for which no particular description is made have the same configuration and/or process as in the first embodiment.

===Relationship Between Elements and Main-unit-side Antenna===

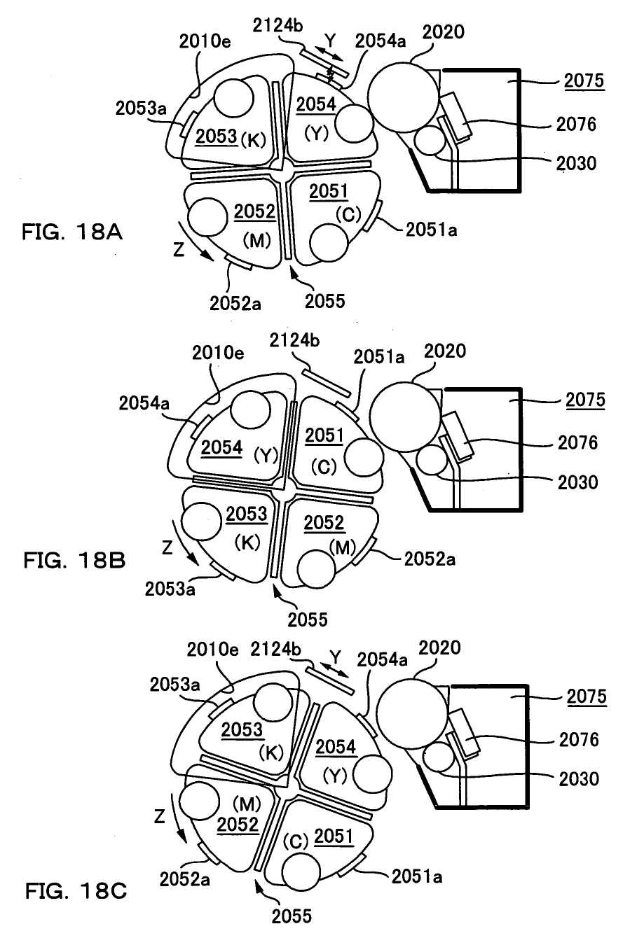

The relationship between the elements of the developing units and a main-unit-side antenna 2124b is described next with reference to FIGS. 18A to 18C.

In FIG. 18A, a yellow developing unit 2054 is positioned at a developing position (opposition position), and an element 2054a of the yellow developing unit 2054 is in opposition to a main-unit-side antenna 2124b in a non-contacting state.

The main-unit-side antenna 2124b is provided so that its longitudinal direction (the Y direction in FIG. 18A) is in the direction of rotation of a rotary 2055 (the Z direction in FIG. 18A). By arranging the main-unit-side antenna 2124b in this manner, wireless communication between the main-unit-side antenna 2124b and the element 2054a is carried out effectively. That is, the main-unit-side antenna 2124b is capable of wirelessly communicating with the element 2054a not only in the state shown in FIG. 18A but also in a state where the rotary 2055 has rotated by a predetermined angle, and by aligning the longitudinal direction of the main-unit-side antenna 2124b in the direction of rotation of the rotary 2055, the range of rotation angles of the rotary 2055 at which wireless communication is possible can be increased.

Also, the length of the longitudinal direction of the main-unit-side antenna 2124b is longer than the length of the element 2054a in that longitudinal direction. Thus, it is possible to more effectively communicate with the element 2054a of the yellow developing unit 2054 mounted to the attach/detach section 2055e provided in the rotary 2055.

Also, the main-unit-side antenna 2124b is provided more outside than the element 2054a in the radial direction of rotation of the rotary 2055. Thus, the main-unit-side antenna 2124b, which is provided more outside than the element 2054a in the radial direction of rotation of the rotary 2055, can be used to effectively perform wireless communication with the element 2054a of the yellow developing unit 2054.

It should be noted that the main-unit-side antenna 2124b is capable of wirelessly communicating with the element 2054a not only when the rotary 2055 is stopped but also when the rotary 2055 is moving. That is, the main-unit-side antenna 2124b is capable of wirelessly communicating with the element 2054a as the element 2054a is moving.

Also, a main-unit-side antenna 2124a is in opposition, in a non-contacting state, to an element 2075a of a photoconductor unit 2075, and the main-unit-side antenna 2124a is capable of wirelessly communicating with the element 2075a of the photoconductor unit 2075 in a non-contacting state.

===Rotation of the Rotary 2055 and the Attach/Detach Position (Attach and Detach Position) of the Developing Units===

The relationship between the rotation of the rotary 2055 and the position where the developing units are removed is described next with reference to FIGS. 18A to 18C.

As described above, in the state shown in FIG. 18A, the yellow developing unit 2054 is positioned at the developing position. From this state, when the rotary 2055 is rotated by a predetermined angle in the Z direction, the state becomes that of FIG. 18B. In the state shown in FIG. 18B, the yellow developing unit 2054 is positioned at the attach/detach position (detach position). In this state, the yellow developing unit 2054 can be attached and detached via an attach/detach opening 2010e, that is, the yellow developing unit 2054 can be attached to an attach/detach section 2055e or it can be detached from the attach/detach section 2055e. Further, when the rotary 2055 is rotated in the Z direction by a predetermined angle from the state shown in FIG. 18B, a cyan developing unit 2051 positioned upstream in the direction of rotation of the rotary 2055 is positioned at the developing position.

It should be noted that FIG. 18C shows a state where the rotary 2055 is positioned at the home position after the printer 2010 has been turned ON and the initialization operation has been performed.

===Writing Information to Elements of the Developing Units===

<<<First Example of Writing Information>>>

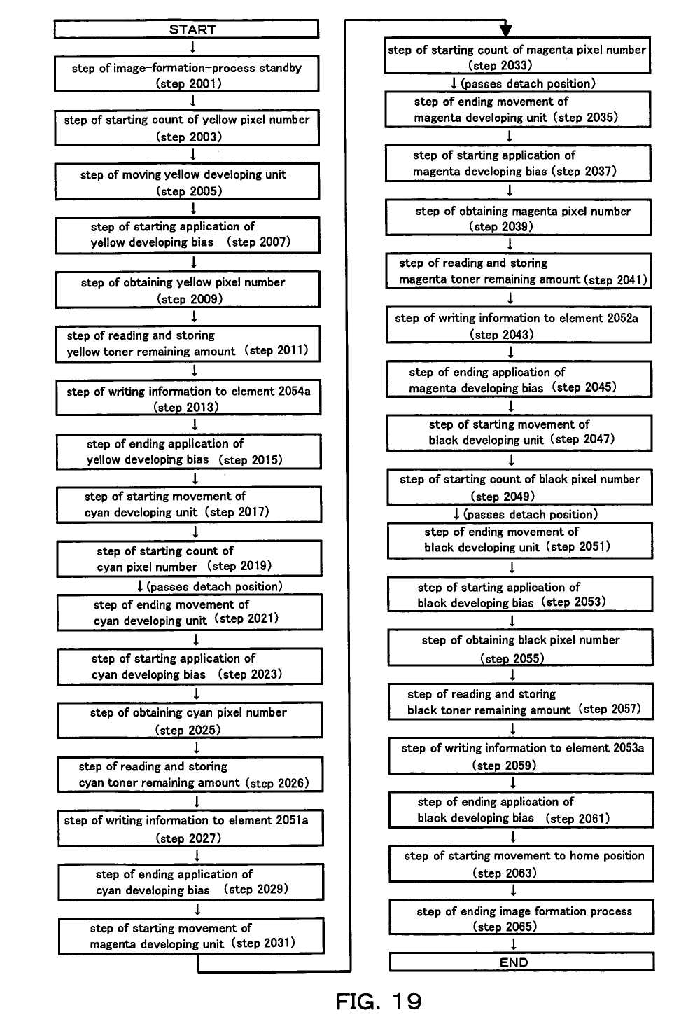

The writing of information to the elements of the developing units is described next with reference to FIG. 19. FIG. 19 is a flowchart for describing how information is written to the elements of the developing units.

<Step of Image-Formation-Process Standby (Step 2001)>

When the printer 2010 is turned ON, a predetermined initialization process is performed and the printer 2010 enters an image-formation-process standby state. When an image signal serving as an image-formation-process order is input from the host computer to a main controller 2101 of the printer 2010 via an interface (I/F) 2112, a photoconductor 2020 and an intermediate transferring member 2070 are rotated. Then, the read sensor for synchronization RS detects the reference position of the intermediate transferring member 2070 and outputs a pulse signal. The unit controller 2102 executes the following control, using the received pulse signal as a reference.

<Step of Starting Count of Yellow Pixel Number (Step 2003)>

A latent image that corresponds to the yellow image information is formed on the charged photoconductor by the exposing unit 2040. At this time, a pixel counter 2127a starts counting the number of pixels input to the exposing unit 2040.

<Step of Moving Yellow Developing Unit (Step 2005)>

The rotary 2055 is rotated, thereby moving the yellow developing unit 2054 to the developing position.

<Step of Starting Application of Yellow Developing Bias (Step 2007)>

Application of a developing bias to the developing roller of the yellow developing unit 2054 is started. Thus, the latent image formed on the photoconductor 2020 is developed with yellow toner. The developing bias that is applied is a voltage in which AC voltage and DC voltage are superimposed, as mentioned above. It should be noted that it is possible to apply the developing bias to the developing roller before the yellow developing unit 2054 arrives at the developing position, or it is instead possible to apply the developing bias to the developing roller after the yellow developing unit 2054 arrives at the developing position.

<Step of Obtaining Yellow Pixel Number (Step 2009)>

In parallel with the developing operation, the number of pixels that have been counted is obtained from the pixel counter 2127a when the input of a signal to the exposing unit 2040 is over. The number of counted pixels is proportional to the amount of toner that is consumed, and thus the amount of yellow toner that is consumed YT can be obtained.

<Step of Reading and Storing Yellow Toner Remaining Amount (Step 2011)>

In parallel with the developing operation, the yellow toner remaining amount YY that is stored in the RAM is read out from the RAM and a value YYnew obtained by subtracting the consumed amount YT from the remaining amount YY is stored in the RAM as the new remaining amount.

<Step of Writing Information to Element 2054a (Step 2013)>

Also, in parallel with the developing operation, that is, while developing, the value YYnew obtained by subtracting the consumed amount YT from the remaining amount YY is written to the element 2054a of the yellow developing unit 2054. This writing is carried out using the main-unit-side antenna 2124b, without being in contact with the element 2054a.

<Step of Ending Application of Yellow Developing Bias (Step 2015)>

At a predetermined timing, application of the developing bias to the developing roller of the yellow developing unit 2054 is ended. Thus, the operation of developing with the yellow developing unit 2054 is ended.

<Step of Starting Movement of Cyan Developing Unit (Step 2017)>

The rotary 2055 starts rotating to position the cyan developing unit 2051 at the developing position.

<Step of Starting Count of Cyan Pixel Number (Step 2019)>

A latent image that corresponds to the cyan image information is formed on the charged photoconductor by the exposing unit 2040. At this time, the pixel counter 2127a starts counting the number of pixels input to the exposing unit 2040.

<Step of Ending Movement of Cyan Developing Unit (Step 2021)>

The rotation of the rotary 2055 for positioning the cyan developing unit 2051 at the developing position is ended. Thus, the cyan developing unit 2051 arrives at the developing position.

<Step of Starting Application of Cyan Developing Bias (Step 2023)>

Application of a developing bias to the developing roller of the cyan developing unit 2051 is started. Thus, the latent image formed on the photoconductor 2020 is developed with cyan toner.

<Step of Obtaining Cyan Pixel Number (Step 2025)>

In parallel with the developing operation, the number of pixels that have been counted is obtained from the pixel counter 2127a when the input of the signal to the exposing unit 2040 is over. The number of counted pixels is proportional to the amount of toner that is consumed, and thus the amount of cyan toner that is consumed CT can be obtained.

<Step of Reading and Storing Cyan Toner Remaining Amount (Step 2026)>

In parallel with the developing operation, the cyan toner remaining amount CC that is stored in the RAM is read out from the RAM and a value CCnew obtained by subtracting the consumed amount CT from the remaining amount CC is stored in the RAM as the new remaining amount.

<Step of Writing Information to Element 2051a (Step 2027)>

Also, in parallel with the developing operation, that is, while developing, the value CCnew obtained by subtracting the consumed amount CT from the remaining amount CC is written to the element 2051a of the cyan developing unit 2051. This writing is carried out using the main-unit-side antenna 2124b, without being in contact with the element 2051a.

<Step of Ending Application of Cyan Developing Bias (Step 2029)>

At a predetermined timing, application of the developing bias to the developing roller of the cyan developing unit 2051 is ended. Thus, the operation of developing with the cyan developing unit 2051 is ended.

<Step of Starting Movement of Magenta Developing Unit (Step 2031)>

The rotary 2055 starts rotating to position the magenta developing unit 2052 at the developing position.

<Step of Starting Count of Magenta Pixel Number (Step 2033)>

A latent image that corresponds to the magenta image information is formed on the charged photoconductor by the exposing unit 2040. At this time, the pixel counter 2127a starts counting the number of pixels input to the exposing unit 2040.

<Step of Ending Movement of Magenta Developing Unit (Step 2035)>

The rotation of the rotary 2055 for positioning the magenta developing unit 2052 at the developing position is ended. Thus, the magenta developing unit 2052 arrives at the developing position.

<Step of Starting Application of Magenta Developing Bias (Step 2037)>

Application of a developing bias to the developing roller of the magenta developing unit 2052 is started. Thus, the latent image formed on the photoconductor 2020 is developed with magenta toner.

<Step of Obtaining Magenta Pixel Number (Step 2039)>

In parallel with the developing operation, the number of pixels that have been counted is obtained from the pixel counter 2127a when the input of the signal to the exposing unit 2040 is over. The number of counted pixels is proportional to the amount of toner that is consumed, and thus the amount of magenta toner that is consumed MT can be obtained.

<Step of Reading and Storing Magenta Toner Remaining Amount (Step 2041)>

In parallel with the developing operation, the magenta toner remaining amount MM that is stored in the RAM is read out from the RAM and a value MMnew obtained by subtracting the consumed amount MT from the remaining amount MM is stored in the RAM as the new remaining amount.

<Step of Writing Information to Element 2052a (Step 2043)>

Also, in parallel with the developing operation, that is, while developing, the value MMnew obtained by subtracting the consumed amount MT from the remaining amount MM is written to the element 2052a of the magenta developing unit 2052. This writing is carried out using the main-unit-side antenna 2124b, without being in contact with the element 2052a.

<Step of Ending Application of Magenta Developing Bias (Step 2045)>

At a predetermined timing, application of the developing bias to the developing roller of the magenta developing unit 2052 is ended. Thus, the operation of developing with the magenta developing unit 2052 is ended.

<Step of Starting Movement of Magenta Developing Unit (Step 2047)>

The rotary 2055 starts rotating to position the black developing unit 2053 at the developing position.

<Step of Starting Count of Black Pixel Number (Step 2049)>

A latent image that corresponds to the black image information is formed on the charged photoconductor by the exposing unit 2040. At this time, the pixel counter 2127a starts counting the number of pixels input to the exposing unit 2040.

<Step of Ending Movement of Black Developing Unit (Step 2051)>

The rotation of the rotary 2055 for positioning the black developing unit 2053 at the developing position is ended. Thus, the black developing unit 2053 arrives at the developing position.

<Step of Starting Application of Black Developing Bias (Step 2053)>

Application of a developing bias to the developing roller of the black developing unit 2053 is started. Thus, the latent image formed on the photoconductor 2020 is developed with black toner.

<Step of Obtaining Black Pixel Number (Step 2055)>

In parallel with the developing operation, the number of pixels that have been counted is obtained from the pixel counter 2127a when the input of the signal to the exposing unit 2040 is over. The number of counted pixels is proportional to the amount of toner that is consumed, and thus the amount of black toner that is consumed BT can be obtained.

<Step of Reading and Storing Black Toner Remaining Amount (Step 2057)>

In parallel with the developing operation, the black toner remaining amount BB that is stored in the RAM is read out from the RAM and a value BBnew obtained by subtracting the consumed amount BT from the remaining amount BB is stored in the RAM as the new remaining amount.

<Step of Writing Information to Element 2053a (Step 2059)>

Also, in parallel with the developing operation, that is, while developing, the value BBnew obtained by subtracting the consumed amount BT from the remaining amount BB is written to the element 2053a of the black developing unit 2053. This writing is carried out using the main-unit-side antenna 2124b, without being in contact with the element 2053a.

<Step of Ending Application of Black Developing Bias (Step 2061)>

At a predetermined timing, application of the developing bias to the developing roller of the black developing unit 2053 is ended. Thus, the operation of developing with the black developing unit 2053 is ended.

<Step of Starting Movement to Home Position (Step 2063)>

Rotation of the rotary 2055 is started so as to position the rotary 2055 at the home position.

<Step of Ending Printing Operation (Step 2065)>

When the rotary 2055 arrives at the home position, the image formation process is ended and the state of image-formation-process standby is entered.

<<<Second Example of Writing Information>>>

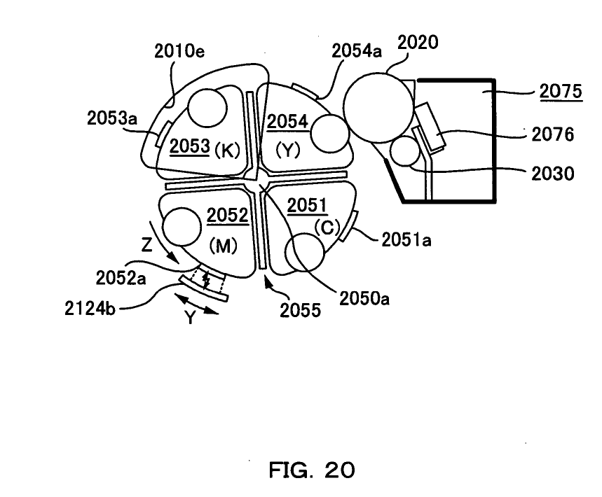

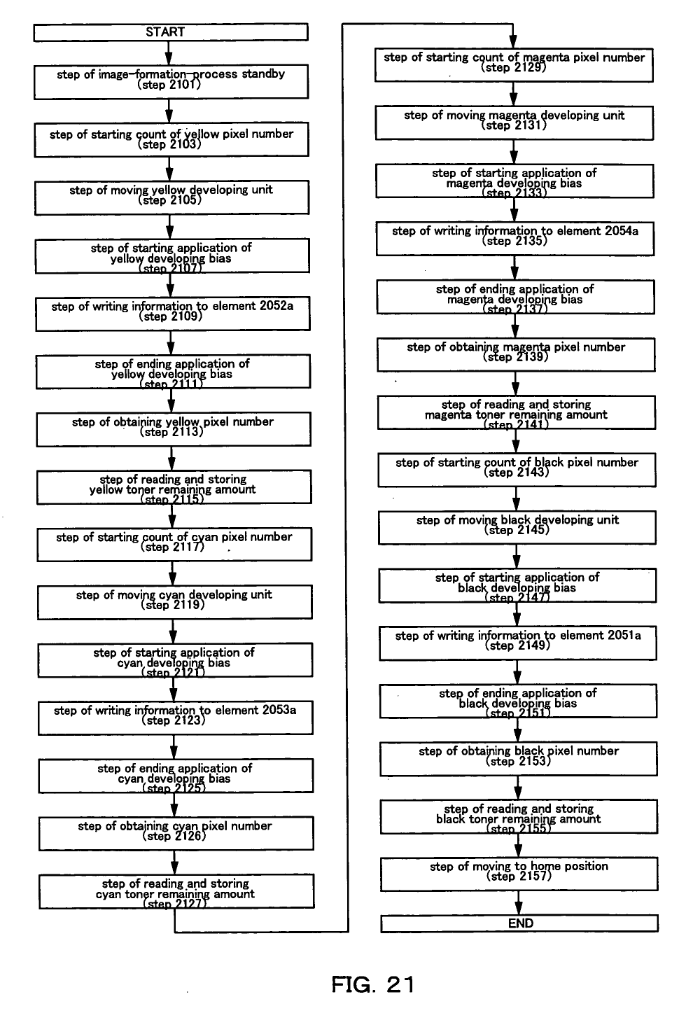

Another example of how information is written to the elements of the developing units is described below with reference to FIG. 20 and FIG. 21. FIG. 20 is a diagram showing another example of how the main-unit-side antenna 2124b is arranged, and FIG. 21 is a flowchart for describing another example of how information is written to the elements of the developing units.

As shown in FIG. 20, in this example the main-unit-side antenna 2124b is provided at a position where it is in opposition to the element 2052a of the magenta developing unit 2052 when the yellow developing unit 2054 is positioned at the developing position.

In such a configuration, information is written as illustrated below.

<Step of Image-formation-process Standby (Step 2101)>

When the printer 2010 is turned ON, a predetermined initialization process is performed and the printer 2010 enters an image-formation-process standby state at the home position. When an image signal serving as an image-formation-process order is input from the host computer to the main controller 2101 of the printer 2010 via the interface (I/F) 2112, the photoconductor 2020 and the intermediate transferring member 2070 are rotated. Then, the read sensor for synchronization RS detects the reference position of the intermediate transferring member 2070 and outputs a pulse signal. The unit controller 2102 executes the following control, using the received pulse signal as a reference.

<Step of Starting Count of Yellow Pixel Number (Step 2103)>

A latent image that corresponds to the yellow image information is formed on the charged photoconductor 2020 by the exposing unit 2040. At this time, the pixel counter 2127a starts counting the number of pixels input to the exposing unit 2040.

<Step of Moving Yellow Developing Unit (Step 2105)>

The rotary 2055 is rotated, thereby moving the yellow developing unit 2054 to the developing position. At this time, the element 2052a of the magenta developing unit 2052 is stopped at a position in opposition to the main-unit-side antenna 2124b. The element 2052a and the main-unit-side antenna 2124b are apart by a distance that permits wireless communication between the two.

<Step of Starting Application of Yellow Developing Bias (Step 2107)>

Application of a developing bias to the developing roller of the yellow developing unit 2054 is started. Thus, the latent image formed on the photoconductor 2020 is developed with yellow toner. The developing bias that is applied is a voltage in which AC voltage and DC voltage are superimposed, as mentioned above. It should be noted that it is possible to apply the developing bias to the developing roller before the yellow developing unit 2054 arrives at the developing position, or it is instead possible to apply the developing bias to the developing roller after the yellow developing unit 2054 arrives at the developing position.

<Step of Writing Information to the Element 2052a (Step 2109)>

When the developing bias is being applied to the developing roller of the yellow developing unit 2054, the latest remaining amount MMnew of magenta toner, which has already been written, at the time of the image formation process based on the previous image signal, to the magenta toner remaining amount storage region of the RAM in the same manner as in the later-discussed step 2141, is read out, and using the main-unit-side antenna 2124b, the latest remaining amount MMnew of magenta toner is written, in a non-contacting state, to the element 2052a in opposition to the main-unit-side antenna 2124b.

<Step of Ending Application of Yellow Developing Bias (Step 2111)>

At a predetermined timing, application of the developing bias to the developing roller of the yellow developing unit 2054 is ended. Thus, the operation of developing with the yellow developing unit 2054 is ended.

<Step of Obtaining Yellow Pixel Number (Step 2113)>

The number of pixels that have been counted is obtained from the pixel counter 2127a. The number of counted pixels is proportional to the amount of toner that is consumed, and thus the amount of yellow toner that is consumed YT can be obtained.

<Step of Reading and Storing Yellow Toner Remaining Amount (Step 2115)>

The yellow toner remaining amount YY that is stored in the yellow toner remaining amount storage region of the RAM is read out from the RAM and a value YYnew obtained by subtracting the consumed amount YT from the remaining amount YY is stored in the yellow toner remaining amount storage region of the RAM as the new remaining amount.

<Step of Starting Count of Cyan Pixel Number (Step 2117)>

A latent image that corresponds to the cyan image information is formed on the charged photoconductor 2020 by the exposing unit 2040. At this time, the pixel counter 2127a starts counting the number of pixels input to the exposing unit 2040.

<Step of Moving Cyan Developing Unit (Step 2119)>

The rotary 2055 is rotated, thereby moving the cyan developing unit 2051 to the developing position. At this time, the element 2053a of the black developing unit 2053 is stopped at a position in opposition to the main-unit-side antenna 2124b. The element 2053a and the main-unit-side antenna 2124b are apart by a distance that permits wireless communication between the two.

<Step of Starting Application of Cyan Developing Bias (Step 2121)>

Application of a developing bias to the developing roller of the cyan developing unit 2051 is started. Thus, the latent image formed on the photoconductor 2020 is developed with cyan toner.

<Step of Writing Information to the Element 2053a (Step 2123)>

When the developing bias is being applied to the developing roller of the cyan developing unit 2051, the latest remaining amount BBnew of black toner, which has already been written, at the time of the image formation process based on the previous image signal, to the black toner remaining amount storage region of the RAM in the same manner as in the later-discussed step 2155, is read out, and using the main-unit-side antenna 2124b, the latest remaining amount BBnew of black toner is written, in a non-contacting state, to the element 2053a in opposition to the main-unit-side antenna 2124b.

<Step of Ending Application of Cyan Developing Bias (Step 2125)>

At a predetermined timing, application of the developing bias to the developing roller of the cyan developing unit 2051 is ended. Thus, the operation of developing with the cyan developing unit 2051 is ended.

<Step of Obtaining Cyan Pixel Number (Step 2126)>

The number of pixels that have been counted is obtained from the pixel counter 2127a. The number of counted pixels is proportional to the amount of toner that is consumed, and thus the amount of cyan toner that is consumed CT can be obtained.

<Step of Reading and Storing Cyan Toner Remaining Amount (Step 2127)>

The cyan toner remaining amount CC that is stored in the cyan toner remaining amount storage region of the RAM is read out from the RAM and a value CCnew obtained by subtracting the consumed amount CT from the remaining amount CC is stored in the cyan toner remaining amount storage region of the RAM as the new remaining amount.

<Step of Starting Count of Magenta Pixel Number (Step 2129)>

A latent image that corresponds to the magenta image information is formed on the charged photoconductor 2020 by the exposing unit 2040. At this time, the pixel counter 2127a starts counting the number of pixels input to the exposing unit 2040.

<Step of Moving Magenta Developing Unit (Step 2131)>

The rotary 2055 is rotated, thereby moving the magenta developing unit 2052 to the developing position. At this time, the element 2054a of the yellow developing unit 2054 is stopped at a position in opposition to the main-unit-side antenna 2124b. The element 2054a and the main-unit-side antenna 2124b are apart by a distance that permits wireless communication between the two.

<Step of Starting Application of Magenta Developing Bias (Step 2133)>

Application of a developing bias to the developing roller of the magenta developing unit 2052 is started. Thus, the latent image formed on the photoconductor 2020 is developed with magenta toner.

<Step of Writing Information to the Element 2054a (Step 2135)>

When the developing bias is being applied to the developing roller of the magenta developing unit 2052, the latest remaining amount YYnew of yellow toner, which has been written to the yellow toner remaining amount storage region of the RAM in step 2115, is read out, and using the main-unit-side antenna 2124b, the latest remaining amount YYnew of yellow toner is written, in a non-contacting state, to the element 2054a in opposition to the main-unit-side antenna 2124b.

<Step of Ending Application of Magenta Developing Bias (Step 2137)>

At a predetermined timing, application of the developing bias to the developing roller of the magenta developing unit 2052 is ended. Thus, the operation of developing with the magenta developing unit 2052 is ended.

<Step of Obtaining Magenta Pixel Number (Step 2139)>

The number of pixels that have been counted is obtained from the pixel counter 2127a. The number of counted pixels is proportional to the amount of toner that is consumed, and thus the amount of magenta toner that is consumed MT can be obtained.

<Step of Reading and Storing Magenta Toner Remaining Amount (Step 2141)>

The magenta toner remaining amount MM that is stored in the magenta toner remaining amount storage region of the RAM is read out from the RAM and a value MMnew obtained by subtracting the consumed amount MT from the remaining amount MM is stored in the magenta toner remaining amount storage region of the RAM as the new remaining amount. It should be noted that the new remaining amount MMnew is written, in a non-contacting state, to the element 2052a using the main-unit-side antenna 2124b when performing the image formation process in accordance with the next image signal.

<Step of Starting Count of Black Pixel Number (Step 2143)>

A latent image that corresponds to the black image information is formed on the charged photoconductor 2020 by the exposing unit 2040. At this time, the pixel counter 2127a starts counting the number of pixels input to the exposing unit 2040.

<Step of Moving Black Developing Unit (Step 2145)>

The rotary 2055 is rotated, thereby moving the black developing unit 2053 to the developing position. At this time, the element 2051a of the cyan developing unit 2051 is stopped at a position in opposition to the main-unit-side antenna 2124b. The element 2051a and the main-unit-side antenna 2124b are apart by a distance that permits wireless communication between the two.

<Step of Starting Application of Black Developing Bias (Step 2147)>

Application of a developing bias to the developing roller of the black developing unit 2053 is started. Thus, the latent image formed on the photoconductor 2020 is developed with black toner.

<Step of Writing Information to the Element 2051a (Step 2149)>

When the developing bias is being applied to the developing roller of the black developing unit 2053, the latest remaining amount CCnew of cyan toner, which has been written to the cyan toner remaining amount storage region of the RAM instep 2127, is readout, and using the main-unit-side antenna 2124b, the latest remaining amount CCnew of cyan toner is written, in a non-contacting state, to the element 2051a in opposition to the main-unit-side antenna 2124b.

<Step of Ending Application of Black Developing Bias (Step 2151)>

At a predetermined timing, application of the developing bias to the developing roller of the black developing unit 2053 is ended. Thus, the operation of developing with the black developing unit 2053 is ended.

<Step of Obtaining Black Pixel Number (Step 2153)>

The number of pixels that have been counted is obtained from the pixel counter 2127a. The number of counted pixels is proportional to the amount of toner that is consumed, and thus the amount of black toner that is consumed BT can be obtained.

<Step of Reading and Storing Black Toner Remaining Amount (Step 2155)>

The black toner remaining amount BB that is stored in the black toner remaining amount storage region of the RAM is read out from the RAM and a value BBnew obtained by subtracting the consumed amount BT from the remaining amount BB is stored in the black toner remaining amount storage region of the RAM as the new remaining amount. It should be noted that the new remaining amount BBnew is written, in a non-contacting state, to the element 2053a using the main-unit-side antenna 2124b when performing the image formation process in accordance with the next image signal.

<Step of Moving to Home Position (Step 2157)>

Rotation of the rotary 2055 is started to position the rotary 2055 at the home position. When the rotary 2055 arrives at the home position, the image formation process is ended, and the state of image-formation-process standby is entered.

In the alternate examples described above of how information is written, information is written to an element of a developing unit that is not adjacent to the developing unit positioned at the developing position (opposition position), but it is also possible for information to be written to an element of a developing unit that is adjacent to the developing unit positioned at the developing position (opposition position). In this case, the main-unit-side antenna 2124b can be arranged so that it is in opposition to the element of a developing unit that is adjacent to the developing unit positioned at the developing position (opposition position).

The writing process described above is only an example, and modifications may be freely made thereto as long as the main-unit-side antenna 2124b, which serves as a writing member, can write information to the element of a developing unit during the developing operation.

### Other Embodiments

In the foregoing, developing units, for example, according to the present invention were described in an embodiment thereof. However, the foregoing embodiment of the invention is for the purpose of elucidating the present invention and is not to be interpreted as limiting the present invention. The invention can of course be altered and improved without departing from the gist thereof, and includes equivalents.

<Regarding the Developing Method>

In the embodiment described above, an alternating electric field is generated between the photoconductor and the developer bearing member, and this action results in the development of the latent image on the photoconductor, but the developing method is not limited to such a method. For example, it is also possible to apply only a DC voltage between the photoconductor and the developer bearing member so as to develop the latent image on the photoconductor.

<Developing Unit>

The developing unit is not limited to a device of the configuration described in the above embodiment, and it may be adopted for any kind of developing unit. As long as the developing unit has an element to which information can be written and a developer containing section, then it may be of any configuration. For example, it is also possible for the developing unit to be provided in the main printer unit 2010a without the developing unit having a developer bearing member.

For example, as the developer bearing roller, as long as a developer bearing roller can be obtained, it is possible to use any of magnetic material, non-magnetic material, conductive material, insulating material, metal, rubber, and resin, for example. For example, as the material it is possible to use a metal such as aluminum, nickel, stainless steel, and iron, a rubber such as natural rubber, silicone rubber, urethane rubber, butadiene rubber, chloroprene rubber, neoprene rubber, and NBR, or a resin such as styrene resin, vinyl chloride resin, polyurethane resin, polyethylene resin, methacrylic resin, and nylon resin, for example. It is of course also possible to use these materials with a coating on their upper layer section. In this case, as the coating material it is possible to use polyethylene, polystyrene, polyurethane, polyester, nylon, or acrylic, for example. Also, as regards its form, it is possible to adopt any of a non-elastic body, an elastic body, a single layer, multiple layers, a film, and a roller, for example. Also, the developer is not limited to toner, and it may also be a two-component developer in which a carrier has been mixed.

The same applies for the toner supply member as well, and as the material thereof it is possible to use polystyrene foam, polyethylene foam, polyester foam, ethylene propylene foam, nylon foam, and silicone foam, for example, in addition to polyurethane foam, which was mentioned above. It should be noted that either open-cell foam or closed-cell foam can be used as the foam cell of the toner supply means. It should also be noted that there is no limitation to foam material, and it is also possible to use a rubber material having elasticity. More specifically, it is possible to use silicone rubber, urethane rubber, natural rubber, isoprene rubber, styrene butadiene rubber, butadiene rubber, chloroprene rubber, butyl rubber, ethylene propylene rubber, epichlorohydrin rubber, nitrile butadiene rubber, or acrylic rubber, molded with a conductive agent such as carbon dispersed therein.

<Moving Member>

The moving member is not limited to a rotary type member that moves in a rotative manner, and it may also be a member that moves in a parallel manner. Also, the number of attach/detach sections provided in the moving member is not limited to four, and it may be less than four or greater than four.

<Elements>

The elements of the developing units and the element of the photoconductor unit are not limited to the configuration described above in the foregoing embodiment. As long as information can be written to them, it is possible for them to be elements in which the antenna is provided separately, for example.

<Photoconductor Unit>

The photoconductor unit 2075 also is not limited to the device of the configuration described in the above-described embodiment, and it may be adopted for any kind of device. For example, it is also possible for it to not have the charging unit 2030, and instead for the charging unit to be provided in the main printer unit 2010a. Also, the photoconductor is not limited to a roller-shaped photoreceptive roller, and it may also be belt-shaped.

<Main-unit-side Antenna (Writing Member)>

The main-unit-side antenna 2124b is not limited to the configuration described in the above embodiment. For example, the main-unit-side antenna may be constituted by a plurality of antennas, and each antenna may be provided in opposition to an element.

<Image Forming Apparatus>

In the foregoing embodiment, an intermediate-transferring-type full-color laser beam printer was described as an example of the image forming apparatus, but the present invention can also be adopted for various other types of image forming apparatuses, such as full-color laser beam printers that are not of the intermediate-transferring type, monochrome laser beam printers, copying machines, and facsimiles.

### Third Embodiment

A third embodiment is described next. The description focuses on features that are unique to the third embodiment. Features for which no particular description is made have the same configuration and/or process as in the first or second embodiments.

===Arrangement of the Elements===

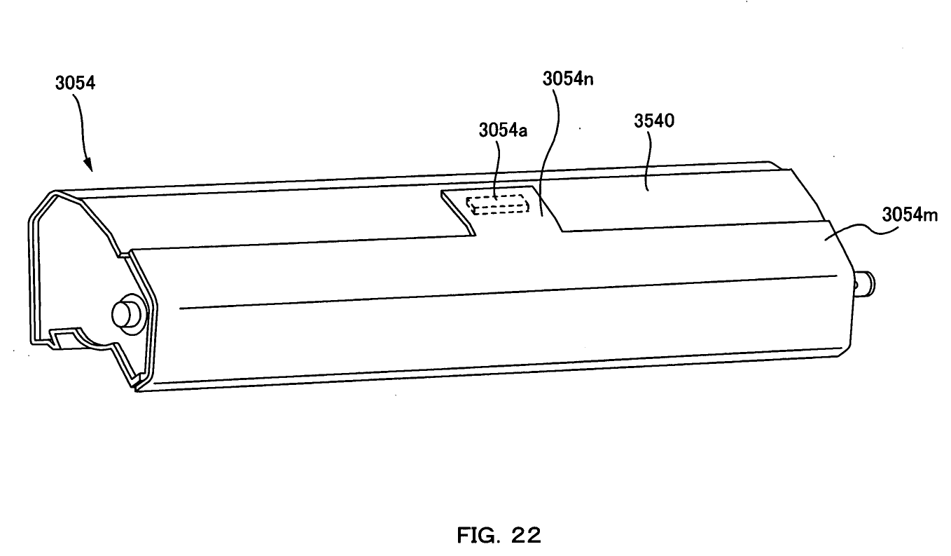

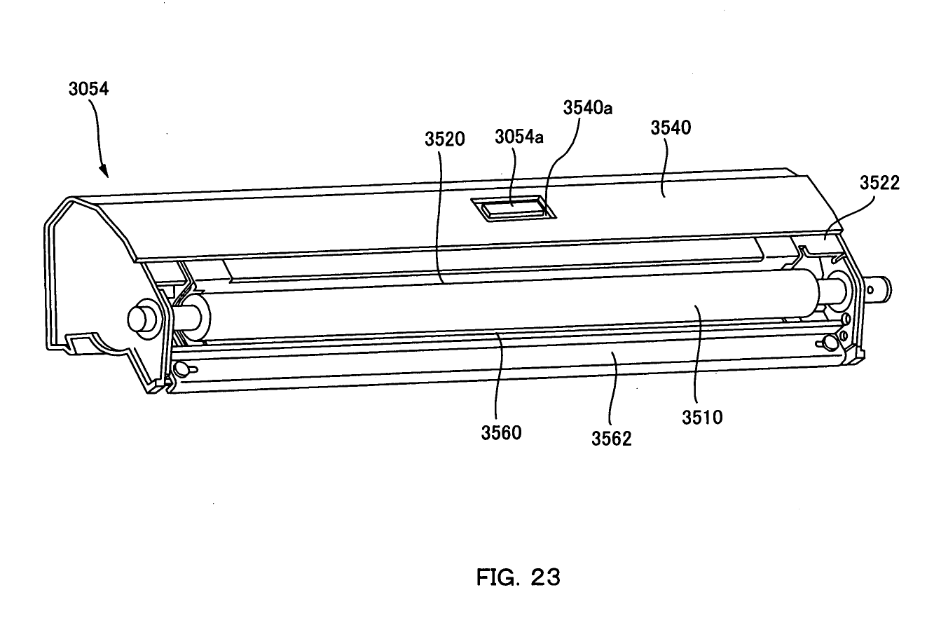

The arrangement of the elements in the developing units is described next using FIG. 22 and FIG. 23. FIG. 22 is a diagram showing how a protective cover is attached to a developing unit. FIG. 23 is a diagram showing another example of how the elements are provided.

A yellow developing unit 3054 is described as an example, but the other developing units also have the same configuration. The yellow developing unit 3054 has a removable protective cover 3054m. The protective cover 3054m is provided in order to protect a developing roller 3510, for example, when the yellow developing unit 3054 is carried, and covers the developing roller 3510. The protective cover 3054m is removed by the user when mounting the yellow developing unit 3054 to a main printer unit 3010a.

An element 3054a is provided outside a housing 3540 that serves as a frame. Also, the element 3054a is provided so that, when the protective cover 3054m is attached to the yellow developing unit 3054, it is positioned on the inside of the protective cover 3054m, as shown in FIG. 22. More specifically, when the protective cover 3054m is attached to the yellow developing unit 3054, the protective cover 3054m covers an opening 3541, the developing roller 3510 a portion of which facing the opening 3541, and the element 3054a. This allows damage to the element 3054a during carrying of the yellow developing unit 3054, for example, to be prevented.

Also, if the yellow developing unit 3054 were virtually divided equally into thirds in the longitudinal direction into an end portion, a center portion, and an other end portion, then the element 3054a would be provided in the center portion. If the developing unit is inadvertently dropped as it is being carried, one of its end portions is likely to strike the floor, for example. Providing the element 3054a in the center portion is a safeguard that more effectively keeps the element 3054a from being damaged.

Also, as shown in FIG. 23, a recessed section 3540a can be provided in the housing 3540, and the element 3054a can be arranged in this recessed section. Adopting such a configuration allows damage, for example, to the element 3054a to be more effectively prevented by the protective cover 3054m. It should be noted that it is also possible to adopt a configuration in which the recessed section 3540a is not provided in the housing 3540 and instead a recessed section is provided in the protective cover 3054m, and for the element 3054m to be positioned in that recessed section when the protective cover 3054m is attached to the yellow developing unit 3054.

Also, as shown in FIG. 22, the protective cover 3054m has a grasping section 3054n that can be grasped when removing the cover 3054m, and the element 3054a is provided to the inside of the grasping section 3054n. The user grasps the grasping section 3054n when removing the protective cover 3054m. Typically, only force in the removing direction is applied to the grasping section for removal when removing the cover. On the other hand, there is a high probability that force in a direction other than the removing direction will be applied to sections other than the grasping section. Accordingly, by providing the element 3054a to the inside of the grasping section 3054n, then, even if the user applies a strong force to the protective cover 3054m when removing the protective cover 3054m, that force can be effectively kept from being applied to the element 3054a through the protective cover 3054m.

### Other Embodiments

In the foregoing, developing units, for example, according to the present invention were described in an embodiment thereof. However, the foregoing embodiment of the invention is for the purpose of elucidating the present invention and is not to be interpreted as limiting the present invention. The invention can of course be altered and improved without departing from the gist thereof, and includes equivalents.

<Elements>

As long as the element is provided on the inside of the cover, it may be provided in any direction. In the embodiment discussed above, the element 3054a was provided so that its longitudinal direction is in the longitudinal direction of the yellow developing unit 3054, but it is also possible to provide the element 3054a so that its longitudinal direction intersects the longitudinal direction of the yellow developing unit 3054.

Also, in the embodiment described above, the elements had an antenna and a memory that can store information, but there is no limitation to this configuration. For example, it is also possible for the element to have a memory but for the antenna to be provided separate from the element.

<Cover>

As regards the configuration that allows the cover to be removed from the developing unit, various known art can be employed. For example, the cover can be provided with a hook portion that fits into the developing unit in an elastically deformed state. It is also possible to adhere double-sided tape to the cover and attach the cover to the developing unit.

Also, in the embodiment described above, the grasping section that is grasped when removing the cover had a rectangular, protruding shape, but there is no limitation to such a configuration. It is only necessary to achieve a portion that can be grasped when removing the cover, and for example, it is also possible to further provide a handle at the protruding portion.

Also, in the embodiment described above, the configuration was such that the cover could be removed, but it is also possible to adopt a configuration in which the cover retracts from the developer bearing member when the developing unit is mounted to the main image forming apparatus.

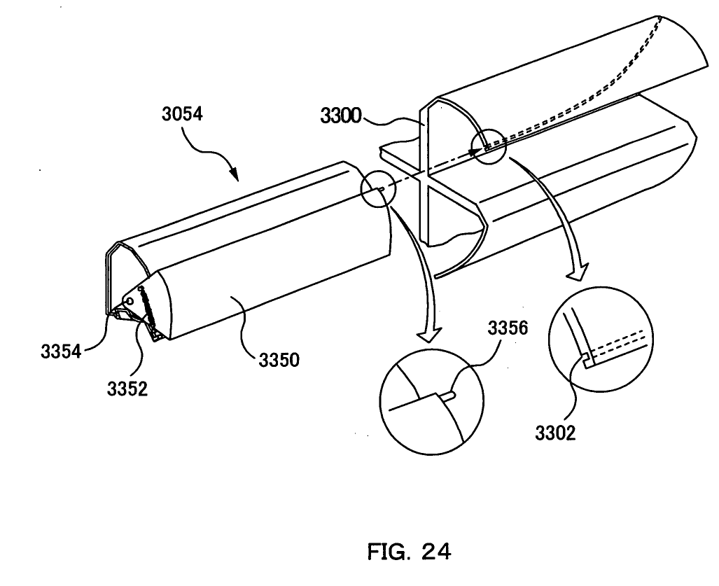

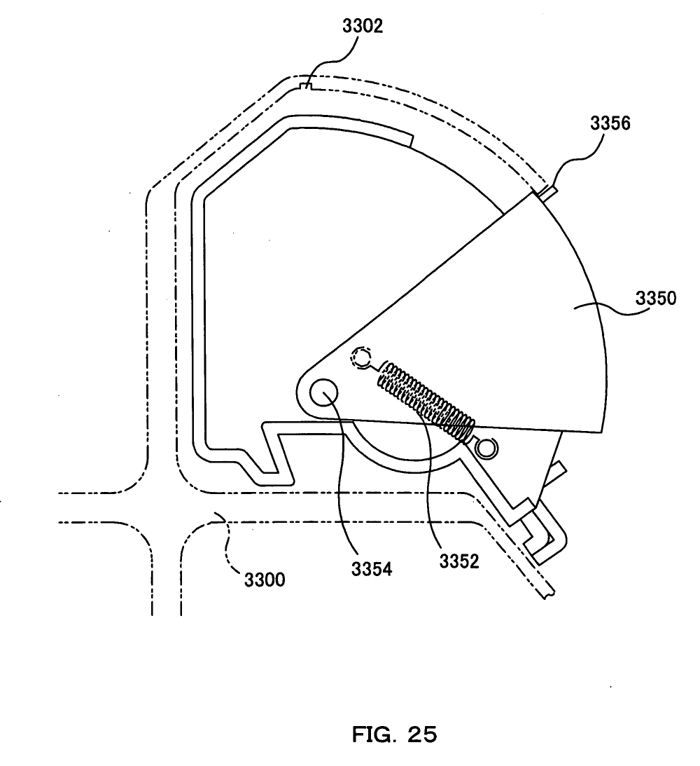

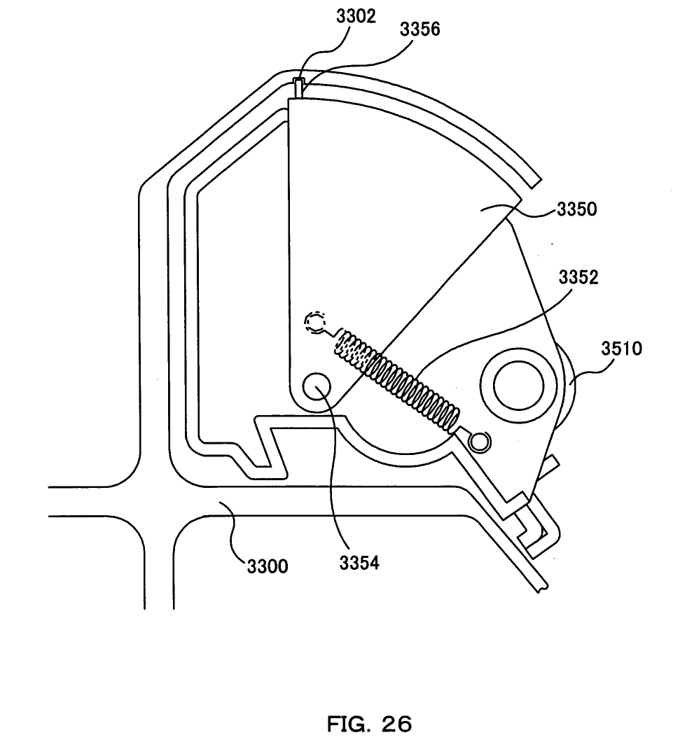

A cover with this configuration is described with reference to FIG. 24, FIG. 25, and FIG. 26. FIG. 24 is a diagram showing the appearance when the yellow developing unit 3054 is mounted to a rotary 3300 provided in the main image forming apparatus. FIG. 25 is a diagram showing the yellow developing unit 3054 before it is mounted to the rotary 3300. FIG. 26 is a diagram showing the yellow developing unit 3054 mounted to the rotary 3300.

As shown in these diagrams, the cover 3350 is capable of rotating about a rotation shaft 3354, and force is applied thereto by a tension spring 3352. The cover 3350 also has an engaging protrusion 3356.

The rotary 3300 has an engaging grove 3302 for each developing unit.

Here, before the yellow developing unit 3054 is mounted to the rotary 3300, the cover 3350 covers the developing roller 3510 etc. as shown in FIG. 25. Thus, the developing roller 3510 etc. is protected.

When mounting the yellow developing unit 54 to the rotary 3300, the engaging protrusion 3356 of the cover 3350 engages the engaging groove 3302 of the rotary 3300. As the yellow developing unit 3054 is mounted in the depth direction of the rotary 3300, the cover 3350 gradually retracts in accordance with the shape of the engaging groove 3302, moving against the urging force of the tension spring 3352. Then, when the yellow developing unit 3054 is mounted all the way in the depth direction of the rotary 3300, the cover 3350 completely retracts from the developing roller 3510, as shown in FIG. 26. The developing roller 3510 is thus placed in a state where developing is possible.

With such a configuration, it is possible to achieve a developing unit, image forming apparatus, and computer system with which damage to elements such as memories is prevented.

### Fourth Embodiment

A fourth embodiment is described next. The description focuses on features that are unique to the fourth embodiment. Features for which no particular description is made have the same configuration and/or process as in the first through third embodiments.

===Overview of the Photoconductor Unit===

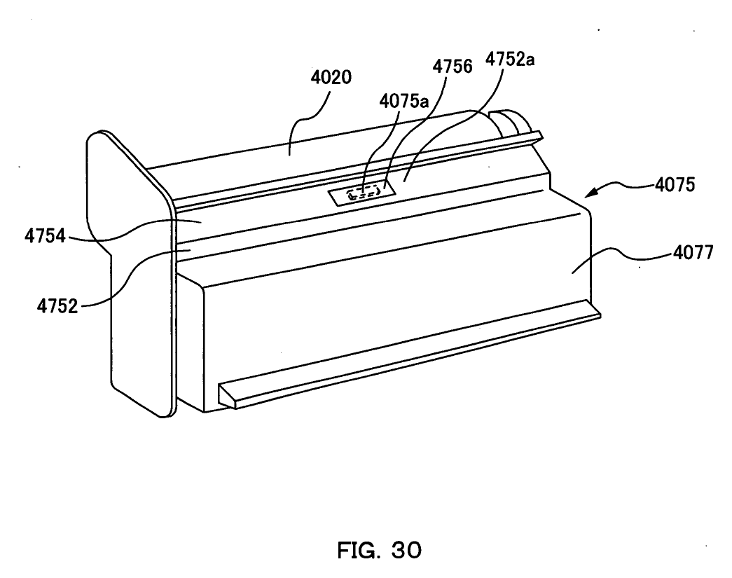

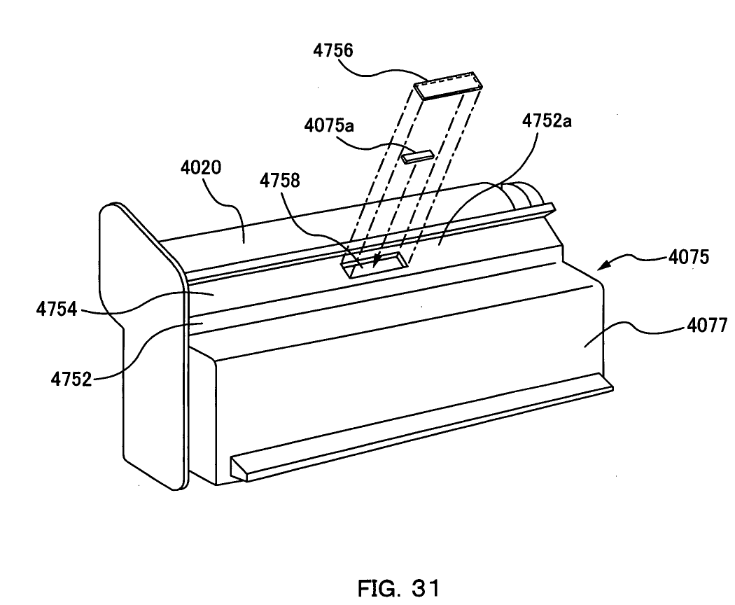

A photoconductor unit 4075 is described in reference to FIG. 30 and FIG. 31. FIG. 30 is a perspective view of the photo conductor unit 4075. FIG. 31 is an exploded view showing the positional relationship between a recessed section 4758, an element 4075a, and a lid section 4756 of the photoconductor unit 4075.

The photoconductor unit 4075 is provided between a first transferring unit 4060 and an exposing unit 4040, and includes a photoconductor 4020, an element 4075a to which information can be written, a charging unit 4030, a cleaning blade 4076, a waste toner containing section 4076a for containing toner that has been scraped off by the cleaning blade 4076, and a housing 4752 for forming the photoconductor unit 4075.

As shown in FIG. 30, the element 4075a is buried in an outer wall section 4754, in the longitudinal direction of the photoconductor unit 4075, of the housing 4752 mentioned above. That is, the element 4075a is provided at a position where it is not exposed to the outside.

Also, the housing 4752, as shown in FIG. 31, is constituted by the lid section 4756 and a main housing unit 4752a. The recessed section 4758 is provided in the main housing unit 4752a, and one side of the element 4075a is in opposition to the lid section 4756 whereas the other side of the element 4075a is in opposition to the recessed section 4758. In other words, in this embodiment, the element 4075a is placed in the recessed section 4758, and is closed off by the lid section 4756. It should be noted that when closing off the recessed section, the lid section 4756 is fastened to the main housing unit 4752a.

The element 4075a has a configuration that allows it to store information that is written thereto. Moreover, the element 4075a is provided so that it is not visible from the outside.

Providing the element 4075a at a position where it is not exposed to the outside allows damage to the element to be effectively prevented.

In determining where to attach the element 4075a to the photoconductor unit 4075, the prevention of damage to the element 4075a must be taken into consideration. Particularly in the case of the printer 4010, since the photoconductor unit 4075 is frequently attached and detached by the user, it is necessary that measures are taken to effectively prevent damage to the element 4075a caused, for example, by the user touching the element 4075a or by the element 4075a coming into contact with other members of the printer 4010.

Accordingly, as discussed above, the element 4075a is provided at a position where it is not exposed to the outside, so that damage to the element 4075a caused, for example, by the user touching the element 4075a or by the element 4075a coming into contact with other members of the printer 4010 can be effectively prevented.

===Overview of the Developing Units===

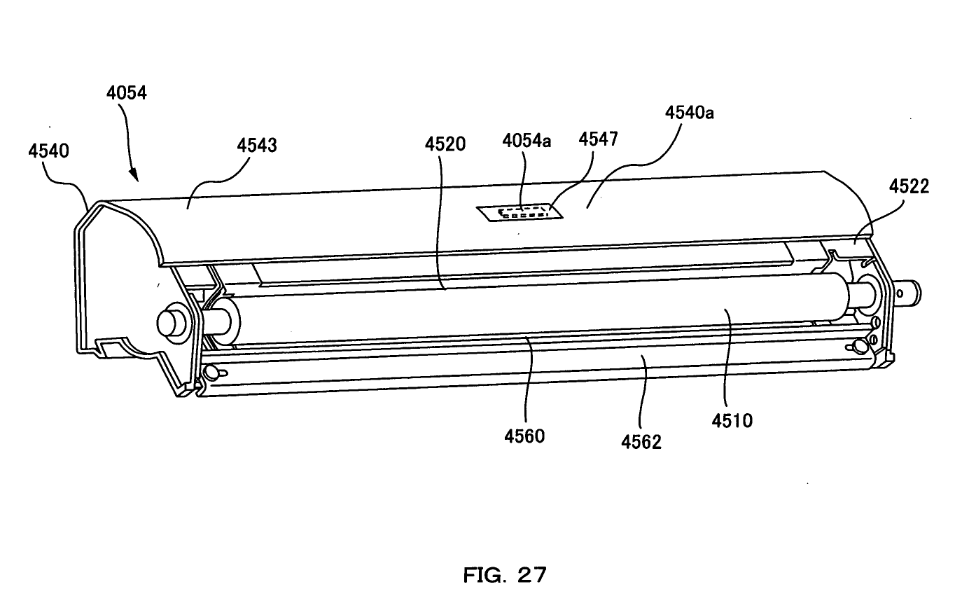

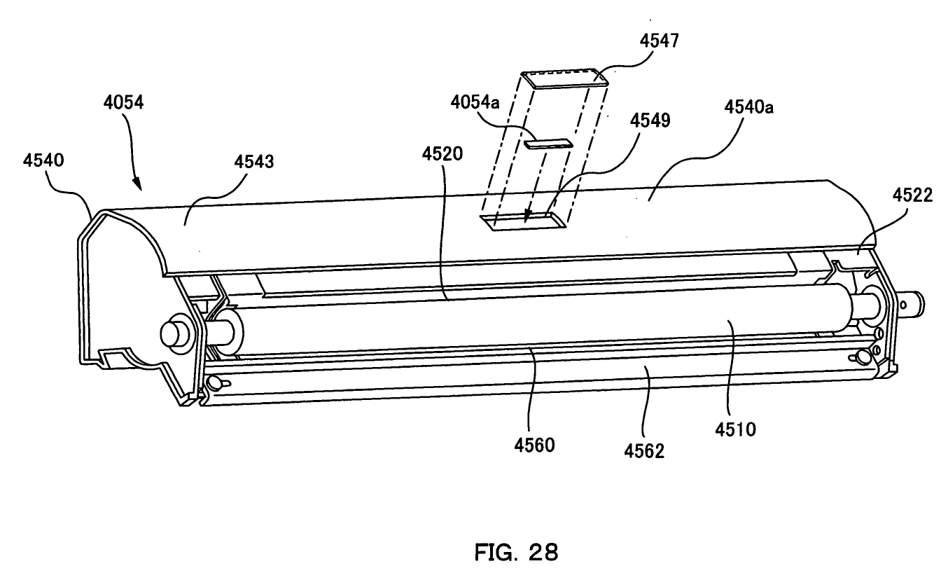

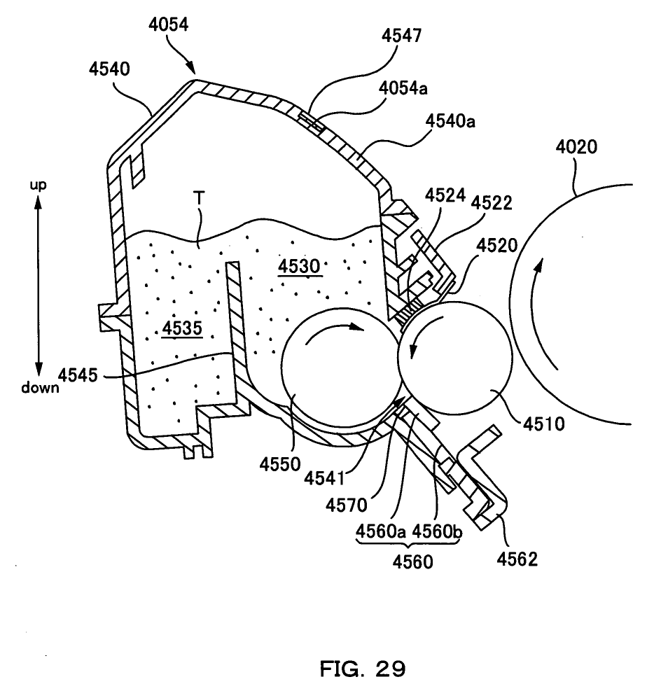

An overview of the developing units is provided next using FIG. 27 to FIG. 29. FIG. 27 is a perspective view of the yellow developing unit 4054 seen from the perspective of a developing roller 4510. FIG. 28 is an exploded view showing the positional relationship between the recessed section 4549, the element 4054a, and the lid section 4547 for the yellow developing unit 4054. FIG. 29 is a cross-sectional view showing the primary structural components of the yellow developing unit 4054. It should be noted that in FIG. 29 as well, the vertical direction is shown by an arrow, and for example, the central axis of the developing roller 4510 is lower than the central axis of the photoconductor 4020. Also, in FIG. 29, the yellow developing unit 4054 is shown positioned at a developing position that is in opposition to the photoconductor 4020.

The YMCK developing device 4050 is provided with a cyan developing unit 4051, which contains cyan (C) toner, a magenta developing unit 4052, which contains magenta (M) toner, a black developing unit 4053, which contains black (K) toner, and the yellow developing unit 4054, which contains yellow (Y) toner, and since the configuration of these developing units is the same, the yellow developing unit 4054 is described below.

The yellow developing unit 4054 is provided with a developer containing section, that is, a first containing section 4530 and a second containing section 4535, for containing yellow toner T as a developer, the element 4054a, the housing 4540, the developing roller 4510, which serves as the developer bearing member, a toner supply roller 4550 for supplying toner T to the developing roller 4510, and the restriction blade 4560 for regulating the thickness of the layer of toner T that is borne on the developing roller 4510, for example.

The housing 4540 is manufactured by joining an upper housing and a lower housing, for example, to form a single unit, and the inside of the housing is divided into the first containing section 4530 and the second containing section 4535 by a restriction wall 4545 that extends upward from the lower section (the vertical direction of FIG. 29). The first containing section 4530 and the second containing section 4535 form developer containing sections (4530, 4535) for containing toner T as a developer. The upper sections of the first containing section 4530 and the second containing section 4535 are in communication, and the movement of the toner T is regulated by the restriction wall 4545. It should be noted that it is also possible to provide a stirring member for stirring the toner T contained in the first containing section 4530 and the second containing section 4535, but in the present embodiment, the developing units (the cyan developing unit 4051, the magenta developing unit 4052, the black developing unit 4053, and the yellow developing unit 4054) rotate in conjunction with rotation of the rotary 4055, thereby stirring the toner T in the developing units, and thus a stirring member is not provided in the first containing section 4530 or the second containing section 4535.

As shown in FIG. 27, the above-described element 4054a is buried in an outer wall section 4543 of the housing 4540 that is in the longitudinal direction of the yellow developing unit 4054. That is, the element 4054a is provided at a position where it is not exposed to the outside.

Also, the housing 4540, as shown in FIG. 28, is constituted by a lid section 4547 and a main housing unit 4540a. A recessed section 4549 is provided in the main housing unit 4540a, and one side of the element 4054a is in opposition to the lid section 4547 whereas the other side of the element 4054a is in opposition to the recessed section 4549. In other words, in this embodiment, the element 4054a is placed in the recessed section 4549, and is closed off by the lid section 4547. It should be noted that when closing off the recessed section, the lid section 4547 is fastened to the main housing unit 4540a.

The element 4054a has a configuration that allows it to store information that is written thereto. Moreover, the element 4054a is provided so that it is not visible from the outside.

Providing the element 4054a at a position where it is not exposed to the outside allows damage to the element to be effectively prevented.

In determining where to attach the element 4054a to the developing unit, the prevention of damage to the element 4054a must be taken into consideration. Particularly in the case of the printer 4010, since the developing units are frequently attached and detached by the user, it is necessary that measures are taken to effectively prevent damage to the element 4054a caused, for example, by the user touching the element 4054a or by the element 4054a coming into contact with other members of the printer 4010.

Accordingly, as discussed above, the element 4054a is provided at a position where it is not exposed to the outside, so that damage to the element 4054a caused, for example, by the user touching the element 4054a or by the element 4054a coming into contact with other members of the printer 4010 can be effectively prevented.

Further, an opening 4541 that communicates with the outside of the housing 4540 is provided in the lower section of the first containing section 4530. The toner supply roller 4550 is provided in the first containing section 4530 with its circumferential surface facing the opening 4541, and is rotatably supported on the housing 4540. Also, the developing roller 4510 is provided with its circumferential surface facing the opening 4541 from outside the housing 4540, and the developing roller 4510 abuts against the toner supply roller 4550.

The developing roller 4510 bears toner T and carries the toner to a developing position in opposition to the photoconductor 4020. The developing roller 4510 is made, for example, of aluminum, stainless steel or iron, and if necessary, it can be subjected to nickel plating or chrome plating, and the toner bearing region can be subjected to sandblasting or the like. The developing roller 4510 is provided so that its longitudinal direction is along the longitudinal direction of the yellow developing unit 4054. Also, the developing roller 4510 can rotate about its central axis, and as shown in FIG. 29, it rotates in the direction (in FIG. 29, the counterclockwise direction) opposite from the direction in which the photoconductor 4020 rotates (in FIG. 29, the clockwise direction). Its central axis is lower than the central axis of the photoconductor 4020. Also, as shown in FIG. 29, in a state where the yellow developing unit 4054 is in opposition to the photoconductor 4020, a gap exists between the developing roller 4510 and the photoconductor 4020. That is, the yellow developing unit 4054 develops the latent image formed on the photoconductor 4020 without being in contact with the photoconductor 4020. It should be noted that when developing the latent image formed on the photoconductor 4020, an alternating electric field is formed between the developing roller 4510 and the photoconductor 4020.

The toner supply roller 4550 supplies the toner T contained in the first containing section 4530 and the second containing section 4535 to the developing roller 4510. The toner supply roller 4550 is made of polyurethane foam, for example, and abuts against the developing roller 4510 in a state of elastic deformation. The toner supply roller 4550 is arranged at a lower section of the first containing section 4530, and the toner T contained in the first containing section 4530 and the second containing section is supplied to the developing roller 4510 by the toner supply roller 4550 at a lower section of the first containing section 4530. The toner supply roller 4550 can rotate about its central axis, and its central axis is lower than the central axis of rotation of the developing roller 4510. Also, the toner supply roller 4550 rotates in a direction (in FIG. 29, the clockwise direction) that is opposite from the direction of rotation of the developing roller 4510 (in FIG. 29, the counterclockwise direction). It should be noted that the toner supply roller 4550 has the function of supplying the toner T that is contained in the first containing section 4530 and the second containing section 535 to the developing roller 4510 as well as the function of stripping off, from the developing roller 4510, toner T remaining on the developing roller 4510 after developing.

The restriction blade 4560 regulates the thickness of the toner T layer borne on the developing roller 4510, and applies charge to the toner T borne on the developing roller 4510. The restriction blade 4560 has a rubber section 4560a and a rubber-supporting section 4560b. The rubber section 4560a is made of silicone rubber or urethane rubber, for example, and the rubber-supporting section 4560b is a thin plate of phosphor bronze or stainless steel, for example, and has spring properties. The rubber section 4560a is supported by the rubber-supporting section 4560b, and one end of the rubber-supporting section 4560b is fixed to a blade-supporting metal plate 4562. The blade-supporting metal plate 4562 is fastened to a seal frame, and is attached to the housing 4540 together with the restriction blade 4560, forming a portion of a seal unit 4520, which is described later. In this state, the rubber section 4560a is pressed against the developing roller 4510 by the elastic force created by the bending of the rubber-supporting section 4560b.

Also, a blade-backing member 4570 made of Moltoprene or the like is provided on the side of the restriction blade 4560 that is opposite from the developing roller 4510 side. The blade-backing member 4570 prevents the toner T from entering in between the rubber-supporting section 4560b and the housing 4540, stabilizing the elasticity obtained by the bending of the rubber-supporting section 4560b, and, by applying force to the rubber section 4560a toward the developing roller 4510 from directly behind the rubber section 4560a, it presses the rubber section 4560a against the developing roller 4510. Consequently, the blade-backing member 4570 increases the contact uniformity and the sealing properties of the rubber section 4560a with respect to the developing roller 4510.

The end of the restriction blade 4560 on the side opposite from the side supported by the blade-supporting metal plate 4562, that is, its tip, is not in contact with the developing roller 4510, and a portion thereof away from its tip by a predetermined distance is in contact with the developing roller 4510 with some breadth. That is, the restriction blade 4560 does not abut against the developing roller 4510 at its edge but rather at its mid section. Also, the restriction blade 4560 is arranged such that its tip is facing upstream in the direction in which the developing roller 4510 rotates, making so-called counter-abutment with respect to the developing roller 4510. It should be noted that the abutting position where the restriction blade 4560 abuts against the developing roller 4510 is lower than the central axis of the developing roller 4510 and is lower than the central axis of the toner supply roller 4550.

The seal member 4520 prevents the toner T in the yellow developing unit 4054 from leaking outside the unit, and also collects toner T on the developing roller 4510, after the developing roller 4510 has passed the developing position, into the developing unit without scraping it off. The seal member 4520 is a seal made of polyethylene film or the like. The seal member 4520 is supported by a seal-supporting metal plate 4522, and is attached to the frame 4540 via the seal-supporting metal plate 4522. A seal urging member 4524 made of Moltoprene or the like is provided at the side of the seal member 4520 that is opposite from the developing roller 4510 side, and due to the elasticity of the seal urging member 4524, the seal member 4520 is pressed against the developing roller 4510. It should be noted that the abutting position where the seal member 4520 abuts against the developing roller 4510 is above the central axis of the developing roller 4510.

In the yellow developing unit 4054 configured in this manner, the toner supply roller 4550 supplies the toner T that is contained in the first containing section 4530 and the second containing section 4535, which function as developer containing sections, to the developing roller 4510. The toner T that is supplied to the developing roller 4510 is carried to the abutting position of the restriction blade 4560 in conjunction with rotation of the developing roller 4510, and when it passes the abutting position, the thickness of the toner T layer is regulated and charge is applied. The toner T on the developing roller 4510, whose layer thickness has been regulated, is brought to the developing position in opposition to the photoconductor 4020 due to further rotation of the developing roller 4510, and is supplied for developing the latent image formed on the photoconductor 4020 in an alternating electric field at the developing position. The toner T on the developing roller 4510 that has passed the developing position due to further rotation of the developing roller 4510 then passes the seal member 4520 and is collected into the developing unit without being scraped off by the seal member 4520.

With this configuration it is possible to achieve a developing unit, a photoconductor unit, an image forming apparatus, and a computer system with which damage to the elements can be effectively prevented.

### Fifth Embodiment

A fifth embodiment is described next. The description focuses on features that are unique to the fifth embodiment. Features for which no particular description is made have the same configuration and/or process as in the first through fourth embodiments.

===Attaching and Detaching the Developing Units===

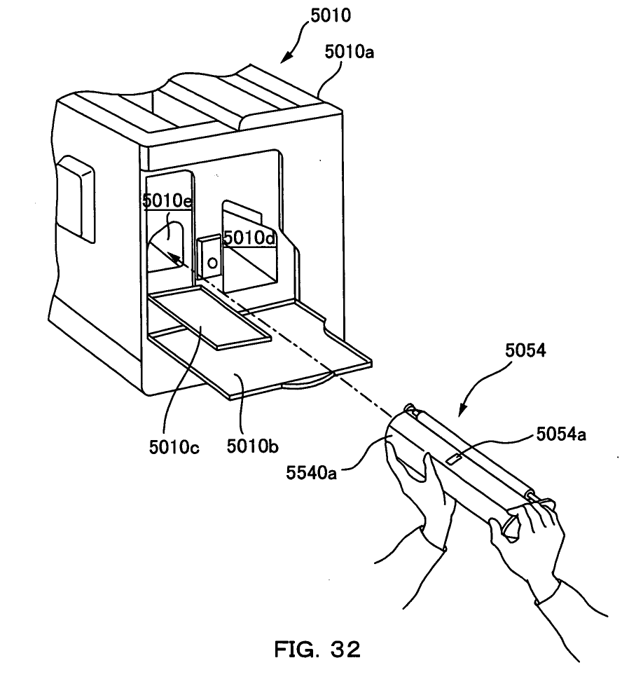

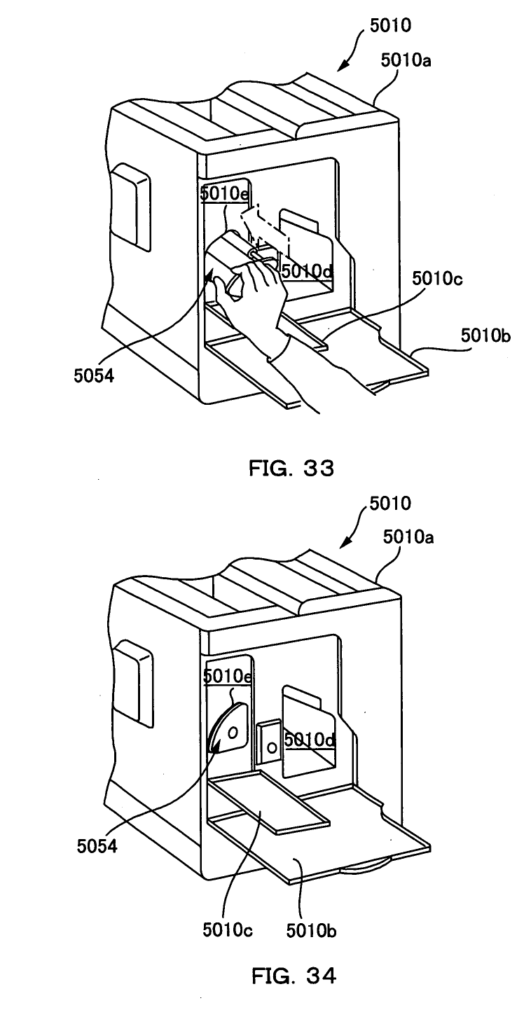

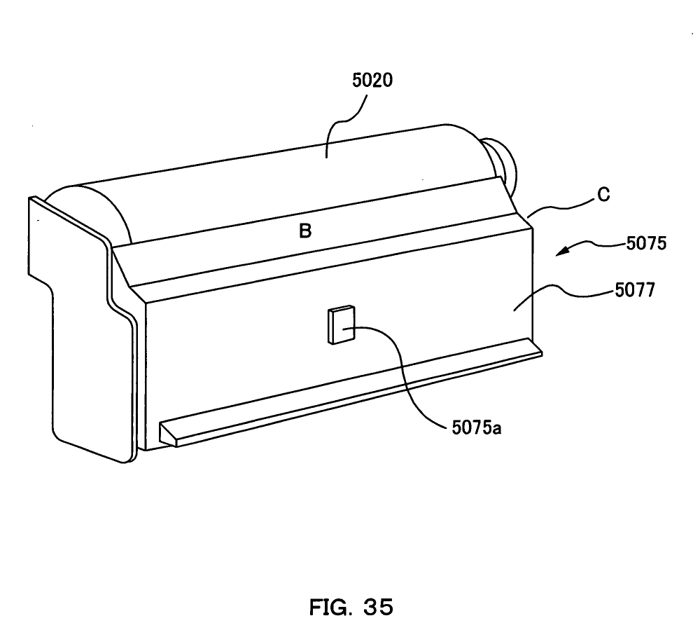

The operation when the user mounts a developing unit 5054 (5051, 5052, 5053) to a main printer unit 5010a is described next with reference to FIG. 32, FIG. 33, and FIG. 34. FIG. 32 is a diagram showing the state before the developing unit is inserted into an attach/detach opening. FIG. 33 is a diagram showing the developing unit as it is being mounted to an attach/detach section via the attach/detach opening. FIG. 34 is a diagram showing the state after the developing unit has been mounted to an attach/detach section through the attach/detach opening. It should be noted that the manner in which the cyan developing unit 5051, the magenta developing unit 5052, the black developing unit 5053, and the yellow developing unit 5054 are attached and detached is the same, and thus hereinafter, the operation of mounting the yellow developing unit 5054 is described, and description of the operation of mounting the other developing units 5051, 5052, and 5053 is omitted.

First, as shown in FIG. 32, the user opens a first opening cover 5010b and a second opening cover 5010c, and then, supporting the lower section of an outer wall surface 5540a of the yellow developing unit 5054 with his/her left hand (or right hand). Then, the user supports, with his/her right hand (or left hand), the rear lateral surface of the yellow developing unit 5054 when the yellow developing unit 5054 is being mounted to an attach/detach section 5055e, and inserts the yellow developing unit 5054 into a developing unit attach/detach opening 5010e while moving the yellow developing unit 5054 in the direction shown by the long-short dashed line.

Then, as shown in FIG. 33, once the user has inserted the yellow developing unit 5054 into the developing unit attach/detach opening 5010e to a certain extent, he/she removes his/her left hand (or right hand) from the lower section of the outer wall surface 5540a of the yellow developing unit 5054, and supporting only the rear lateral surface of the yellow developing unit 5054 with his/her right hand (or left hand), he/she pushes the yellow developing unit 5054 in the direction shown by the long-short dashed line. It should be noted that by providing an element 5054a near the center in the longitudinal direction of the outer wall surface 5540a, the element 5054a is no longer exposed from the developing unit attach/detach opening 5010e even while the yellow developing unit 5054 is being mounted to the attach/detach section 5055e, and thus, when the yellow developing unit 5054 is pushed in further, there is no longer the possibility that the user will touch the element with his/her right hand (or left hand).

Next, when the user further pushes the rear lateral surface of the yellow developing unit 5054 from the state of FIG. 33, then, as shown in FIG. 34, the yellow developing unit 5054 is mounted to the attach/detach section 5055e without the element 5054a being exposed from the developing unit attach/detach opening 5010e.

It should be noted that the manner in which the user supports the yellow developing unit 5054 is not limited to the foregoing method, and as long as the method allows the lower section of the outer wall surface 5540a of the yellow developing unit 5054 to be supported and the yellow developing unit 5054 to be inserted through the developing unit attach/detach opening 5010e, other methods may also be employed. Also, to remove the yellow developing unit 5054 from the attach/detach section 5055e, the operation for mounting the yellow developing unit 5054 to the attach/detach section 5055e can be carried out in reverse.

Incidentally, if the element 5054a to which information can be written is exposed from the developing unit attach/detach opening 5010e with the yellow developing unit 5054 mounted to the attach/detach section 5055e when the second opening cover 5010c of the main printer unit 5010a is opened, then the user may inadvertently touch the element 5054a with his/her body when attaching and detaching the yellow developing unit 5054 to and from the attach/detach section 5055e, and as a result, it is conceivable that the element 5054a may come loose from the yellow developing unit 5054 or that the information written to the element 5054a may be ruined, and this is not preferable. Also, if, when attaching and detaching the yellow developing unit 5054 to and from the attach/detach section 5055e, the second opening cover 5010c is closed without noticing that the yellow developing unit 5054 is not completely mounted to the attach/detach section 5055e and that the frontward end of the yellow developing unit 5054 is slightly protruding out from the developing unit attach/detach opening 5010e, then it is conceivable that the impact caused by closing the second opening cover 5010c will damage the element 5054a itself, and this, too, is not preferable.

Therefore, the element 5054a is provided on the yellow developing unit 5054 in such a manner that the element 5054a is not exposed from the developing unit attach/detach opening 5010e when the yellow developing unit 5054 has been mounted to the attach/detach section 5055e. Thus, once the yellow developing unit 5054 has been mounted to the attach/detach section 5055e, there is no longer a possibility that the user may touch with the element 5054a with his/her body, allowing the element 5054a to be kept from being damaged. The same applies for the other developing units 5051, 5052, and 5053 as well.

In particular, if the element 5054a is protruding out from the outer wall surface 5540a in the yellow developing unit 5054, the portion of the element 5054a that is protruding is hidden once the yellow developing unit 5054 has been mounted to the attach/detach section 5055e, and thus damage to the element 5054a can be more effectively prevented. It should be noted that if, in the yellow developing unit 5054, the element 5054a is provided so that it is buried in the outer wall surface 5540a and is not protruding, then, when the user is performing the task of attaching or detaching the yellow developing unit 5054 to and from the attach/detach section 5055e, it is less likely that the user will touch the element 5054a with his/her body, and the element 5054a no longer comes into contact with and collides with the inner wall of the developing unit attach/detach opening 5010e, and damage to the element 5054a can be prevented. The same applies for the other developing units 5051, 5052, and 5053 as well.

Most users typically attach and detach the yellow developing unit 5054 to and from the attach/detach section 5055e supporting the lower section of the outer wall surface 5540a of the yellow developing unit 5054 with their hand. Accordingly, if the surface of the element 5054a on the side opposite from the side that is in contact with the outer wall surface 5540a is facing upward when mounting the yellow developing unit 5054 to the attach/detach section 5055e, then the element 5054a is not provided on the lower section of the outer wall surface 5540a. Thus, when the user attaches and detaches the yellow developing unit 5054 to and from the attach/detach section 5055e, his/her body does not come into contact with the element 5054a, even if the user is supporting the lower section of the outer wall surface 540a with his/her hand. Consequently, damage to the element 5054a can be prevented not only when the yellow developing unit 5054 is mounted to the attach/detach section 5055e but also when it is being attached thereto and detached therefrom. The same applies for the other developing units 5051, 5052, and 5053 as well.

It is also possible to provide the element 5054a on a lateral surface A on the leading side when the yellow developing unit 5054 is being mounted to the attach/detach section 5055e. In this case, the yellow developing unit 5054 can be attached to and detached from the attach/detach section 5055e regardless of which section of the outer wall surface 5540a of the yellow developing unit 5054 the user supports with his/her hand. Consequently, damage to the element 5054a when attaching and detaching the developing unit 5054 can be prevented more effectively.

It is also possible for the main-unit-side antenna 5124b to write information to the element 5054a in the yellow developing unit 5054 in a non-contacting state. This allows damage to the element 5054a to which information is written by the main-unit-side antenna 5124b to be prevented. The same applies for the other developing units 5051, 5052, and 5053 as well.

It is also possible for the main-unit-side antenna 5124b to write information indicating a remaining amount or a usage amount of the developer to the element 5054a in the yellow developing unit 5054. This allows damage to the element 5054a, to which information indicating a remaining amount or a usage amount has been written, to be prevented. Consequently, problems such as the information indicating a remaining amount or a usage amount being erased can be prevented. The same applies for the other developing units 5051, 5052, and 5053 as well.

Further, the yellow developing unit 5054 has the developing roller 5510, and it is possible to provide the element 5054a at a position where it is not exposed through the attach/detach opening 5010e when the yellow developing unit 5054 is mounted to the attach/detach section 5055e, allowing damage to the element 5054a to be prevented. The same applies for the other developing units 5051, 5052, and 5053 as well.

===Overview of the Photoconductor Unit===

An overview of the photoconductor unit is described next using FIG. 35. FIG. 35 is a perspective view in which a photoconductor unit 5075 is seen from the perspective of an outer wall surface 5077. An element 5075a to which information can be written is provided near the center of an outer wall surface 5077 in a longitudinal direction of the photoconductor unit 5075. When the photoconductor unit 5075 has been mounted to an attach/detach section through a photoconductor unit attach/detach opening 5010d, the element 5075a is in opposition to a main-unit-side antenna 5124a provided on the main printer unit 5010a side, and information can be written to it in a non-contacting state. It should be noted that other aspects of the configuration of the photoconductor unit 5075 are identical to those described in the overview of the image forming apparatus.

===Attaching/Detaching the Photoconductor Unit===

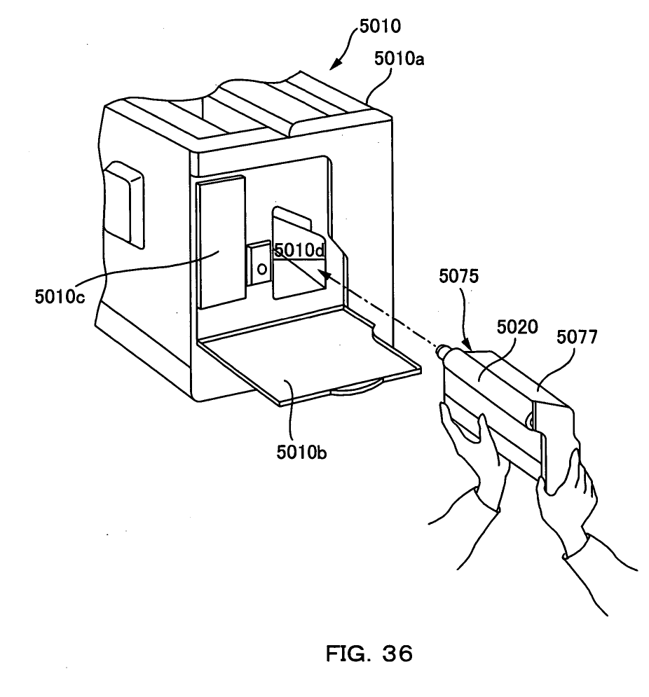

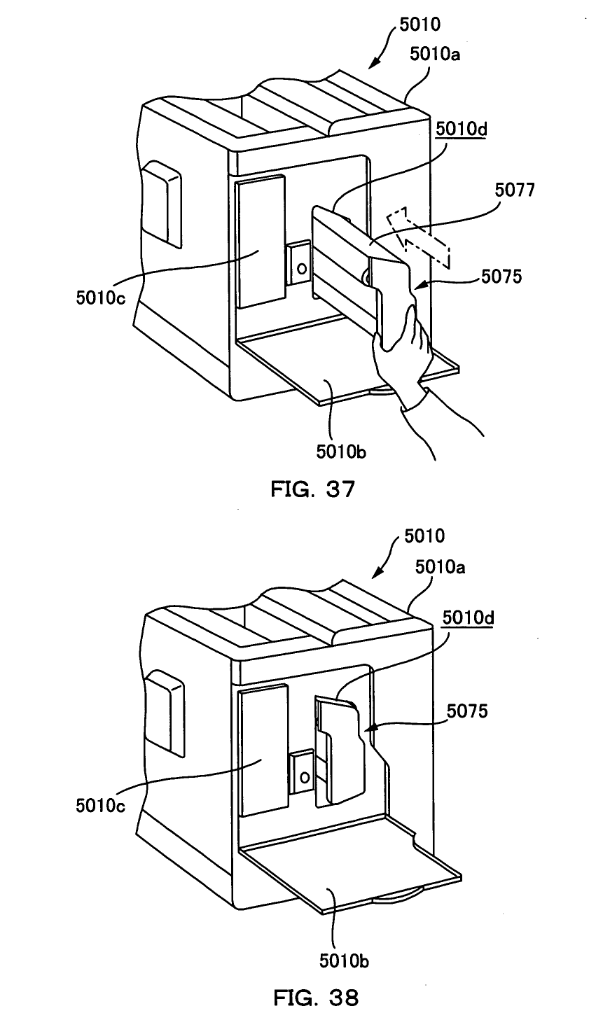

The operation when the user mounts the photoconductor unit 5075 to a main printer unit 5010a is described next with reference to FIG. 36, FIG. 37, and FIG. 38. FIG. 36 is a diagram showing the state before the photoconductor unit is inserted into an attach/detach opening. FIG. 37 is a diagram showing the photoconductor unit as it is being mounted to the attach/detach section via the attach/detach opening. FIG. 38 is a diagram showing the state after the photoconductor unit has been mounted to an attach/detach section through the attach/detach opening.

First, as shown in FIG. 36, the user opens a-first opening cover 5010b, and then, supporting the lower section of the outer wall surface 5077 of the photoconductor unit 5075 with his/her left hand (or right hand). Then, the user, with his/her right hand (or left hand), supports the rear lateral surface of the photoconductor unit 5075 when the photoconductor unit 5075 is being mounted to an attach/detach section, and inserts the photoconductor unit 5075 into a photoconductor unit attach/detach opening 5010d while moving the photoconductor unit 5075 in the direction shown by the long-short dashed line.

Then, as shown in FIG. 37, once the user has inserted the photoconductor unit 5075 into the photoconductor unit attach/detach opening 5010d to a certain extent, he/she takes his/her left hand (or right hand) from the lower section of the outer wall surface 5077 of the photoconductor unit 5075, and supporting only the rear lateral surface of the photoconductor unit 5075 with his/her right hand (or left hand), he/she pushes the photoconductor unit 5075 in the direction shown by the long-short dashed line. It should be noted that by providing an element 5075a near the center in the longitudinal direction of the outer wall surface 5077, the element 5075a is no longer exposed from the photoconductor unit attach/detach opening 5010d, even while the photoconductor unit 5075 is being mounted to the attach/detach section, and when the photoconductor unit 5075 is pushed in further, there is no longer the possibility that the user will touch the element with his/her right hand (or left hand).

Next, when the user further pushes the rear lateral surface of the photoconductor unit 5075 from the state of FIG. 37, then, as shown in FIG. 38, the photoconductor unit 5075 is mounted to the attach/detach section without the element 5075a being exposed from the photoconductor unit attach/detach opening 5010d.

It should be noted that the manner in which the user supports the photoconductor unit 5075 is not limited to the foregoing method, and as long as the method allows the lower section of the outer wall surface 5077 of the photoconductor unit 5075 to be supported and the photoconductor unit 5075 to be inserted through the photoconductor unit attach/detach opening 5010d, other methods may also be employed. Also, the operation for mounting the photoconductor unit 5075 to the attach/detach section can be carried out in reverse in order to remove the photoconductor unit 5075 from the attach/detach section.

Incidentally, if the element 5075a to which information can be written is exposed from the photoconductor unit attach/detach opening 5010d with the photoconductor unit 5075 mounted to the attach/detach section when the first opening cover 5010b of the main printer unit 5010a is opened, then the user may inadvertently touch the element 5075a with his/her body when attaching and detaching the photoconductor unit 5075 to and from the attach/detach section, and as a result it is conceivable that the element 5075a may come loose from the photoconductor unit 5075 or that the information written to the element 5075a may be ruined, and this is not preferable. Also, if, when attaching and detaching the photoconductor unit 5075 to and from the attach/detach section, the first opening cover 5010b is closed without noticing that the photoconductor unit 5075 is not completely mounted to the attach/detach section and that the frontward end of the photoconductor unit 5075 is slightly protruding out from the photoconductor unit attach/detach opening 5010d, then it is conceivable that the impact caused by closing the first opening cover 5010b will damage the element 5075a itself, and this, too, is not preferable.

Therefore, the element 5075a is provided in the photoconductor unit 5075 in such a manner that the element 5075a is not exposed from the photoconductor unit attach/detach opening 5010d when the photoconductor unit 5075 has been mounted to the attach/detach section. Thus, once the photoconductor unit 5075 has been mounted to the attach/detach section, there is no longer a possibility that the user may touch the element 5075a with his/her body, and the element 5075a can be kept from being damaged.

In particular, if the element 5075a is protruding out from the outer wall surface 5077 in the photoconductor unit 5075 (see FIG. 35), then the portion of the element 5075a that is protruding is hidden once the photoconductor unit 5075 has been mounted to the attach/detach section. Thus, damage to the element 5075a can be prevented more effectively. It should be noted that if, in the photoconductor unit 5075, the element 5075a is provided so that it is buried in the outer wall surface 5077 and is not protruding, then, when the user is performing the task of attaching or detaching the photoconductor unit 5075 to and from the attach/detach section, it is less likely that the user will touch the element 5075a with his/her body, and the element 5075a no longer comes into contact with and collides with the inner wall of the photoconductor unit attach/detach opening 5010d, and damage to the element 5075a can be prevented.

Most users typically attach and detach the photoconductor unit 5075 to and from the attach/detach section through the photoconductor unit attach/detach opening 5010d while supporting the lower section of the outer wall surface 5077 of the photoconductor unit 5075 with their hand. Accordingly, if the element 5075a is provided on an oblique surface B of the outer wall surface 77 (see FIG. 35) so that the surface of the element 5075a on the side opposite from the side that is in contact with the outer wall surface 77 when mounting the photoconductor unit 5075 to the attach/detach section 5055d is facing upward, then the element 5075a is not provided on the lower side of the outer wall surface 5077. Thus, when the user attaches and detaches the photoconductor unit 5075 to and from the attach/detach section, his/her body does not touch the element 5075a, even if the user is supporting the lower section of the outer wall surface 5077 with his/her hand. Consequently, damage to the element 5075a can be prevented not only when the photoconductor unit 5075 is mounted to the attach/detach section but also when it is being attached thereto and detached therefrom.

It is also possible to provide the element 5075a on a lateral surface C (see FIG. 35) on the leading side when the photoconductor unit 5075 is being mounted to the attach/detach section. In this case, the photoconductor unit 5075 can be attached to and detached from the attach/detach section regardless of which section of the outer wall surface 5077 of the photoconductor unit 5075 the user supports with his/her hand. Consequently, damage to the element 5075a when attaching and detaching the photoconductor unit 5075 can be prevented more effectively.

It is also possible for the main-unit-side antenna 5124a to write information to the element 5075a in the photoconductor unit 5075 in a non-contacting state. This allows damage to the element 5075a, to which information is written in a non-contacting state by the main-unit-side antenna 5124a, to be prevented.

It is also possible for the main-unit-side antenna 5124a to write information indicating a number of printed sheets to the element 5075a in the photoconductor unit 5075. This allows damage to the element 5075a, to which information indicating the number of printed sheets has been written, to be prevented. Therefore, the problem of information indicating the number of printed sheets being erased can be prevented.

With the configuration described above, it is possible to achieve a developing unit, a photoconductor unit, an image forming apparatus, and a computer system with which damage to an element can be prevented.

### Sixth Embodiment

A sixth embodiment is described next. The description focuses on features that are unique to the sixth embodiment. Features for which no particular description is made have the same configuration and/or process as in the first through fifth embodiments.

===Overview of the Developing Units===

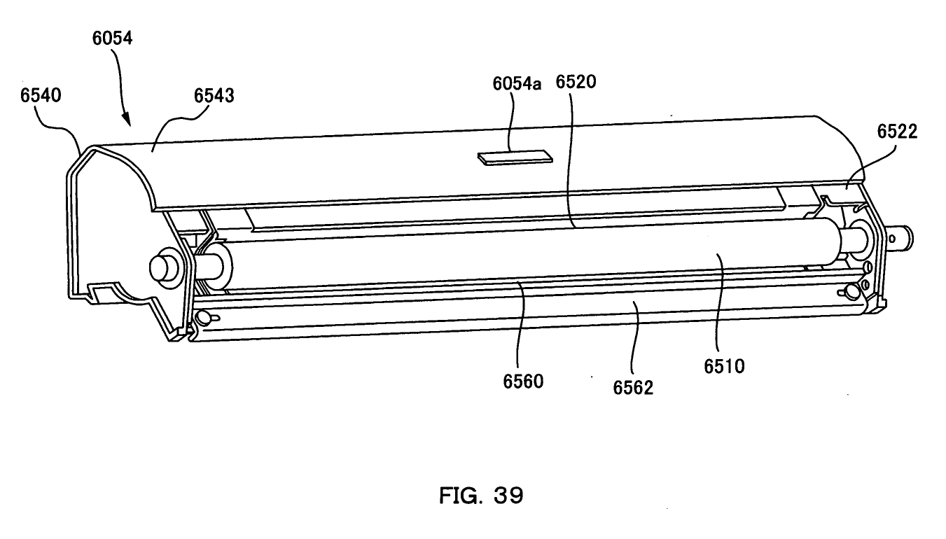

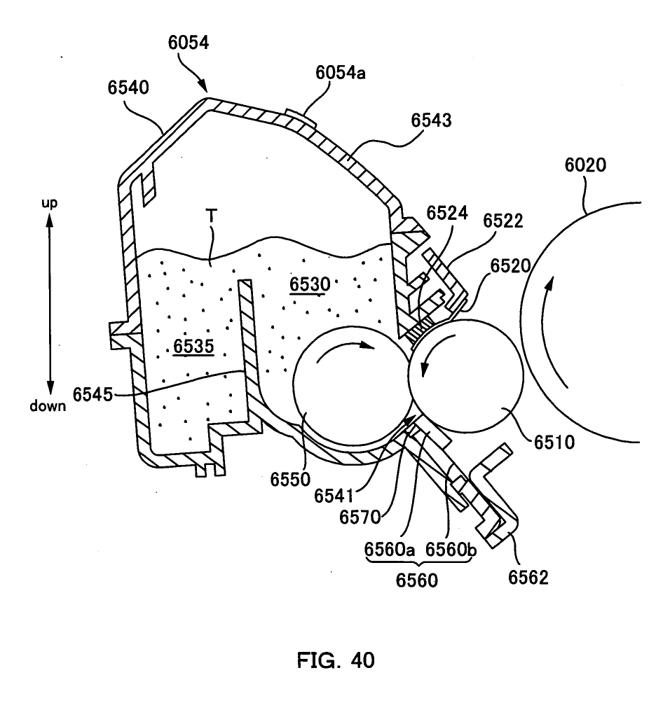

An overview of the developing units is provided next using FIG. 39 and FIG. 40. FIG. 39 is a perspective view of a yellow developing unit 6054 seen from the perspective of a developing roller 6510. FIG. 40 is a cross-sectional view showing the primary structural components of the yellow developing unit 6054. It should be noted that in FIG. 40 as well, the vertical direction is shown by an arrow, and for example, the central axis of the developing roller 6510 is lower than the central axis of the photoconductor 6020. Also, in FIG. 40, the yellow developing unit 6054 is shown positioned at a developing position that is in opposition to the photoconductor 6020.

A YMCK developing device 6050 is provided with a cyan developing unit 6051, which contains cyan (C) toner, a magenta developing unit 6052, which contains magenta (M) toner, a black developing unit 6053, which contains black (K) toner, and the yellow developing unit 6054, which contains yellow (Y) toner, and since the configuration of these developing units is the same, only the yellow developing unit 6054 is described below.

The yellow developing unit 6054 is provided, for example, with a developer containing section, that is, a first containing section 6530 and a second containing section 6535, for containing yellow toner T as a developer, an element 6054a, a housing 6450, a developing roller 6510, which serves as the developer bearing member, a toner supply roller 6550 for supplying toner T to the developing roller 6510, and a restriction blade 6560 for regulating the thickness of the layer of toner T that is borne on the developing roller 6510.

The housing 6450 is manufactured by joining an upper housing and a lower housing, for example, to form a single unit, and the inside of the housing is divided into the first containing section 6530 and the second containing section 6535 by a restriction wall 6545 that extends upward from the lower section (the vertical direction of FIG. 40). The first containing section 6530 and the second containing section 6535 form developer containing sections (6530, 6535) for containing toner T as a developer. The upper sections of the first containing section 6530 and the second containing section 6535 are in communication, and the movement of the toner T is regulated by the restriction wall 6545. It should be noted that it is also possible to provide a stirring member for stirring the toner T contained in the first containing section 6530 and the second containing section 6535, but in the present embodiment, the developing units (the cyan developing unit 6051, the magenta developing unit 6052, the black developing unit 6053, and the yellow developing unit 6054) rotate in conjunction with rotation of the rotary 6055, thereby stirring the toner T in the developing units, and thus a stirring member is not provided in the first containing section 6530 or the second containing section 6535.

The element 6054a, to which information can be written, is provided on an outer wall of the housing 6450 so that its longitudinal direction is in the longitudinal direction of the yellow developing unit 6054. The element 6054a has a configuration that allows it to store written information. It should be noted that the element 6054a is attached to the outer surface of the housing 6540. Also, the outer surface of the housing 6540 includes a wall section 6543 that is curved in the longitudinal direction of the yellow developing unit 6054, and in this embodiment, the element 6054a is provided on the curved wall section 6543. The element 6054a is flexible and is attached along the curved surface of the curved wall section 6543. The element 6054a is provided with an antenna 6054d as a developing-unit antenna, and the longitudinal direction of the antenna 6054d also is in the longitudinal direction of the yellow developing unit 6054. The element 6054a will be described in greater detail later.

The longitudinal direction of the element being in the longitudinal direction of the developing unit in this way allows for a developing unit in which the element is provided at an easily attachable position to be achieved.

When considering where to attach the element 6054a to the yellow developing unit 6054, strong consideration must be given to the ease with which the element can be attached. For example, the element 6054a easily falls off from the yellow developing unit 6054 if it is not attached sufficiently, and even if it is attached sufficiently, there is also the possibility that significantly bending the element 6054a as it is attached to the yellow developing unit 6054 may affect the communication performance.

Accordingly, as discussed above, the element 6054a is provided on the outer surface of the housing 6540 in such a manner that its longitudinal direction is in the longitudinal direction of the yellow developing unit 6054. In this way, it is possible to achieve a developing unit in which the element 6054a is provided at a position where it can be easily attached, and the foregoing problems can be solved.

An opening 6541 that communicates with the outside of the housing 6450 is provided in the lower section of the first containing section 6530. The toner supply roller 6550 is provided in the first containing section 6530 with its circumferential surface facing the opening 6541, and is rotatably supported on the housing 6450. Also, the developing roller 6510 is provided with its circumferential surface facing the opening 6541 from outside the housing 6450, and the developing roller 6510 abuts against the toner supply roller 6550.

The developing roller 6510 bears toner T and carries the toner to a developing position in opposition to the photoconductor 6020. The developing roller 6510 is made of aluminum, stainless steel or iron, for example, and if necessary, it can be subjected to nickel plating or chrome plating, and the toner bearing region can be subjected to sandblasting or the like. The developing roller 6510 is provided so that its longitudinal direction is along the longitudinal direction of the yellow developing unit 6054. Also, the developing roller 6510 can rotate about its central axis, and as shown in FIG. 40, it rotates in the direction (in FIG. 40, the counterclockwise direction) opposite from the direction in which the photoconductor 6020 rotates (in FIG. 40, the clockwise direction). Its central axis is lower than the central axis of the photoconductor 6020. Also, as shown in FIG. 40, in a state where the yellow developing unit 6054 is in opposition to the photoconductor 6020, a gap exists between the developing roller 6510 and the photoconductor 6020. That is, the yellow developing unit 6054 develops the latent image formed on the photoconductor 6020 without being in contact with the photoconductor 6020. It should be noted that when developing the latent image formed on the photoconductor 6020, an alternating electric field is formed between the developing roller 6510 and the photoconductor 6020.

The toner supply roller 6550 supplies the toner T contained in the first containing section 6530 and the second containing section 6535 to the developing roller 6510. The toner supply roller 6550 is made, for example, of polyurethane foam, and abuts against the developing roller 6510 in a state of elastic deformation. The toner supply roller 6550 is arranged at a lower section of the first containing section 6530, and the toner T contained in the first containing section 6530 and the second containing section is supplied to the developing roller 6510 by the toner supply roller 6550 at a lower section of the first containing section 6530. The toner supply roller 6550 can rotate about its central axis, and its central axis is lower than the central axis of rotation of the developing roller 6510. Also, the toner supply roller 6550 rotates in a direction (in FIG. 40, the clockwise direction) that is opposite from the direction of rotation of the developing roller 6510 (in FIG. 40, the counterclockwise direction). It should be noted that the toner supply roller 6550 has the function of supplying the toner T that is contained in the first containing section 6530 and the second containing section 6535 to the developing roller 6510 as well as the function of stripping off, from the developing roller 6510, toner T remaining on the developing roller 6510 after developing.

The restriction blade 6560 regulates the thickness of the toner T layer borne on the developing roller 6510, and applies charge to the toner T borne on the developing roller 6510. The restriction blade 6560 has a rubber section 6560a and a rubber-supporting section 6560b. The rubber section 6560a is made of silicone rubber or urethane rubber, for example, and the rubber-supporting section 6560b is a thin plate of phosphor bronze or stainless steel, for example, and has spring properties. The rubber section 6560a is supported by the rubber-supporting section 6560b, and one end of the rubber-supporting section 6560b is fixed to a blade-supporting metal plate 6562. The blade-supporting metal plate 6562 is fastened to a seal frame, and is attached to the housing 6450 together with the restriction blade 6560, forming a portion of a seal unit 6520, which is described later. In this state, the rubber section 6560a is pressed against the developing roller 6510 by the elastic force created by the bending of the rubber-supporting section 6560b.

Also, a blade-backing member 6570 made of Moltoprene or the like is provided on the side of the restriction blade 6560 that is opposite from the developing roller 6510 side. The blade-backing member 6570 prevents the toner T from entering in between the rubber-supporting section 6560b and the housing 6450, stabilizing the elasticity obtained by the bending of the rubber-supporting section 6560b, and, by applying force to the rubber section 6560a toward the developing roller 6510 from directly behind the rubber section 6560a, it presses the rubber section 6560a against the developing roller 6510. Consequently, the blade-backing member 6570 increases the contact uniformity and the sealing properties of the rubber section 6560a with respect to the developing roller 6510.

The end of the restriction blade 6560 on the side opposite from the side supported by the blade-supporting metal plate 6562, that is, its tip, is not in contact with the developing roller 6510, and a portion thereof away from its tip by a predetermined distance is in contact with the developing roller 6510 with some breadth. That is, the restriction blade 6560 does not abut against the developing roller 6510 at its edge but rather at its mid section. Also, the restriction blade 6560 is arranged such that its tip is facing upstream in the direction in which the developing roller 6510 rotates, making so-called counter-abutment with respect to the developing roller 6510. It should be noted that the abutting position where the restriction blade 6560 abuts against the developing roller 6510 is lower than the central axis of the developing roller 6510 and is lower than the central axis of the toner supply roller 6550.

The seal member 6520 prevents the toner T in the yellow developing unit 6054 from leaking outside the unit, and also collects toner T on the developing roller 6510, after the developing roller 6510 has passed the developing position, into the developing unit without scraping it off. The seal member 6520 is a seal made of polyethylene film or the like. The seal member 6520 is supported by a seal-supporting metal plate 6522, and is attached to the frame 6540 via the seal-supporting metal plate 6522. A seal urging member 6524 made of Moltoprene or the like is provided on the side of the seal member 6520 that is opposite from the developing roller 6510 side, and due to the elasticity of the seal urging member 6524, the seal member 6520 is pressed against the developing roller 6510. It should be noted that the abutting position where the seal member 6520 abuts against the developing roller 6510 is above the central axis of the developing roller 6510.

In the yellow developing unit 6054 configured in this manner, the toner supply roller 6550 supplies the toner T that is contained in the first containing section 6530 and the second containing section 6535, which function as developer containing sections, to the developing roller 6510. The toner T that is supplied to the developing roller 6510 is carried to the abutting position of the restriction blade 6560 in conjunction with rotation of the developing roller 6510, and when it passes the abutting position, the thickness of the toner T layer is regulated and charge is applied. The toner T on the developing roller 6510, whose layer thickness has been regulated, is brought to the developing position in opposition to the photoconductor 6020 due to further rotation of the developing roller 6510, and is supplied for developing the latent image formed on the photoconductor 6020 in an alternating electric field at the developing position. The toner T on the developing roller 6510 that has passed the developing position due to further rotation of the developing roller 6510 then passes the seal member 6520 and is collected into the developing unit without being scraped off by the seal member 6520.

With the foregoing configuration, it is possible to achieve a developing unit, a photoconductor unit, an image forming apparatus, and a computer system with which an element is provided on the developing unit. etc. at a position where it can be easily attached.

### INDUSTRIAL APPLICABILITY

According to the present invention, it is possible to achieve an image forming apparatus and a computer system with which information can be accurately written to the element of a developing unit. Also, with the present invention, it is possible to achieve an image forming apparatus and a computer system with which it is possible to accurately communicate with, for example, a developing unit having an element.

1. An image forming apparatus comprising:
a photoconductor on which a latent image can be formed;
a moving member provided with a plurality of attach/detach sections, to and from each of which a developing unit having
an element to which information can be written and
a developer containing section for containing developer with which the latent image on said photoconductor can be developed
can be attached and detached; and
an antenna for wirelessly writing information to the element of the developing unit attached to one of said attach/detach sections;
wherein said antenna is provided at a position where, when a predetermined developing unit, of among a plurality of developing units attached to said plurality of attach/detach sections, is performing development of the latent image on said photoconductor, said antenna is in opposition to at least one of the elements of the other developing units that are not performing the development.

2. An image forming apparatus according to claim 1,
wherein said moving member moves rotatively to selectively position each of said plurality of developing units attached to said plurality of attach/detach sections in opposition to said photoconductor.

3. An image forming apparatus according to claim 2,
wherein said element is provided on an outer wall surface in a longitudinal direction of said developing unit, and
wherein said antenna is provided at a position that is more outside, in a radial direction of rotation of said moving member, than the elements of the developing units that are not performing the development.

4. An image forming apparatus according to claim 3,
wherein said antenna is provided at a position that is more outside, in the radial direction of rotation of said moving member, than the element of the developing unit that is on a side opposite, with respect to a rotational axis of said moving member, from the developing unit that is performing development of the latent image on said photoconductor.

5. An image forming apparatus according to claim 2,
wherein a longitudinal direction of said antenna is in the direction of rotation of said moving member.

6. An image forming apparatus according to claim 2,
wherein said element is provided on a lateral surface of said developing unit on a leading side when said developing unit is being attached to said attach/detach section, and
wherein said antenna is provided at a position that is more outside, in an axial direction of rotation of said moving member, than the elements of the developing units that are not performing the development.

7. An image forming apparatus according to claim 1,
wherein said antenna is capable of writing information to said element in a non-contacting state.

8. An image forming apparatus according to claim 1,
wherein said antenna is used to write, to the element, information indicating a remaining amount of developer that is contained in the developing unit provided with that element.

9. An image forming apparatus according to claim 1,
wherein said antenna is used to write, to the element, information indicating a usage amount of developer that is contained in the developing unit provided with that element.

10. An image forming apparatus according to claim 1,
wherein said image forming apparatus further comprises an AC voltage supply section for supplying an AC voltage, and
wherein when the predetermined developing unit, of among said plurality of developing units attached to said plurality of attach/detach sections, is supplied with the AC voltage from said AC voltage supply section and is performing development of the latent image on said photoconductor, said antenna is used to write information to the element of the developing unit that is not performing the development.

11. An image forming apparatus according to claim 10,
wherein said developing unit has a developer bearing member for bearing the developer, and
wherein said AC voltage supply section supplies the AC voltage to said developer bearing member.

12. An image forming apparatus according to claim 10,
wherein a difference between a maximum voltage value and a minimum voltage value of said AC voltage is at least 1000 volts.

13. An image forming apparatus comprising:
a photoconductor on which a latent image can be formed;
a moving member provided with a plurality of attach/detach sections, to and from each of which a developing unit having
an element to which information can be written and
a developer containing section for containing developer with which the latent image on said photoconductor can be developed
can be attached and detached; and
an antenna for wirelessly writing information to the element of the developing unit attached to one of said attach/detach sections;
wherein said antenna is provided at a position where, when a predetermined developing unit, of among a plurality of developing units attached to said plurality of attach/detach sections, is performing development of the latent image on said photoconductor, said antenna is in opposition to at least one of the elements of the other developing units that are not performing the development such that information can be written wirelessly to that element,
wherein said moving member moves rotatively in opposition to said photoconductor,
wherein said antenna is provided at a position that is more outside, in the radial direction of rotation of said moving member, than the element provided on an outer wall surface in a longitudinal direction of the developing unit that is on a side opposite, with respect to a rotational axis of said moving member, from the developing unit that is performing development of the latent image on said photoconductor,
wherein a longitudinal direction of said antenna is in the direction of rotation of said moving member,
wherein said antenna is capable of writing information to said element in a non-contacting state, and
wherein said antenna is used to write, to the element, information about consumption of developer that is contained in the developing unit provided with that element.

14. A computer system comprising:
an image forming apparatus including:
a photoconductor on which a latent image can be formed;
a moving member provided with a plurality of attach/detach sections, to and from each of which a developing unit having
an element to which information can be written and
a developer containing section for containing developer with which the latent image on said photoconductor can be developed
can be attached and detached; and
an antenna for wirelessly writing information to the element of the developing unit attached to one of said attach/detach sections; and
a main computer unit that is connected to said image forming apparatus;
wherein said antenna is provided at a position where, when a predetermined developing unit, of among a plurality of developing units attached to said plurality of attach/detach sections, is performing development of the latent image on said photoconductor, said antenna is in opposition to at least one of the elements of the other developing units that are not performing the development.

15. An image forming apparatus comprising:
a moving member provided with a plurality of attach/detach sections, to and from each of which a developing unit having
an element to which information can be wirelessly written and
a developer containing section can be attached and detached;
a photoconductor on which a latent image can be formed; and
a writing member for writing information to said element;
wherein the developing unit attached to one of said attach/detach sections is moved by said moving member to an opposition position in opposition to said photoconductor and develops the latent image formed on said photoconductor, and
wherein, when said developing unit is positioned at said opposition position and is performing development, said writing member writes information to said element of at least one developing unit of among the developing units attached respectively to said plurality of attach/detach sections.

16. An image forming apparatus according to claim 15,
wherein said developing unit has a developer bearing member for bearing developer, and
wherein said latent image is developed by the developer borne on said developer bearing member of said developing unit that is positioned at said opposition position.

17. An image forming apparatus according to claim 15,
wherein said writing member writes information to said element in a non-contacting state.

18. An image forming apparatus according to claim 15,
wherein said writing member writes information to said element when said moving member is not moving.

19. An image forming apparatus according to claim 15,
wherein said writing member writes information to said element of the developing unit that is positioned at said opposition position.

20. An image forming apparatus according to claim 15,
wherein said writing member writes information to said element of a developing unit, of among the developing units attached respectively to said plurality of attach/detach sections, other than the developing unit that is positioned at said opposition position.

21. An image forming apparatus according to claim 20,
wherein said developing unit has a developer bearing member for bearing developer, and
wherein an AC voltage is applied between said developer bearing member and said photoconductor to develop said latent image with the developer that is borne on said developer bearing member.

22. An image forming apparatus according to claim 20,
wherein said writing member writes information to said element of a developing unit, of among the developing units attached respectively to said plurality of attach/detach sections, that is adjacent to the developing unit that is positioned at said opposition position.

23. An image forming apparatus according to claim 20,
wherein said writing member writes information to said element of a developing unit, of among the developing units attached respectively to said plurality of attach/detach sections, that is not adjacent to the developing unit that is positioned at said opposition position.

24. An image forming apparatus according to claim 15,
wherein said writing member writes, to the element, information indicating a remaining amount of developer that is contained in the developing unit provided with that element.

25. An image forming apparatus according to claim 15,
wherein said writing member writes, to the element, information indicating a usage amount of developer that is contained in the developing unit provided with that element.

26. An image forming apparatus comprising:
a moving member provided with a plurality of attach/detach sections, to and from each of which a developing unit having
an element to which information can be wirelessly written and
a developer containing section
can be attached and detached;
a photoconductor on which a latent image can be formed; and
a writing member for writing information to said element;
wherein the developing unit attached to one of said attach/detach sections is moved by said moving member to an opposition position in opposition to said photoconductor and develops the latent image formed on said photoconductor,
wherein, when said developing unit is positioned at said opposition position and is performing development, said writing member writes information to said element of at least one developing unit of among the developing units attached respectively to said plurality of attach/detach sections,
wherein said developing unit has a developer bearing member for bearing developer,
wherein said latent image is developed by the developer borne on said developer bearing member of said developing unit that is positioned at said opposition position, and
wherein said writing member writes information to said element in a non-contacting state when said moving member is not moving.

27. A computer system comprising:
a main computer unit; and
an image forming apparatus that is connected to said main computer unit and that includes:
a moving member provided with a plurality of attach/detach sections, to and from each of which a developing unit having
an element to which information can be wirelessly written and a developer containing section
can be attached and detached;
a photoconductor on which a latent image can be formed; and
a writing member for writing information to said element;
wherein the developing unit attached to one of said attach/detach sections is moved by said moving member to an opposition position in opposition to said photoconductor and develops the latent image formed on said photoconductor, and
wherein, when said developing unit is positioned at said opposition position and is performing development, said writing member writes information to said element of at least one developing unit of among the developing units attached respectively to said plurality of attach/detach sections.

28. An image forming apparatus according to claim 1,
wherein said developing unit has a developer bearing member for bearing developer that is contained in said developer containing section, and a cover that is removable or retractable and that is for covering said developer bearing member, and
wherein said element is provided inside said cover.

29. An image forming apparatus according to claim 15,
wherein said developing unit has a developer bearing member for bearing developer that is contained in said developer containing section, and a cover that is removable or retractable and that is for covering said developer bearing member, and
wherein said element is provided inside said cover.

30. An image forming apparatus according to claim 1,
wherein said element is provided at a position where it is not exposed to the outside.

31. An image forming apparatus according to claim 15,
wherein said element is provided at a position where it is not exposed to the outside.

32. An image forming apparatus according to claim 1, further comprising:
an attach/detach opening through which said developing unit is attached and detached;
wherein said element is provided at a position where it is not exposed from said attach/detach opening when said developing unit is attached to said image forming apparatus.

33. An image forming apparatus according to claim 15, further comprising:
an attach/detach opening through which said developing unit is attached and detached;
wherein said element is provided at a position where it is not exposed from said attach/detach opening when said developing unit is attached to said image forming apparatus.

34. An image forming apparatus according to claim 1,
wherein a longitudinal direction of said element is in a longitudinal direction of said developing unit.

35. An image forming apparatus according to claim 15,
wherein a longitudinal direction of said element is in a longitudinal direction of said developing unit.
